(19) United States
(12) Patent Application Publication
(10) Pub. No.: US 2025/0111245 A1
(43) Pub. Date: Apr. 3, 2025

(54) ENHANCING NEURAL NETWORK TRAINING AND DEVELOPMENT VIA POST-HOC PARAMETER AVERAGING

(71) Applicant: NVIDIA Corporation, Santa Clara, CA (US)

(72) Inventors: Samuli Matias Laine, Vantaa (FI); Miika Samuli Aittala, Helsinki (FI); Janne Johannes Hellsten, Helsinki (FI); Jaakko T. Lehtinen, Helsinki (FI); Timo Oskari Aila, Tuusula (FI); Tero Tapani Karras, Helsinki (FI)

(21) Appl. No.: 18/898,040

(22) Filed: Sep. 26, 2024

Related U.S. Application Data
(60) Provisional application No. 63/606,448, filed on Dec. 5, 2023.
(60) Provisional application No. 63/603,049, filed on Nov. 27, 2023.
(60) Provisional application No. 63/586,948, filed on Sep. 29, 2023.

(51) Int. Cl. G06N 3/0985

(52) U.S. Cl. CPC G06N 3/0985

(57) ABSTRACT

Apparatuses, systems, and techniques to compute neural network parameters and to use a neural network to perform inference. In at least one embodiment, neural network parameters are computed, after training, by determining a weighted average of snapshots of averaged parameters that form a basis set of averaged parameter snapshots, each respective snapshot of averaged parameters including a plurality of network parameters averaged by a respective combination of an averaging function and one or more averaging parameters.

### CLAIM OF PRIORITY

This application claims the benefit of U.S. Provisional Application No. 63/606,448, titled “Improvements to the Training and Architecture of Neural Networks” and filed Dec. 5, 2023, of U.S. Provisional Application No. 63/603,049, titled “Improvements to the Training and Architecture of Neural Networks” and filed Nov. 27, 2023, and of U.S. Provisional Application No. 63/586,948, titled “Improvements to the training and architecture of neural networks” and filed Sep. 29, 2023, each of which is incorporated by reference herein.

### BACKGROUND

Deep learning is a subset of machine learning that involves training models consisting of multiple layers of computational units (often referred to as artificial neurons). Such models can be referred to as deep neural networks (DNNs). The goal of deep learning is to train DNNs to identify complex patterns and representations from large datasets and thereby enable them to perform various tasks, e.g., image classification and natural language processing.

DNNs can be conceptualized as a number of interconnected layers, some of which are linear and some of which are non-linear, some of which are learned and some of which perform predefined, fixed functions. Linear layers (e.g., fully-connected layers or convolutional layers) perform a linear operation on an input, using a weight matrix, to transform the input and thereby provide an output. Linear layers typically include weights and biases that are learned during a training process, though some linear layers may have predefined, fixed weights that are invariant to training (or not updated during certain learning scenarios). Non-linear layers include, for example, activation layers (which consist of a number of artificial neurons using some activation function, e.g. ReLU, SiLU, etc.), normalization layers (e.g. BatchNorm, LayerNorm, GroupNorm), modulation layers (e.g. AdaIN), gating layers (e.g. GeGLU), and attention layers (e.g. self-attention layers, cross-attention layers). Some non-linear layers are fixed and therefore invariant to training (e.g. activation layers typically perform predefined, fixed mathematical operations), while others include trainable parameters that are learned during the training process (e.g. attention layers).

Training a DNN involves providing an input to the DNN, processing the input in a forward direction to provide a model output, computing a model error (i.e., a difference between the model output and a ground truth), backpropagating a feedback signal (based on gradients of the model error) in a reverse direction, and updating the individual weights of each respective learned layer. The feedback signal provides an indication of a direction in which each weight should be adjusted in order to reduce the value of the loss function, and the weights are thereby updated in a manner that reduces the model error. The process is repeated-often for hundreds of thousands of iterations-enabling the model to learn from large datasets.

While the process may appear straightforward when described at a high level, the training dynamics are highly complex in the presence of multiple layers and large numbers of computational units, and a number of significant problems are presented in practice.

### BRIEF DESCRIPTION OF THE DRAWINGS

FIG. 1 illustrates a flowchart of a process for producing a trained neural network, according to at least one embodiment;

FIG. 2A illustrates an algorithm, according to at least one embodiment, for converting a parameter used for parameterizing a power function averaging function to an alternative equivalent parameter used for an alternative parameterization of the power function averaging function;

FIG. 2B illustrates an algorithm, according to at least one embodiment, for determining weights of one or more weighted averages of parameter snapshots that approximate one or more desired averaging functions;

FIG. 3 illustrates, according to at least one embodiment, construction of a basis set of snapshots and post-hoc reconstruction of a desired averaging function as a weighted average of snapshots selected from the basis set;

FIG. 4 illustrates, for a plurality of different neural network architectures, the impact of averaging function parameterization on neural network performance;

FIG. 5A illustrates a diffusion model (DM) architecture, according to at least one embodiment;

FIG. 5B illustrates an input block of the diffusion model of FIG. 5A, according to at least one embodiment;

FIG. 5C illustrates an output block of the diffusion model of FIG. 5A, according to at least one embodiment;

FIG. 5D illustrates an embedding block of the diffusion model of FIG. 5A, according to at least one embodiment;

FIG. 5E illustrates an encoder block of the diffusion model of FIG. 5A, according to at least one embodiment;

FIG. 5F illustrates a decoder block of the diffusion model of FIG. 5A, according to at least one embodiment;

FIG. 5G illustrates an attention block of the diffusion model of FIG. 5A, according to at least one embodiment;

FIG. 6A illustrates logic, according to at least one embodiment;

FIG. 6B illustrates logic, according to at least one embodiment;

FIG. 7 illustrates training and deployment of a neural network, according to at least one embodiment;

FIG. 8 illustrates an example data center system, according to at least one embodiment;

FIG. 9 is a block diagram illustrating a computer system, according to at least one embodiment;

FIG. 10 illustrates a computer system, according to at least one embodiment;

FIG. 11A illustrates a computer system, according to at least one embodiment;

FIG. 11B illustrates a computer system, according to at least one embodiment;

FIG. 11C illustrates a computer system, according to at least one embodiment;

FIG. 11D illustrates a computer system, according to at least one embodiment;

FIGS. 11E and 11F illustrate a shared programming model, according to at least one embodiment;

FIGS. 12A-12B illustrate additional exemplary graphics processor logic according to at least one embodiment;

FIG. 13A illustrates a parallel processor, according to at least one embodiment;

FIG. 13B illustrates a partition unit, according to at least one embodiment;

FIG. 13C illustrates a processing cluster, according to at least one embodiment;

FIG. 13D illustrates a graphics multiprocessor, according to at least one embodiment;

FIG. 14 is a block diagram illustrating a processor micro-architecture for a processor, according to at least one embodiment;

FIG. 15 illustrates a deep learning application processor, according to at least one embodiment;

FIG. 16 illustrates at least portions of a graphics processor, according to one or more embodiments;

FIG. 17 illustrates at least portions of a graphics processor, according to one or more embodiments;

FIG. 18 illustrates a parallel processing unit (“PPU”), according to at least one embodiment;

FIG. 19 illustrates a general processing cluster (“GPC”), according to at least one embodiment;

FIG. 20 illustrates a memory partition unit of a parallel processing unit (“PPU”), according to at least one embodiment; and

FIG. 21 illustrates a streaming multi-processor, according to at least one embodiment.

### DETAILED DESCRIPTION

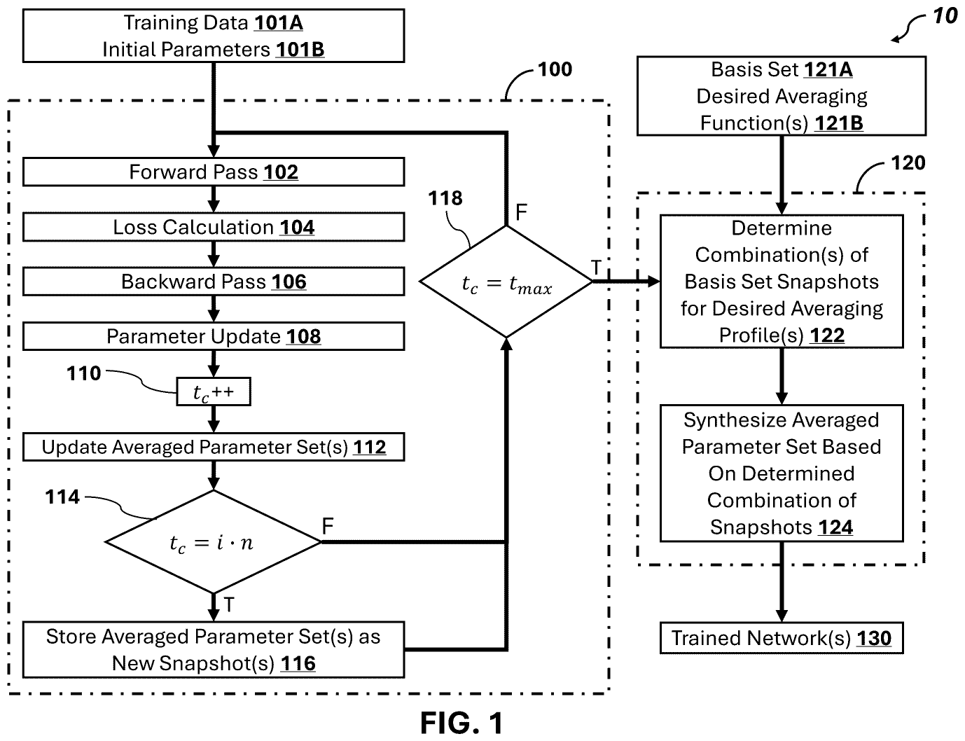

FIG. 1 illustrates a flowchart of a process 10 for providing parameters for one or more trained neural networks, according to at least one embodiment. The neural network includes a plurality of learnable layers (each of which includes at least one learnable parameter) as well as a plurality of fixed function layers. In at least one embodiment, the neural network is a diffusion model (DM). In at least one embodiment, the neural network is a generative pretrained transformer (GPT). In various embodiments, the neural network model is a convolutional neural network (CNN), a recurrent neural network (RNN), an autoencoder, a feedforward neural network (FFNN), a graph neural network (GNN), or a generative adversarial network (GAN).

The process 10 includes a training phase 100 and a post-training phase 120. During the training phase 100, the process performs a number of training steps (e.g. tₘₐₓ steps), each training step including one or more iterations of forward pass 102, loss calculation 104, and backward pass 106. In at least one embodiment, each training step includes processing a batch of training examples, each training sample in the batch being processed via a single training iteration that includes forward pass 102, loss calculation 104, and backward pass 106.

During each training step of the training phase 100, the process 10 provides a set of instantaneous network parameters by updating a prior set of parameters 108. In at least one embodiment, each training step includes processing a batch of training examples via plurality of training iterations and updating the prior set of parameters at 108 based on an average of gradients computed during each training iteration.

During each step of the training phase 100, the process 10 also provides one or more sets of averaged network parameters by updating, at 112, one or more prior sets of averaged parameters maintained during the training phase 100. The process 10 periodically (e.g. every nth training step) stores, at 116, a snapshot of each of the one or more sets of averaged network parameters maintained during the training phase 100. The stored snapshots of averaged network parameters collectively provide a basis set 121A to be used for the post-training phase 120.

During the post-training phase 120, the process 10 determines, at 122 and for each of one or more respective desired averaging functions 121B, a combination of stored snapshots that approximates the desired averaging function. Also during the post-training phase 120, the process 10 synthesizes, based on the one or more determined combinations of stored snapshots, one or more averaged parameter sets. The result of the post-training phase 120 is one or more averaged parameter sets, each defining a trained neural network, output at 130.

During forward pass 102 of each training iteration of training phase 100, the neural network processes, using a set of network parameters, input corresponding to a training example of training data 101A to generate output. During the first training step of training phase 100, the neural network uses a set of initial parameters 101B during forward pass 102 of each training iteration. In at least one embodiment, the initial parameters 101B are determined through random initialization. In at least one embodiment, the initial parameters 101B are determined through a technique that provides an initial parameter distribution with certain predetermined properties, e.g. a predetermined mean and variance. In at least one embodiment, the initial parameters 101B are determined based on the training data to be used for training phase 100. In at least one embodiment, the initial parameters 101B are determined via transfer learning. During every subsequent training step of training phase 100, the neural network uses parameters determined during the immediately prior step (i.e., the instantaneous parameters determined during the parameter update 108 of the immediately prior training step) to process input and generate output during the forward pass 102 of each training iteration.

During loss calculation 104 of each training iteration of training phase 100, the process 10 computes, using a loss function and based on the output generated during forward pass 102, a model loss (also referred to as a model error). In at least one embodiment, the model loss is computed by using a supervised learning loss function that compares the model output with a target (also referred to as “ground truth”) corresponding to the training example of the training data 101A. In various embodiments, the supervised learning loss function can be a regression loss function, such as mean squared error (MSE), score matching loss, mean absolute error (MAE), or Huber Loss, or a classification loss function, such as binary cross-entropy or categorical cross-entropy. In at least one embodiment, the model loss is computed using an unsupervised learning loss function that assesses the degree to which the forward pass captured underlying structure of or patterns in the training instance input. In various embodiments, the unsupervised learning loss function can be a reconstruction loss function, such as mean squared error (MSE) or binary cross-entropy, a contrastive loss function, such as triplet loss, an adversarial loss function, such as minimax loss or Wasserstein loss, or a clustering loss, such as K-means loss or Gaussian mixture loss.

During the backward pass 106 of each training iteration of training phase 100, the process 10 computes gradients of the model loss with respect to learnable parameters of the neural network. The gradient of the model loss, with respect to any particular parameter, indicates a direction and relative magnitude of an adjustment to that particular parameter that will reduce the value of the model loss.

During parameter update 108, the process 10 updates—using gradients calculated during backward pass 106—the prior set of network parameters and thereby provides a set of instantaneous network parameters. In at least one embodiment, the process 10 updates the prior set of parameters using stochastic gradient descent (SGD), mini-batch gradient descent, or true gradient descent. In at least one embodiment, the process 10 updates the prior set of parameters using a gradient descent optimizer that utilizes momentum, adaptive learning rates, or adaptive moments (e.g. AdaGrad, RMSProp, Adam).

Following parameter update 108, the process 10 proceeds to 110, where the value of the current training step t_{c} is incremented, and then updates, at 112, one or more sets of averaged network parameters maintained during training phase 100. Each set of averaged network parameters is determined using a unique combination of an averaging function and one or more averaging parameters. In at least one embodiment, each set of averaged parameters \hat{θ}(t_{c}) after t_{c} training steps is a weighted average of the sets of instantaneous parameters θ(t) as function of training step t, represented as:

$$\hat{θ} ( {t}_{c} ) = {\sum }_{t = 0}^{{t}_{c}} {p}_{{t}_{c}} ( t ) θ ( t ) ,$$

where the averaging function pₜ_{_{c}} is a time-dependent response function that sums to one, i.e., Σₜpₜ_{_{c}}(t)=1. In at least one embodiment, the averaging function pₜ_{_{c}} is represented in terms of a canonical response function ƒ(t), such that:

$${p}_{{t}_{c}} ( t ) = \{ \begin{matrix}f ( t ) / g ( {t}_{c} ) & if 0 \leq t \leq {t}_{c} \\ 0 & otherwise\end{matrix} ,$$

$$where :$$

$$g ( {t}_{c} ) = {\int }_{0}^{{t}_{c}} f ( t ) dt .$$

In at least one embodiment, the averaging function pₜ_{_{c}} is characterized by its standard distribution statistics, such that:

$${μ}_{{t}_{c}} = 𝔼 [ t ]$$

$$and$$

$${σ}_{{t}_{c}} = \sqrt{Var [ t ]}$$

$$for$$

$$t ∼ {p}_{{t}_{c}} ( t ) ,$$

where the mean μₜ_{_{c}} indicates an average delay imposed by the averaging function pₜ_{_{c}}, and the standard deviation σₜ_{_{c}} correlates with the length of the time period (e.g. the number of training steps) over which the parameters of the set of parameters are averaged. To update the one or more sets of averaged network parameters at 112, the process 10 computes each set of averaged network parameters \hat{θ}(t_{c}) using a corresponding set of averaged network parameters \hat{θ}(t_{c-Δt}) from a prior training step t_{c-Δt} along with the set of instantaneous network parameters θ(t_{c}) resulting from parameter update 108. In at least one embodiment, each set of averaged network parameters \hat{θ}(t_{c}) is computed according to:

$$\hat{θ} ( {t}_{c} ) = {\int }_{0}^{{t}_{c}} \frac{f ( t )}{g ( {t}_{c} )} θ ( t ) dt$$

$$\hat{θ} ( {t}_{c} ) = {\int }_{0}^{{t}_{c - Δ t}} \frac{f ( t )}{g ( {t}_{c} )} θ ( t ) dt + {\int }_{{t}_{c - Δ t}}^{{t}_{c}} \frac{f ( t )}{g ( {t}_{c} )} θ ( t ) dt$$

$$\hat{θ} ( {t}_{c} ) = \frac{g ( {t}_{c - Δ t} )}{{\underbrace{g ( {t}_{c} )}}_{= : β ( {t}_{c} )}} {\underbrace{{\int }_{0}^{{t}_{c}} \frac{f ( t )}{g ( {t}_{c - Δ t} )} θ ( t ) dt}}_{= θ ( {t}_{c - Δ t} )} + \frac{θ ( {t}_{c} )}{g ( {t}_{c} )} {\underbrace{{\int }_{{t}_{c - Δ t}}^{{t}_{c}} f ( t ) dt}}_{= g ( {t}_{c} ) - g ( {t}_{c - Δ t} )}$$

$$\hat{θ} ( {t}_{c} ) = β ( {t}_{c} ) \hat{θ} ( {t}_{c - Δ t} ) + \frac{θ ( {t}_{c} )}{g ( {t}_{c} )} ( g ( {t}_{c} ) - g ( {t}_{c - Δ t} ) )$$

$$\hat{θ} ( {t}_{c} ) = β ( {t}_{c} ) \hat{θ} ( {t}_{c - Δ t} ) + [ 1 + \frac{g ( {t}_{c - Δ t} )}{{\underbrace{g ( {t}_{c} )}}_{= β ( {t}_{c} )}} ] θ ( {t}_{c} )$$

$$\hat{θ} ( {t}_{c} ) = β ( {t}_{c} ) \hat{θ} ( {t}_{c - Δ t} ) + ( 1 - β ( {t}_{c} ) ) θ ( {t}_{c} ) ,$$

where Δt denotes the length of the training step in whatever units are being used for t (e.g. number of training steps), and β(t_{c}) is a time-varying factor that blends between the previous averaged network parameters and the new instantaneous network parameters.

In at least one embodiment, the one or more sets of averaged network parameters are exponential moving averages (EMA), each averaging function pₜ_{_{c}} decays exponentially (as t moves farther away from t_{c} into the past), each averaging function pₜ_{_{c}} is parameterized by the EMA half-life λ, and one or more values for the EMA half-life λ are selected that correspond to the one or more sets of averaged network parameters. The averaging function pₜ_{_{c}} is represented as:

$${p}_{{t}_{c}} ( t ) = \frac{f ( t )}{g ( {t}_{c} )} ,$$

$$f ( t ) = \{ \begin{matrix}{2}^{t / λ} & if t > 0 \\ \frac{λ}{ln 2} δ ( t ) & otherwise\end{matrix} ,$$

$$and$$

$$g ( {t}_{c} ) = \frac{λ {2}^{{t}_{c} / λ}}{ln 2} ,$$

where δ(t) is the Dirac delta function. To update the one or more sets of averaged network parameters at 112, each set of averaged network parameters \hat{θ}(t_{c}) is computed, using a corresponding set of averaged network parameters \hat{θ}(t_{c-Δt}) from the prior training step t_{c-Δt} along with the set of instantaneous network parameters θ(t_{c}) resulting from the parameter update at 108, according to:

$$\hat{θ} ( {t}_{c} ) = β ( {t}_{c} ) \hat{θ} ( {t}_{c - Δ t} ) + ( 1 - β ( {t}_{c} ) ) θ ( {t}_{c} ) ,$$

where:

$$β ( {t}_{c} ) = \frac{g ( {t}_{c - Δ t} )}{g ( {t}_{c} )} = \frac{{2}^{{t}_{c - Δ t} / λ}}{{2}^{{t}_{c} / λ}} = {2}^{- Δ t / λ} .$$

In at least one embodiment, the one or more sets of averaged network parameters are power function moving averages, each averaging function pₜ_{_{c}} is a power function parameterized by a constant γ, and one or more values for the constant γ are selected that correspond to the one or more sets of averaged network parameters. The averaging function pₜ_{_{c}} is represented as:

$${p}_{{t}_{c}} ( t ) = \frac{f ( t )}{g ( {t}_{c} )} ,$$

$$f ( t ) = {t}^{γ} ,$$

$$and$$

$$g ( {t}_{c} ) = \frac{{t}_{c}^{γ + 1}}{γ + 1} .$$

The length of each averaging function pₜ_{_{c}} increases over the course of training proportional to t_{c}. The response function ƒ(t) is self-similar over different timescales, i.e., ƒ(st) ∝ƒ(t) for any positive stretching factor s. The response functions for different values of t_{c} will therefore be stretched versions of each other; if t_{c} doubles, so does σₜ_{_{c}}. Furthermore, ƒ(0)=0, which eliminates any contribution from the initial parameters θ(0) to the set of averaged network parameters. Each averaging function pₜ_{_{c}} is equal to the beta distribution with α=γ+1 and β=1, stretched along the t-axis by t_{c}. The relative mean and standard deviation with respect to t_{c} are therefore:

$${μ}_{rel} = \frac{{μ}_{{t}_{c}}}{{t}_{c}} = \frac{γ + 1}{γ + 2} ,$$

$$and$$

$${σ}_{rel} = \frac{{σ}_{{t}_{c}}}{{t}_{c}} = \sqrt{\frac{γ + 1}{{( γ + 2 )}^{2} ( γ + 3 )} .}$$

The standard deviation σᵣₑₗ defines the amount of averaging, and the value of the constant γ, which parameterizes the averaging function pₜ_{_{c}}, can be obtained by solving a 3^{rd} order polynomial and taking the unique positive root:

$$\begin{matrix}\frac{γ + 1}{{( γ + 2 )}^{2} ( γ + 3 )} = {σ}_{rel}^{2} , \\ {( γ + 2 )}^{2} ( γ + 3 ) - ( γ + 1 ) {σ}_{rel}^{- 2} = 0 ,\end{matrix}$$

$$and$$

$${γ}^{3} + 7 {γ}^{2} + ( 16 - {σ}_{rel}^{- 2} ) γ + ( 12 - {σ}_{rel}^{- 2} ) = 0 .$$

To update the one or more sets of averaged network parameters at 112, each set of averaged network parameters \hat{θ}(t_{c}) is computed, using a corresponding set of averaged network parameters \hat{θ}(t_{c-Δt}) from the prior training step t_{c-Δt} along with the set of instantaneous network parameters θ(t_{c}) resulting from the parameter update at 108, according to:

$$\hat{θ} ( {t}_{c} ) = β ( {t}_{c} ) \hat{θ} ( {t}_{c - Δ t} ) + ( 1 - β ( {t}_{c} ) ) θ ( {t}_{C} ) ,$$

where:

$$β ( {t}_{n} ) = \frac{g ( {t}_{c - Δ t} )}{g ( {t}_{c} )} = {( \frac{{t}_{c - Δ t}}{{t}_{c}} )}^{γ + 1} = {( 1 - \frac{Δ t}{{t}_{c}} )}^{γ + 1} .$$

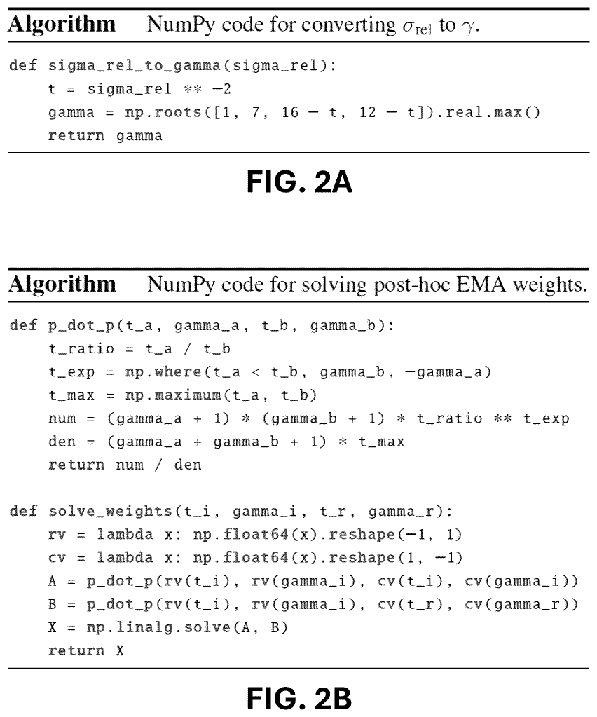

FIG. 2A illustrates an algorithm, according to at least one embodiment, for converting the standard deviation σᵣₑₗ to the parameterization constant γ. While the parameterization constant γ is mathematically straightforward, its effect on the shape of the averaging function is not entirely intuitive. To provide a parameterization with a more intuitive meaning, the averaging function can be parameterized by its relative standard deviation σᵣₑₗ=(γ+1)^{1/2}(γ+2)⁻¹(γ+3)^{-1/2}, which represents the “width” of the averaging function relative to training time. Any specified standard deviation σᵣₑₗ can then be converted to the parameterization constant γ. For example, an averaging length of 10% can be designated to refer to a profile with σᵣₑₗ=0.10 (equivalent to γ≈6.94).

At 114, the process 10 determines whether a criterion for storing the one or more sets of averaged network parameters (maintained during training phase 100 and updated at 112) is satisfied. Specifically, the process determines whether the current training step t_{c} is divisible by n. If the current training step t_{c} is not divisible by n, the process proceeds to 118. If the current training step t_{c} is divisible by n, the process proceeds to 116, where each of the one or more sets of averaged network parameters is stored as a component of a basis set 121A of snapshots of averaged parameters. In this manner, the process 10 stores, after every n training steps and for each averaging function/averaging parameter combination, a snapshot of averaged network parameters. In at least one embodiment, the process 10 stores, after every n training steps, two snapshots of exponential moving averages, each with a different EMA half-life λ, at 116. In at least one embodiment, the process 10 stores, after every n training steps, two snapshots of power function moving averages, each with a different parameterization constant γ, at 116. In at least one embodiment, the snapshots are stored at uneven intervals, e.g., when t_{c}=2ⁱ.

At 118, the process 10 compares the value of the current training step t_{c} to a maximum training step value tₘₐₓ. If the value of the current training step t_{c} equals the maximum training step value tₘₐₓ, the process 10 proceeds to post-training phase 120. If the value of the current training step t_{c} is less than the maximum training step value tₘₐₓ, the process 10 continues to perform the training phase 100 until a number of training steps equal to the maximum training step value tₘₐₓ have been performed.

The post-training phase 120 utilizes the basis set 121A of snapshots of averaged network parameters (which were stored at 116 during various training steps of training phase 100) and one or more desired averaging functions 121B. In at least one embodiment, the basis set 121A of snapshots is represented as \hat{Θ}={\hat{θ}₁, \hat{θ}₂, . . . , \hat{θ}_{N}}, each snapshot \hat{θ}ᵢ (for i=1, 2, . . . , N) corresponding to a different combination of averaging function, averaging parameterization, and training interval. In at least one embodiment, each snapshot \hat{θ}ᵢ(tᵢ, λᵢ) is a snapshot of an exponential moving average after tᵢ training steps with an EMA half-life of λᵢ. In at least one embodiment, each \hat{θ}ᵢ(tᵢ, γᵢ) is a snapshot of a power function moving average after tᵢ training steps with a parameterization constant of γᵢ. In at least one embodiment, each desired averaging function of the one or more desired averaging functions 121B is represented as pᵣ(t).

During post-training phase 120, the process 10 determines, at 122, a combination, for each of the one or more desired averaging functions 121B, of snapshots from the basis set 121A that provides an approximation of a set of averaged network parameters computed by averaging the instantaneous parameters of each of the tₘₐₓ training steps with the desired averaging function. In at least one embodiment, the process determines, at 122, a combination of snapshots that approximates averaging the instantaneous parameters of each of the tₘₐₓ training steps with the desired averaging function pᵣ(t) such that:

$${\hat{θ}}_{r}^{*} = {\sum }_{i} {x}_{i} {\hat{θ}}_{i}$$

$$= {\sum }_{i} {x}_{i} {𝔼}_{t ∼ {p}_{i} ( t )} [ θ ( t ) ]$$

$$= {\sum }_{i} {x}_{i} {\int }_{- ∞}^{∞} {p}_{i} ( t ) θ ( t ) dt$$

$${\int }_{- ∞}^{∞} θ ( t ) {\underbrace{{\sum }_{i} {p}_{i} ( t ) {x}_{i}}}_{= : {p}_{r}^{*} ( t )} dt ,$$

where \hat{θ}ᵢ ∈\hat{Θ} and the contribution of each Bi is weighted by xᵢ∈ [symbol] , resulting in the corresponding approximate response function pᵣ*(t)≅pᵣ(t). In other words, the process determines, at 122, a weighted average of snapshots from basis set 121A by selecting the weights {xᵢ} of the weighted average so that pᵣ*(t) matches the desired response function pᵣ(t) as closely as possible. The weights {xᵢ} can be represented by column vector x=[x₁, x₂, . . . , x_{N} ]^{T} ∈ [symbol] ^{N} and the averaging function corresponding to each snapshot can be represented by p=[p₁, p₂, . . . , N] for each θ{\hat{θ}₁, \hat{θ}₂, . . . , N} in basis set \hat{Θ}, so that p(t) maps to the row vector [p₁(t), p₂(t), . . . , p_{N}(t)]∈ [symbol] ^{N}, and so that the approximate averaging function can be represented as an inner product pᵣ*(t)=p(t)x.

In at least one embodiment, the weights {xᵢ} of the weighted average of snapshots are determined via a least squares solution, i.e., by minimizing:

$$ℒ ( x ) = {‖ {p}_{r}^{*} ( t ) - {p}_{r} ( t ) ‖}_{2}^{2} = {\int }_{- ∞}^{∞} {( {p}_{r}^{*} ( t ) - {p}_{r} ( t ) )}^{2} dt .$$

In at least one embodiment, to solve for the minimum of [symbol] (x), the process sets the gradient of [symbol] (x) with respect to the column vector x equal to zero:

$$0 = {∇}_{x} ℒ ( x )$$

$$= {∇}_{x} [ {\int }_{- ∞}^{∞} {( p ( t ) x - {p}_{r} ( t ) )}^{2} dt ]$$

$$= {\int }_{- ∞}^{∞} {∇}_{x} [ {( p ( t ) x - {p}_{r} ( t ) )}^{2} ] dt$$

$$= {\int }_{- ∞}^{∞} ( p ( t ) x - {p}_{r} ( t ) ) {∇}_{x} [ p ( t ) x - {p}_{r} ( t ) ] dt$$

$$= {\int }_{- ∞}^{∞} ( p ( t ) x - {p}_{r} ( t ) ) {p ( t )}^{T} dt$$

$$= {\int }_{- ∞}^{∞} ( {p ( t )}^{T} p ( t ) x - {p ( t )}^{T} {p}_{r} ( t ) ) dt$$

$$= {\underbrace{{\int }_{- ∞}^{∞} {p ( t )}^{T} p ( t ) dt}}_{= : A} x - {\underbrace{{\int }_{- ∞}^{∞} {p ( t )}^{T} {p}_{r} ( t ) dt .}}_{= : b}$$

The result is a standard matrix equation Ax−b=0, to which the solution is x=A⁻¹b. The individual elements of A and b can be expressed as inner products between their corresponding averaging functions:

$$\begin{matrix}A = [ {a}_{ij} ] , {a}_{ij} = 〈 {p}_{i} , {p}_{j} 〉 , \\ b = {[ {b}_{i} ]}^{T} , {b}_{i} = 〈 {p}_{i} , {p}_{r} 〉 ,\end{matrix}$$

where:

$$〈 f , g 〉 = {\int }_{- ∞}^{∞} f ( x ) g ( x ) dx .$$

The inner products can be computed for arbitrary averaging functions with arbitrary parameterizations using standard numerical methods, such as Monte Carlo integration.

In at least one embodiment, the averaging functions {pᵢ} corresponding to the snapshots θᵢ={\hat{θ}₁, \hat{θ}₂, . . . } in basis set \hat{Θ} 121A and the desired averaging function pᵣ are all power function averaging functions defined according to:

$$p ( t ) = \frac{f ( t )}{g ( {t}_{c} )} ,$$

$$f ( t ) = {t}^{γ} ,$$

$$and$$

$$g ( {t}_{c} ) = \frac{{t}_{c}^{γ + 1}}{γ + 1} .$$

In this embodiment, every averaging function—i.e., every averaging function corresponding to a snapshot and the desired averaging function pᵣ(t)—is uniquely defined by the combination of a training interval t and the constant γ, i.e., by (t, γ). Therefore, pᵢ(t)=pₜ_{ᵢ}_{,γ}_{ᵢ}(t) and pᵣ(t)=pₜ_{ᵣ}_{,γ}_{ᵣ}(t). The weights {xᵢ} of the weighted average of snapshots can be determined by computing x=A⁻¹b using inner products [symbol] pₜ_{ₐ}_{,γ}_{ₐ},pₜ_{_{b}}_{,γ}_{_{b}} [symbol] . For tₐ≤t_{b}, the inner product can be computed as:

$$〈 {p}_{{t}_{a , {γ}_{a}}} , {p}_{{t}_{b} , {γ}_{b}} 〉 = {\int }_{- ∞}^{∞} {p}_{{t}_{a , {γ}_{a}}} ( t ) {p}_{{t}_{b} , {γ}_{b}} ( t ) dt$$

$$= {\int }_{0}^{{t}_{a}} \frac{{f}_{{γ}_{a}} ( t )}{{g}_{{γ}_{a}} ( {t}_{a} )} \cdot \frac{{f}_{{γ}_{b}} ( t )}{{g}_{{γ}_{b}} ( {t}_{b} )} dt$$

$$= \frac{1}{{g}_{{γ}_{a}} ( {t}_{a} ) {g}_{{γ}_{b}} ( {t}_{b} )} {\int }_{0}^{{t}_{a}} {f}_{{γ}_{a}} ( t ) {f}_{γ b} ( t ) dt$$

$$= \frac{( {γ}_{a} + 1 ) ( {γ}_{b} + 1 )}{{t}_{a}^{γ a + 1} {t}_{b}^{{γ}_{b} + 1}} {\int }_{0}^{{c}_{a}} {t}^{{γ}_{a} + {γ}_{b}} dt$$

$$= \frac{( {γ}_{a} + 1 ) ( {γ}_{b} + 1 )}{{t}_{a}^{{γ}_{a} + 1} {t}_{b}^{{γ}_{b} + 1}} \cdot \frac{{t}_{a}^{{γ}_{a} + {γ}_{b} + 1}}{{γ}_{a} + {γ}_{b} + 1}$$

$$= \frac{( {γ}_{a} + 1 ) ( {γ}_{b} + 1 ) {( {t}_{a} / {t}_{b} )}^{{γ}_{b}}}{( {γ}_{a} + {γ}_{b} + 1 ) {t}_{b}} .$$

For tₐ>t_{b}, the terms can be redefined (tₐ, γₐ)↔(t_{b}, γ_{b}) and the foregoing computation can be employed. Therefore, in at least one embodiment, the determining, at 122, the weights {xᵢ} of the weighted average of snapshots can be performed by first populating the elements of A and b using the above derived inner product and then solving the matrix equation Ax−b=0 for the column vector x.

FIG. 2B illustrates an algorithm, according to at least one embodiment, for determining, at 122, the weights of one or more weighted averages of snapshots that provide an approximation of a set of averaged network parameters computed by averaging the instantaneous parameters of each of the tₘₐₓ training steps with one or more desired averaging functions. The algorithm in FIG. 2B accepts a list of {tᵢ} and {γᵢ}, corresponding to the snapshots of the basis set 121A, as well as a list of {tᵣ} and {γᵣ} corresponding to the desired averaging functions 121B. The algorithm returns a matrix of averaging weights whose columns represent the desired averaging functions while the rows represent the snapshots.

Following the determination, at 122, the weights of one or more weighted averages of snapshots, the process 10 synthesizes, for each of the one or more desired averaging functions 121B, a set of averaged network parameters. Each synthesized set of averaged network parameters provides a set of network parameters that defines, along with a predefined network architecture, a trained neural network. At 130, the process provides the one or more trained neural networks as output.

During neural network training, parameters learned over numerous (e.g. millions) of training iterations. For large neural networks (including, e.g., millions of parameters), although the performance of the network as a whole will converge after a sufficient number of training iterations (e.g. a loss function will come to satisfy a convergence criterion), the values of individual parameters will continue to fluctuate. In order to filter out the noise inherent in such post-convergence fluctuations, the instantaneous parameters resulting from each of multiple training iterations can be averaged to provide the final parameters of a trained model used at inference. In this manner, the final parameters are not determined solely from the result of a single training iteration but are instead selected by averaging instantaneous parameters that result from each of multiple training iterations. In some neural networks, e.g. denoising diffusion models, such averaging is an essential step in constructing a viable model-without it, model performance is typically inadequate.

The performance of a large neural network can be very sensitive to the specific averaging function and the parameters chosen therefore. “Good” choices for the averaging function and parameters will yield a neural network that performs well at the tasks for which it has been trained, while “poor” choices for the averaging function and parameters will yield a neural network that does not perform as well. Proper selection of the averaging characteristics is therefore essential to the development of high performance neural networks, and—because state-of-the-art training techniques require the selection of averaging characteristics prior to training—a “poor” choice can require a very costly re-training process (e.g., training a denoising diffusion model can require on the order of 150,000 GPU hours at a cost of approximately $600,000). By facilitating the construction of neural networks with parameters having an averaging function that is specified post-hoc (i.e., after training), the process 10 facilitates fine-tuning of averaging function parameters after training and without any retraining, thereby yielding trained neural networks that exhibit enhanced accuracy at inference while simultaneously reducing outlays—in terms of both compute costs and financial costs—required for training.

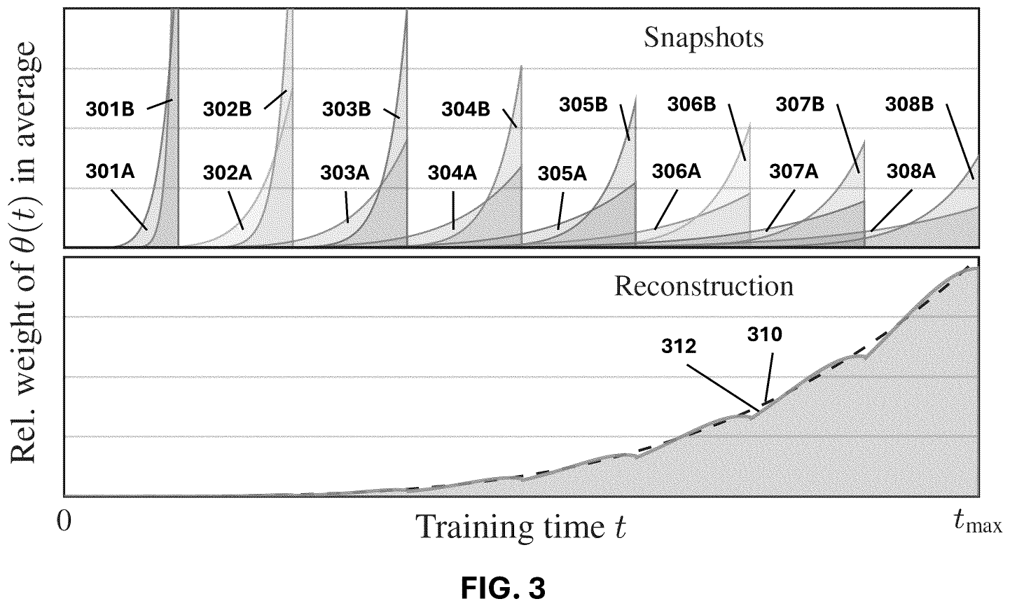

FIG. 3 illustrates, according to at least one embodiment, the construction of a basis set of snapshots (each snapshot being a set of parameters that are averaged, after t training steps, by an averaging function parameterized by one or more averaging parameters) and the post-hoc reconstruction of a desired averaging function as a weighted average of snapshots selected from the basis set. During training of a neural network (e.g. the training phase 100 of process 10 of FIG. 1), two snapshots are periodically stored (e.g. after every n training ste—s)—each of the two snapshots being a set of parameters averaged by an averaging function parameterized by a different set of averaging parameters. Specifically, in FIG. 3, a first snapshot 301A, which is a set of instantaneous parameters averaged by a power function averaging function with are, of 0.10, and a second snapshot 301B, which is a set of instantaneous parameters averaged by a power function averaging function with σᵣₑₗ of 0.05, are stored after n training steps. Then, as training progresses, first and second snapshots 302A and 302B (instantaneous parameters averaged by a power function averaging function with σᵣₑₗ of 0.10 and 0.05, respectively) are also stored after 2n training steps, after 3n training steps (303A and 303B), after 4n training steps (304A and 304B), and after every n training steps until training concludes after tₘₐₓ=8n training steps. The snapshots (i.e., 301A through 308A and 301B through 308B) stored during training form a basis set from which a set of instantaneous parameters averaged according to a post-hoc desired averaging function can be synthesized. In the embodiment illustrated in FIG. 3, the neural network is a denoising diffusion model (DDM), and the first and second snapshots (i.e., 30XA and 30XB) are stored once every 8 million training images, i.e., once every 4096 training steps with batch size of 2048 images, until training concludes after 64 million training images.

During post-training (e.g. the post-training phase 120 of process 10 of FIG. 1), a post-hoc desired averaging function 310 is reconstructed as a weighted average 312 of the snapshots that form the basis set. In at least one embodiment, the weighted average 312 is determined via the computations described in connection with the determining performed at 122 in the process 10. The post-hoc desired averaging function 310 is not limited to the power function averaging functions used for the snapshots (i.e., 30XA and 30XB), but can instead be any type of averaging function parameterized with any parameters. In at least one embodiment, the post-hoc desired averaging function 310 is derived from any of: a suitably-shaped probability distribution (e.g. Gamma distribution, Chi-squared distribution), a local polynomial regression (e.g. LOWESS), or a higher-order infinite impulse response (IIR) filter (e.g. Butterworth filter).

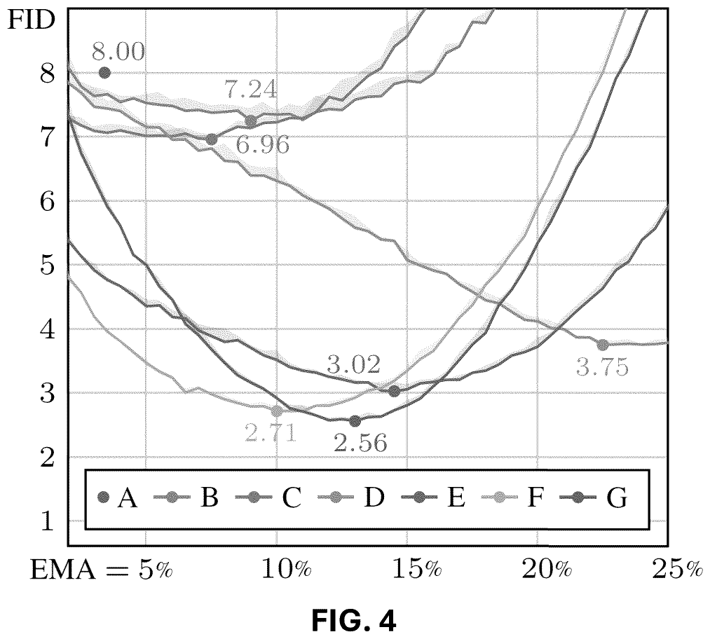

FIG. 4 illustrates, for each of seven different neural network architectures (i.e., “A,” “B,” “C,” “D,” “E,” “F,” and “G”), the impact of averaging function parameterization on neural network performance. Specifically, FIG. 4 plots, for each of seven different diffusion model architectures, the Frdchet Inception Distance (FID) as a function σᵣₑₗ, referred to as “EMA length.” FID is a quantitative measure of how similar a distribution of images generated by a trained neural network is to a distribution of real images. A lower FID score indicates that the generated images are more similar to the real images in terms of both quality and diversity.

In FIG. 4, diffusion model architecture A was trained using traditional EMA (EMA length was specified prior to training and no basis set was constructed during training), and thus only a single point is shown. Diffusion model architectures B through G were trained via a process that involved constructing a basis set of snapshots by storing snapshots of sets of averaged parameters during training such that a set of averaged parameters corresponding to EMA lengths of 0% to 25% could be constructed after training concluded. As is illustrated in FIG. 4, the exact EMA length at which each diffusion model architecture achieved its best performance varied from one model to another. Furthermore, as is also illustrated in FIG. 4, the selection of an EMA length at which a minimal FID is obtained for one architecture (e.g. architecture D achieved a minimum FID of 3.75 for an EMA length of ˜22%) can result in sub-optimal performance for other architectures (e.g., for an EMA length of ˜22%, the FID for each of architectures F and G exceeds 7—far from their minimum FID scores of 2.71 and 2.56, respectively). While traditional EMA would require multiple training runs—and hundreds of thousands of GPU hours and millions of dollars—to fine tune averaging function parameterization for a given model architecture, the post-hoc reconstruction of a set of instantaneous parameters averaged according to any desired averaging function enables, according to at least one embodiment, the fine tuning of averaging function parameterization without any retraining.

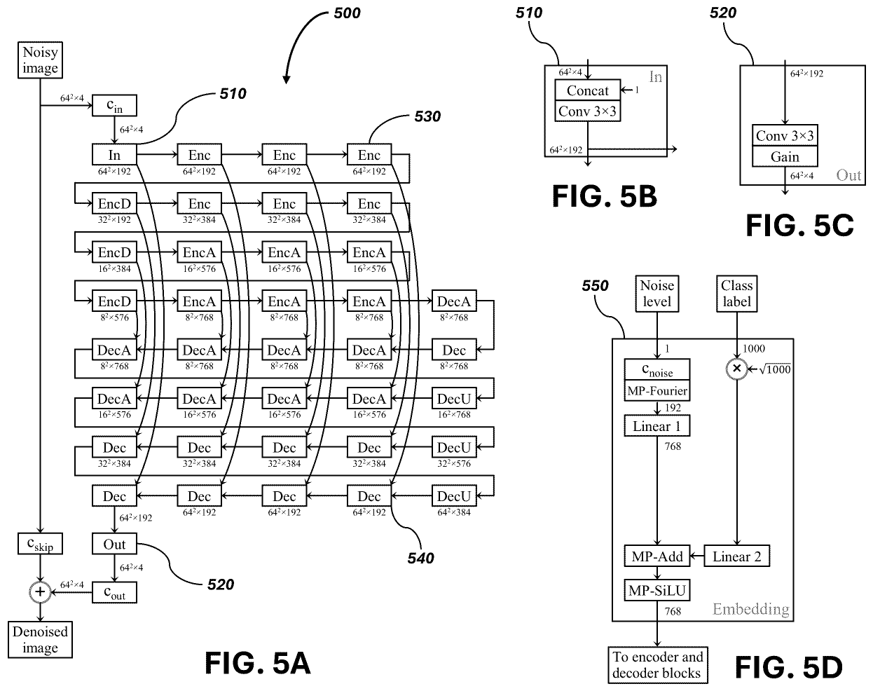

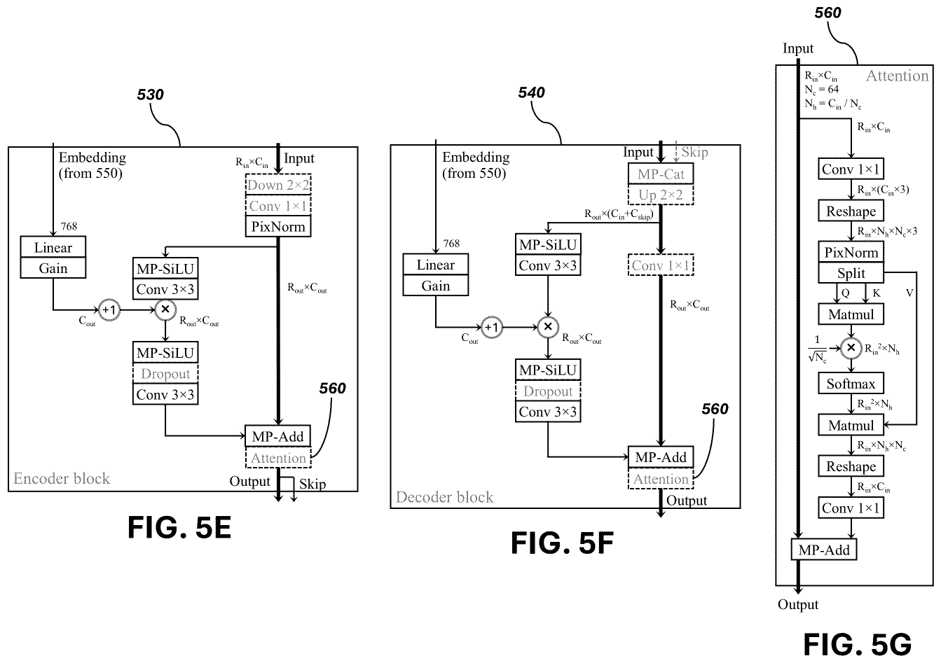

FIG. 5A illustrates a diffusion model (DM) architecture, according to at least one embodiment. The DM 500 receives, as input, a noisy image and generates, as output, a denoised image. The DM 500 includes an input block 510, an output block 520, a plurality of encoder blocks (Enc), e.g. encoder block 530, and a plurality of decoder blocks (Dec), e.g. decoder block 540. The DM 500 additionally includes an embedding network 550 that conditions the encoder blocks and the decoder blocks with a noise level and class label. In at least one embodiment, parameters of learned layers (included in one or more of the input block 510, the output block 520, an encoder block of the plurality of encoder blocks, and/or a decoder block of the plurality of decoder blocks) are averaged parameters that are provided via the process 10 of FIG. 1.

The plurality of encoder blocks include encoder downsampling blocks (EncD) which perform downsampling operations on the input they receive. The encoder downsampling blocks reduce spatial dimensions of their input and/or increase the number of channels/features incorporated in their output. The plurality of decoder blocks include decoder upsampling blocks (DecU) which perform upsampling operations on the input they receive. The decoder upsampling blocks increase spatial dimensions of the input they receive and/or decrease the number of channels/features incorporated in their output. The plurality of encoder blocks and the plurality of decoder blocks additionally include encoder attention blocks (EncA) and decoder attention blocks (DecA) which incorporate attention mechanisms into encoding processes and decoding processes, respectively. The encoder attention blocks enable the DM 500 to capture long-range dependencies in the data, allow the encoder to focus on relevant parts of the input, and enhance the ability of the DM 500 to learn complex relationships. The decoder attention blocks enable the DM 500 to refine generated output by attending to relevant encoded features, improve the coherence and quality of the reconstructed data, and allow the decoder to access information from the entire input sequence. In at least one embodiment, one or more encoder attention blocks and one or more decoder attention blocks utilize self-attention. In at least one embodiment, one or more encoder attention blocks and one or more decoder attention blocks utilize cross-attention. In at least one embodiment, one or more encoder attention blocks and one or more decoder attention blocks utilize both self-attention and cross-attention.

FIG. 5B illustrates an input block 510 of the diffusion model of FIG. 5A, according to at least one embodiment. The input block 510 includes a concatenation layer and a convolutional layer. In at least one embodiment, the convolutional layer of the input block 510 is a learned layer with averaged parameters that are provided via the process 10 of FIG. 1. FIG. 5C illustrates an output block 520 of the diffusion model of FIG. 5A, according to at least one embodiment. The output block 520 includes a convolutional layer and a gain parameter. In at least one embodiment, the convolutional layer of the output block 520 is a learned layer with averaged parameters that are provided via the process 10 of FIG. 1.

FIG. 5D illustrates an embedding network of the diffusion model of FIG. 5A, according to at least one embodiment. The embedding network 550 receives, as input, a noise level and a class label and processes the input to provide, as input for the encoder and decoder blocks, a combined noise level and class label embedding. The embedding network 550 thereby both (i) encodes the noise level of a diffusion process into a vector representation that can be used by the encoder and decoder blocks of the DM 500 and (ii) encodes class labels into a vector representation that can be used by the encoder and decoder blocks of the DM 500. The embedding network 550 includes a magnitude preserving summation layer (MP-Add) that combines the noise level and class label embeddings. In at least one embodiment, the first linear layer (Linear 1) and/or the second linear layer (Linear 2) of the embedding network 550 is a learned layer with averaged parameters that are provided via the process 10 of FIG. 1.

FIG. 5E illustrates an encoder block of the diffusion model of FIG. 5A, according to at least one embodiment. The encoder block 530 receives, as input, an embedding from embedding network 550 and a main path input (e.g. from input block 510 or from a preceding encoder block). The encoder block 530 process the input embedding and the main path input to generate output, which is provided to both (i) a subsequent encoder block or a decoder block in the main path and (ii) a corresponding decoder block via a skip connection. The encoder block 530 includes a linear layer (Linear) and two convolutional layers (Conv 3×3). In at least one embodiment, the linear layer (Linear) and/or one or more of the two convolutional layers (Conv 3×3) is a learned layer with averaged parameters that are provided via the process 10 of FIG. 1.

If the encoder block 530 is an encoder downsampling block (EncD), the encoder block 530 includes a downsampling layer (Down 2×2) and a convolutional layer (Conv 1×1). In at least one embodiment, the downsampling layer (Down 2×2) and/or the convolutional layer (Conv 1×1) is a learned layer with averaged parameters that are provided via the process 10 of FIG. 1. If the encoder block 530 is an encoder attention block (EncA), the encoder block 530 includes an attention block 560. In at least one embodiment, the attention block 560 includes a learned layer with averaged parameters that are provided via the process 10 of FIG. 1.

FIG. 5F illustrates a decoder block of the diffusion model of FIG. 5A, according to at least one embodiment. The decoder block 540 receives, as input, an embedding from embedding network 550, a main path input (e.g. from a preceding encoder or decoder block), and a skip connection input from a corresponding encoder block. The decoder block 540 processes the input to generate output, which is provided, via the main path, to a subsequent decoder block or to the output block 520. The decoder block 540 includes a linear layer (Linear) and two convolutional layers (Conv 3×3). In at least one embodiment, the linear layer (Linear) and/or one or more of the two convolutional layers (Conv 3×3) is a learned layer with averaged parameters that are provided via the process 10 of FIG. 1.

If the decoder block 540 is decoder upsampling block (DecU), the decoder block 540 includes an upsampling layer (Up 2×2) and a convolutional layer (Conv 1×1). In at least one embodiment, the upsampling layer (Up 2×2) and/or the convolutional layer (Conv 1×1) is a learned layer with averaged parameters that are provided via the process 10 of FIG. 1. If the decoder block is a decoder attention block (DecA), the decoder block 540 includes an attention block 560. In at least one embodiment, the attention block 560 includes a learned layer with averaged parameters that are provided via the process 10 of FIG. 1.

FIG. 5G illustrates an attention block of the diffusion model of FIG. 5A, according to at least one embodiment. The attention block 560 receives input, processes the input to capture, e.g., contextual information and long-range dependencies in the data, and provides output that incorporates, e.g., the contextual information and/or information pertaining to the long-range dependencies. The attention block 560 includes two convolutional layers (Conv 1×1). In at least one embodiment, one or both of the convolutional layers (Conv 1×1) is a learned layer with averaged parameters that are provided via the process 10 of FIG. 1.

### Logic

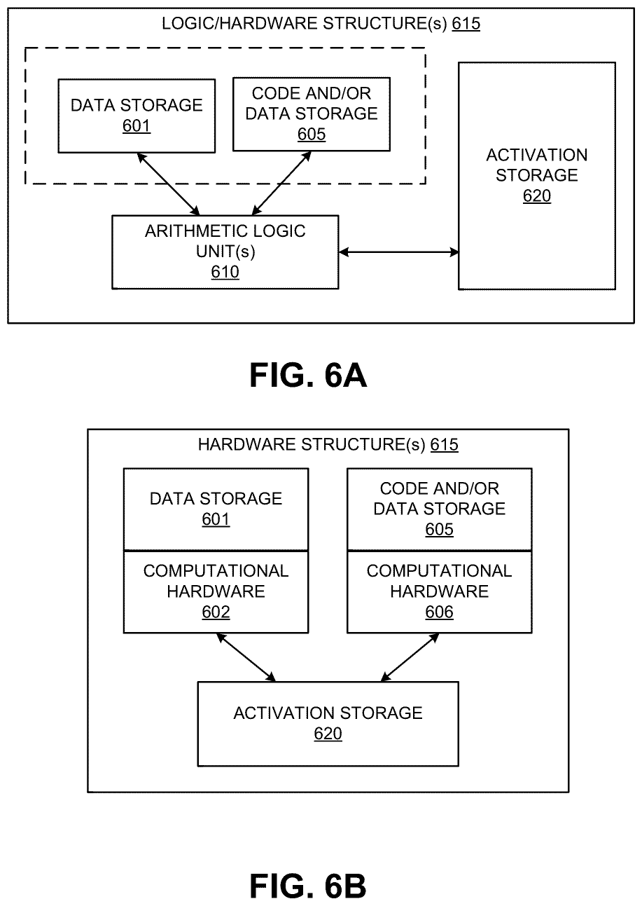

FIG. 6A illustrates logic 615 which, as described elsewhere herein, can be used in one or more devices to perform operations such as those discussed herein in accordance with at least one embodiment. In at least one embodiment, logic 615 is used to perform inferencing and/or training operations associated with one or more embodiments. In at least one embodiment, logic 615 is inference and/or training logic. Details regarding logic 615 are provided below in conjunction with FIGS. 6A and/or 6B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, logic 615 may include, or be coupled to code and/or data storage 601 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 601 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 615 may include, without limitation, a code and/or data storage 605 to store backward and/or output weight and/or input/output data corresponding to neurons or layers of a neural network trained and/or used for inferencing in aspects of one or more embodiments. In at least one embodiment, code and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 615 may include, or be coupled to code and/or data storage 605 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code and/or data storage 605 may be cache memory, DRAM, SRAM, non-volatile memory (e.g., flash memory), or other storage. In at least one embodiment, a choice of whether code and/or data storage 605 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 601 and code and/or data storage 605 may be separate storage structures. In at least one embodiment, code and/or data storage 601 and code and/or data storage 605 may be a combined storage structure. In at least one embodiment, code and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605. In at least one embodiment, activations stored in activation storage 620 are generated according to linear algebraic and or matrix-based mathematics performed by ALU(s) 610 in response to performing instructions or other code, wherein weight values stored in code and/or data storage 605 and/or data storage 601 are used as operands along with other values, such as bias values, gradient information, momentum values, or other parameters or hyperparameters, any or all of which may be stored in code and/or data storage 605 or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a coprocessor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 601, code and/or data storage 605, and activation storage 620 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., flash memory), or other storage. In at least one embodiment, activation storage 620 may be completely or partially within or external to one or more processors or other logical circuits. In at least one embodiment, a choice of whether activation storage 620 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 615 illustrated in FIG. 6A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates logic 615, according to at least one embodiment. In at least one embodiment, logic 615 is inference and/or training logic. In at least one embodiment, logic 615 may include, without limitation, hardware logic in which computational resources are dedicated or otherwise exclusively used in conjunction with weight values or other information corresponding to one or more layers of neurons within a neural network. In at least one embodiment, logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 615 illustrated in FIG. 6B may be used in conjunction with central processing unit (CPU) hardware, graphics processing unit (GPU) hardware or other hardware, such as field programmable gate arrays (FPGAs). In at least one embodiment, logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 comprises one or more ALUs that perform mathematical functions, such as linear algebraic functions, only on information stored in code and/or data storage 601 and code and/or data storage 605, respectively, result of which is stored in activation storage 620.

In at least one embodiment, each of code and/or data storage 601 and 605 and corresponding computational hardware 602 and 606, respectively, correspond to different layers of a neural network, such that resulting activation from one storage/computational pair 601/602 of code and/or data storage 601 and computational hardware 602 is provided as an input to a next storage/computational pair 605/606 of code and/or data storage 605 and computational hardware 606, in order to mirror a conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage/computation pairs 601/602 and 605/606 may be included in logic 615.

### Neural Network Training and Deployment

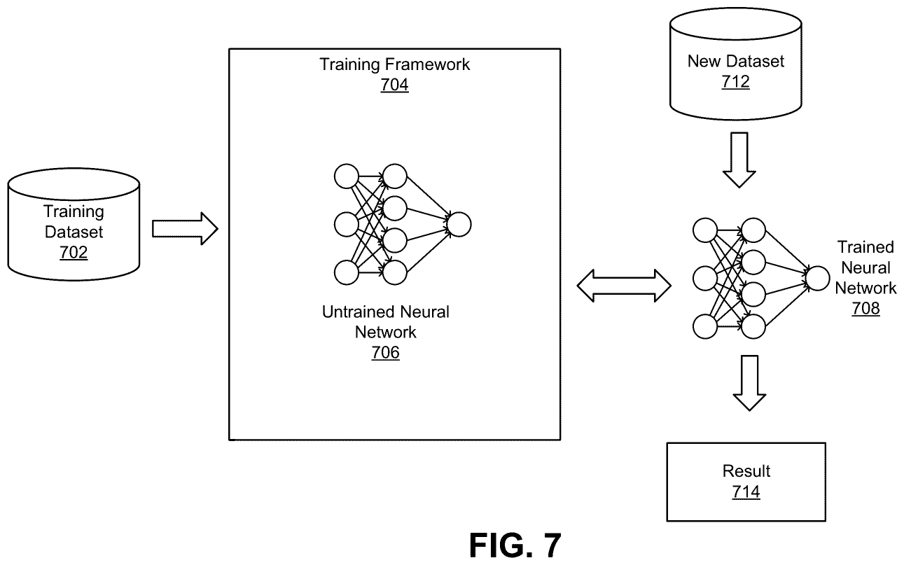

FIG. 7 illustrates training and deployment of a deep neural network, according to at least one embodiment. In at least one embodiment, untrained neural network 706 is trained using a training dataset 702. In at least one embodiment, training framework 704 is a PyTorch framework, whereas in other embodiments, training framework 704 is a TensorFlow, Boost, Caffe, Microsoft Cognitive Toolkit/CNTK, MXNet, Chainer, Keras, Deeplearning4j, or other training framework. In at least one embodiment, training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having a known output and an output of neural network 706 is manually graded. In at least one embodiment, untrained neural network 706 is trained in a supervised manner and processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on input data such as a new dataset 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map in trained neural network 708 capable of performing operations useful in reducing dimensionality of new dataset 712. In at least one embodiment, unsupervised training can also be used to perform anomaly detection, which allows identification of data points in new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new dataset 712 without forgetting knowledge instilled within trained neural network 708 during initial training.

In at least one embodiment, training framework 704 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA. In at least one embodiment, OpenVINO comprises logic 615 or uses logic 615 to perform operations described herein. In at least one embodiment, an SoC, integrated circuit, or processor uses OpenVINO to perform operations described herein.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

### Data Center

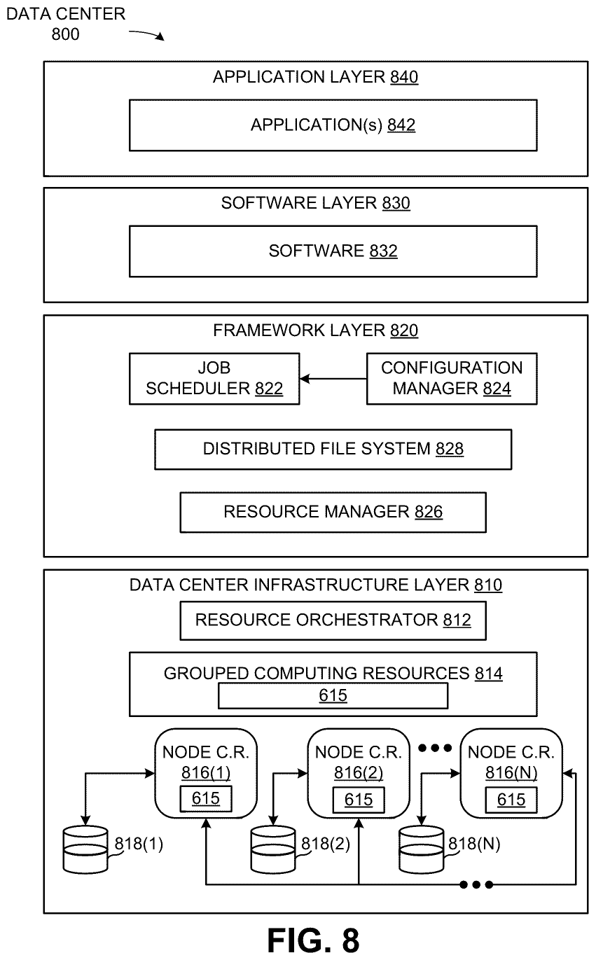

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents a positive integer (which may be a different integer “N” than used in other figures). In at least one embodiment, node C.R.s 816(1)-816(N) may include, but are not limited to, any number of central processing units (“CPUs”) or other processors (including accelerators, field programmable gate arrays (FPGAs), graphics processors, etc.), memory storage devices 818(1)-818(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). In at least one embodiment, separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 612 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. In at least one embodiment, one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 615 are used to perform inferencing and/or training operations associated with one or more embodiments. Details regarding logic 615 are provided herein in conjunction with FIGS. 6A and/or 6B. In at least one embodiment, logic 615 may be used in data center 800 for inferencing or predicting operations based, at least in part, on weight parameters calculated using neural network training operations, neural network functions and/or architectures, or neural network use cases described herein.

### Computer Systems

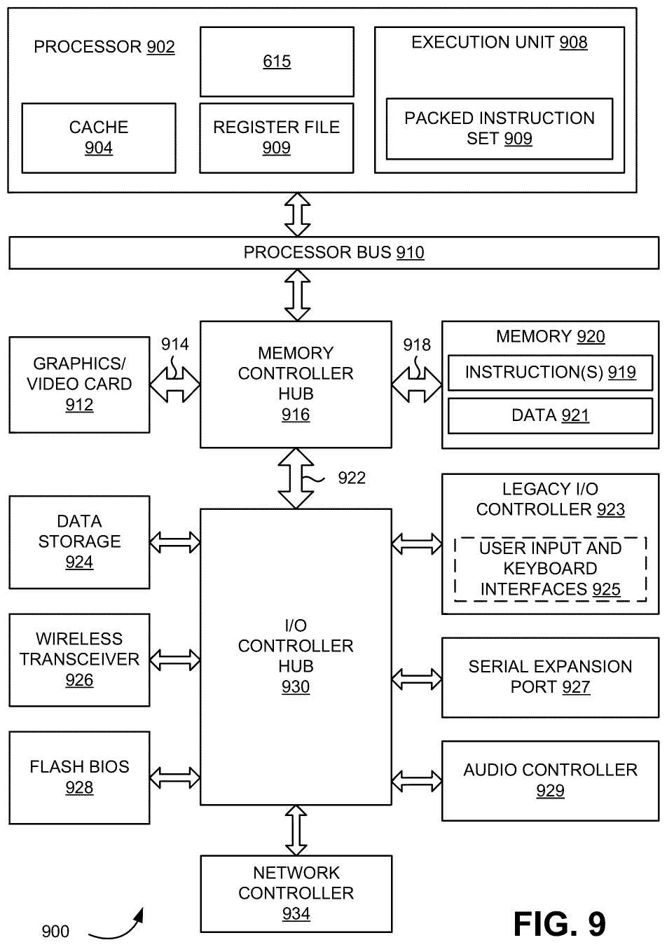

FIG. 9 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™ Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, a register file 906 may store different types of data in various registers including, without limitation, integer registers, floating point registers, status registers, and an instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor, along with associated circuitry to execute instructions, operations used by many multimedia applications may be performed using packed data in processor 902. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be a Dynamic Random Access Memory (“DRAM”) device, a Static Random Access Memory (“SRAM”) device, a flash memory device, or another memory device. In at least one embodiment, memory 920 may store instruction(s) 919 and/or data 921 represented by data signals that may be executed by processor 902.

In at least one embodiment, a system logic chip may be coupled to processor bus 910 and memory 920. In at least one embodiment, a system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O interface 922. In at least one embodiment, a system logic chip may provide a graphics port for coupling to a graphics controller. In at least one embodiment, MCH 916 may be coupled to memory 920 through high bandwidth memory path 918 and a graphics/video card 912 may be coupled to MCH 916 through an Accelerated Graphics Port (“AGP”) interconnect 914.

In at least one embodiment, computer system 900 may use system I/O interface 922 as a proprietary hub interface bus to couple MCH 916 to an I/O controller hub (“ICH”) 930. In at least one embodiment, ICH 930 may provide direct connections to some I/O devices via a local I/O bus. In at least one embodiment, a local I/O bus may include, without limitation, a high-speed I/O bus for connecting peripherals to memory 920, a chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as a Universal Serial Bus (“USB”) port, and a network controller 934. In at least one embodiment, data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary SoC. In at least one embodiment, devices illustrated in FIG. 9 may be interconnected with proprietary interconnects, standardized interconnects (e.g., PCIe) or some combination thereof. In at least one embodiment, one or more components of computer system 900 are interconnected using compute express link (CXL) interconnects.

Logic 615 are used to perform inferencing and/or training operations associated with one or more embodiments. Details regarding logic 615 are provided herein in conjunction with FIGS. 6A and/or 6B. In at least one embodiment, logic 615 may be used in computer system 900 for inferencing or predicting operations based, at least in part, on weight parameters calculated using neural network training operations, neural network functions and/or architectures, or neural network use cases described herein.

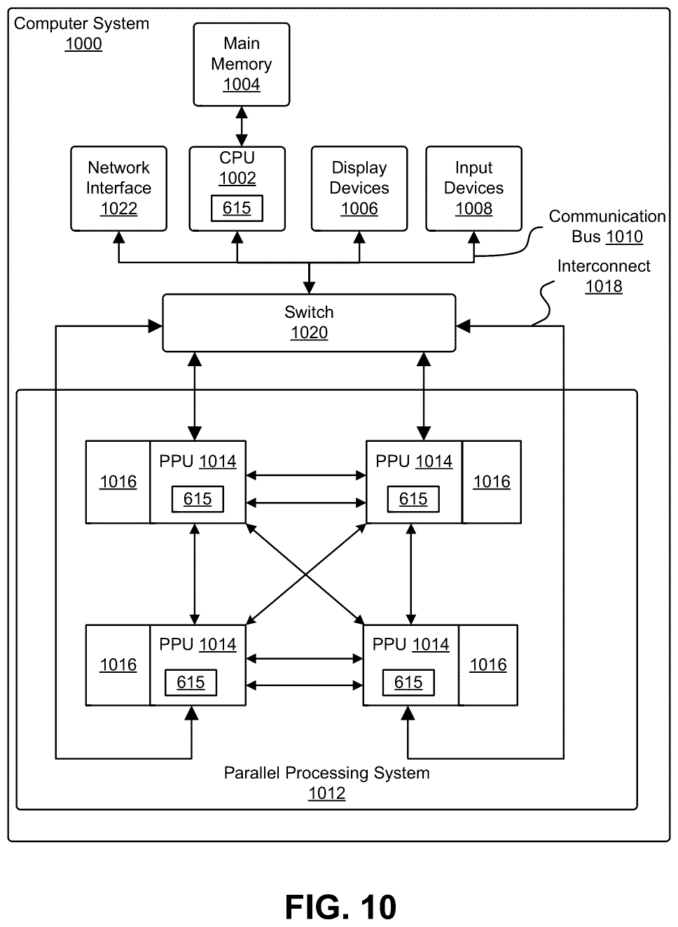

FIG. 10 illustrates a computer system 1000, according to at least one embodiment. In at least one embodiment, computer system 1000 is configured to implement various processes and methods described throughout this disclosure.

In at least one embodiment, computer system 1000 comprises, without limitation, at least one central processing unit (“CPU”) 1002 that is connected to a communication bus 1010 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1000 includes, without limitation, a main memory 1004 and control logic (e.g., implemented as hardware, software, or a combination thereof) and data are stored in main memory 1004, which may take form of random access memory (“RAM”). In at least one embodiment, a network interface subsystem (“network interface”) 1022 provides an interface to other computing devices and networks for receiving data from and transmitting data to other systems with computer system 1000.

In at least one embodiment, computer system 1000, in at least one embodiment, includes, without limitation, input devices 1008, a parallel processing system 1012, and display devices 1006 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 1008 such as keyboard, mouse, touchpad, microphone, etc. In at least one embodiment, each module described herein can be situated on a single semiconductor platform to form a processing system.

Logic 615 are used to perform inferencing and/or training operations associated with one or more embodiments. Details regarding inference and/or training logic 615 are provided herein in conjunction with FIGS. 6A and/or 6B. In at least one embodiment, logic 615 may be used in computer system 1000 for inferencing or predicting operations based, at least in part, on weight parameters calculated using neural network training operations, neural network functions and/or architectures, or neural network use cases described herein.

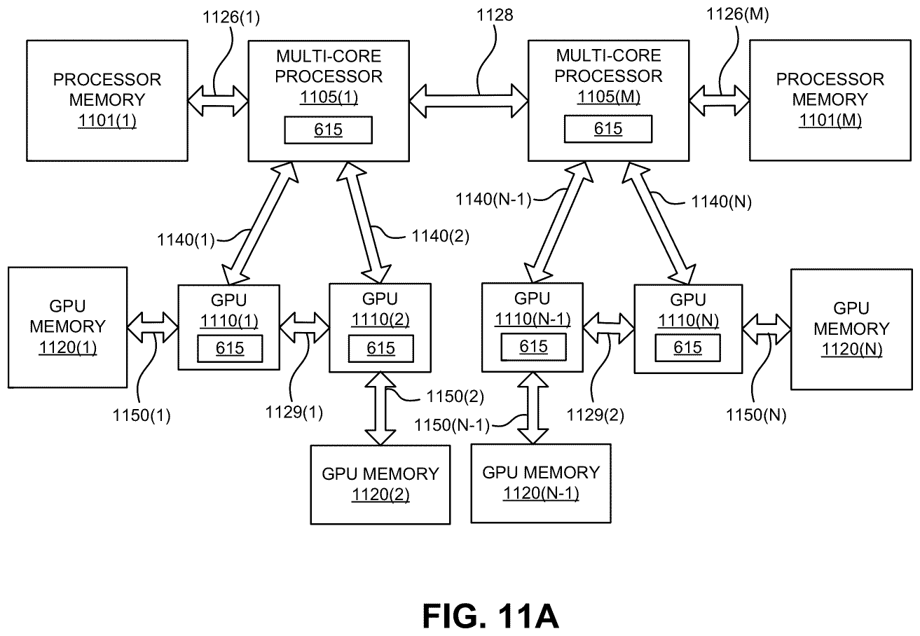

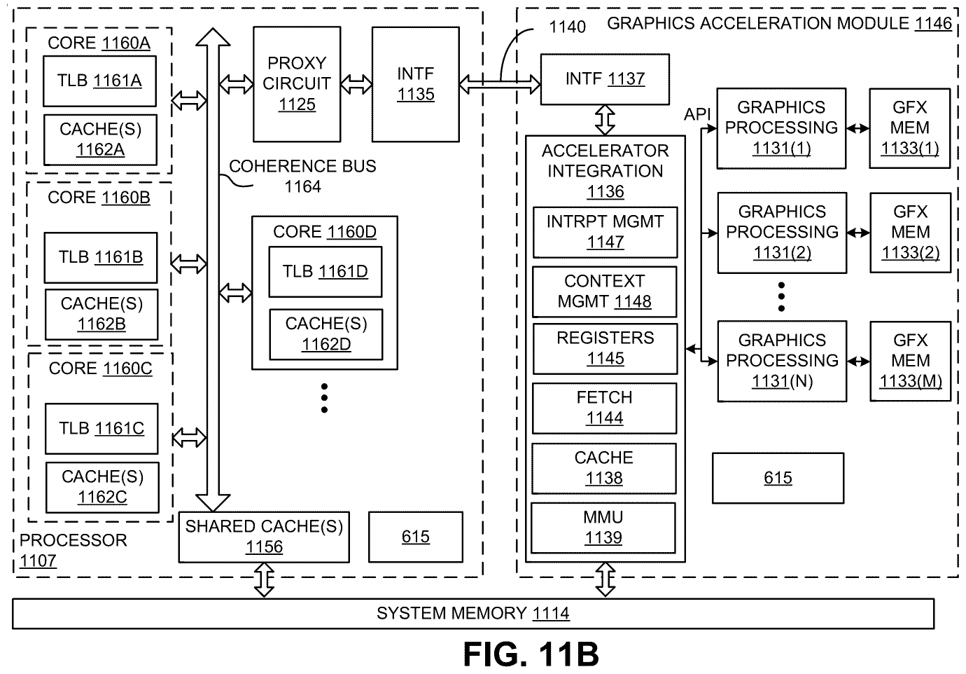

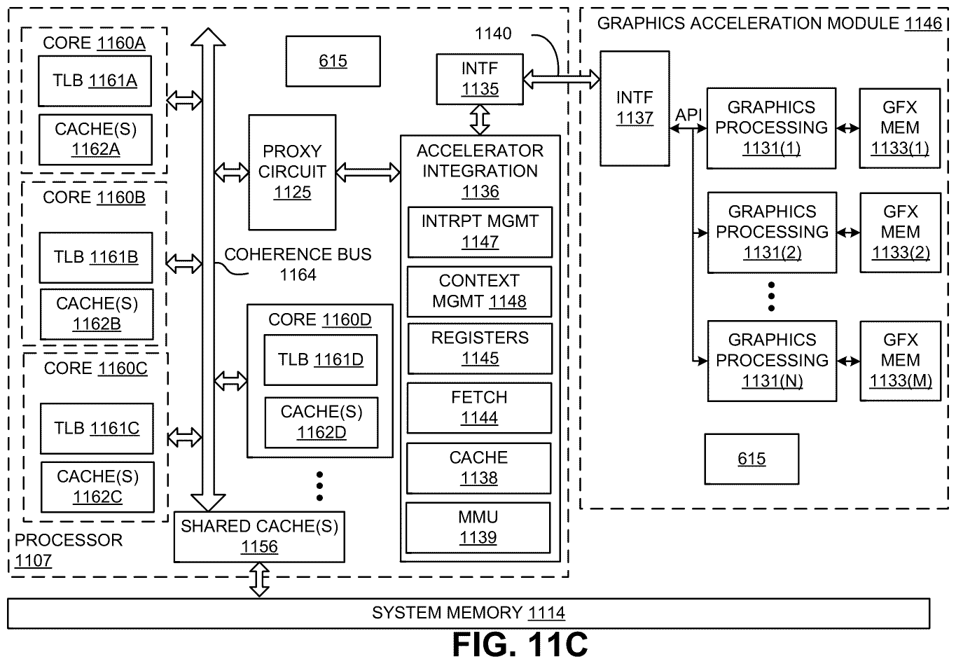

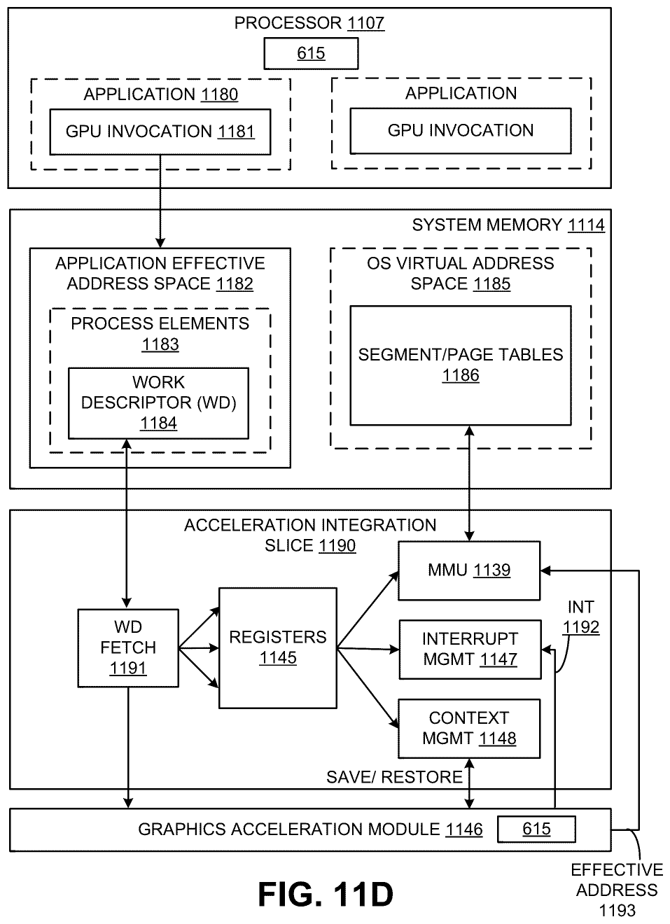

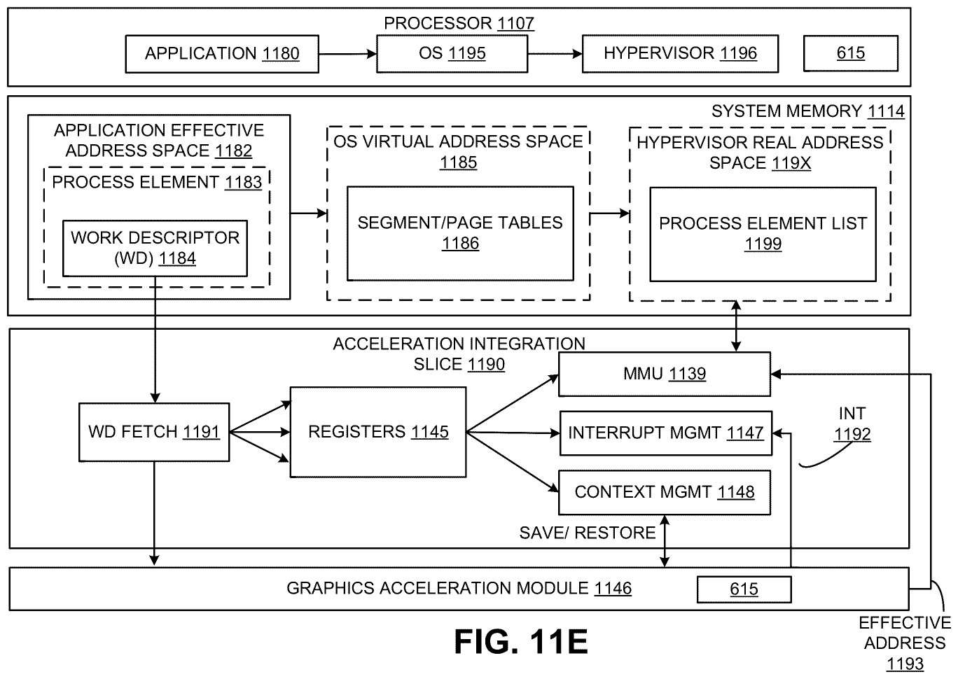

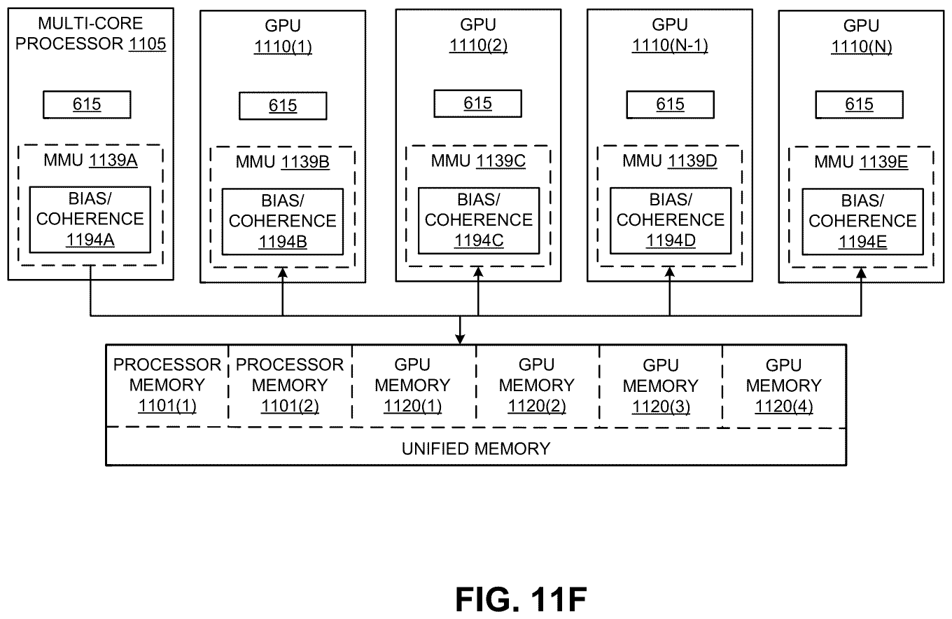

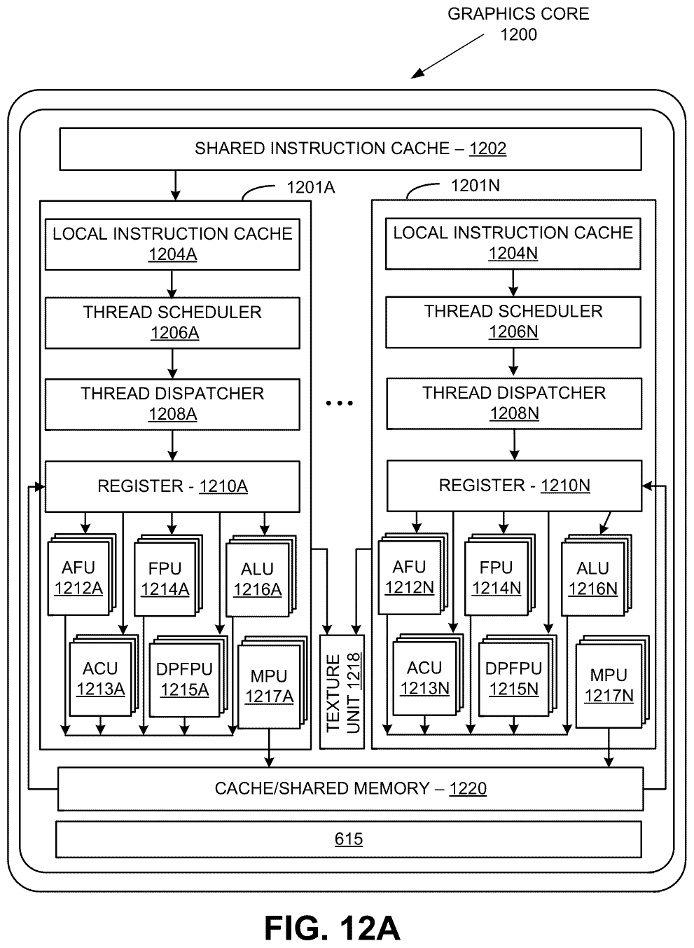

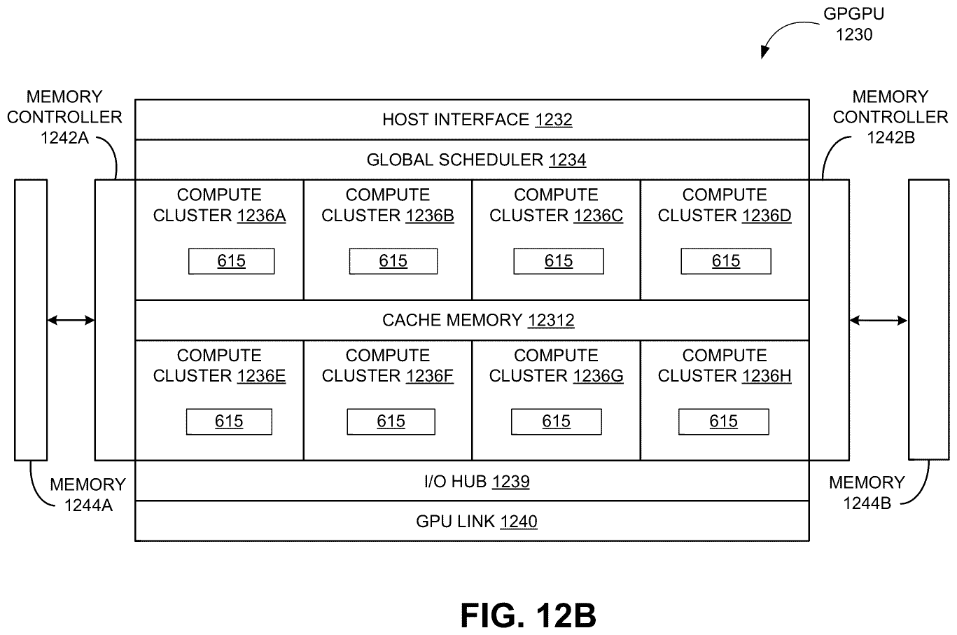

FIG. 11A illustrates an exemplary architecture in which a plurality of GPUs 1110(1)-1110(N) is communicatively coupled to a plurality of multi-core processors 1105(1)-1105(M) over high-speed links 1140(1)-1140(N) (e.g., buses, point-to-point interconnects, etc.). In at least one embodiment, high-speed links 1140(1)-1140(N) support a communication throughput of 4 GB/s, 30 GB/s, 80 GB/s or higher. In at least one embodiment, various interconnect protocols may be used including, but not limited to, PCIe 4.0 or 5.0 and NVLink 2.0. In various figures, “N” and “M” represent positive integers, values of which may be different from figure to figure. In at least one embodiment, one or more GPUs in a plurality of GPUs 1110(1)-1110(N) includes one or more graphics cores (also referred to simply as “cores”) 1200 as disclosed in FIGS. 12A and 12B. In at least one embodiment, one or more graphics cores 1200 may be referred to as streaming multiprocessors (“SMs”), stream processors (“SPs”), stream processing units (“SPUs”), compute units (“CUs”), execution units (“EUs”), and/or slices, where a slice in this context can refer to a portion of processing resources in a processing unit (e.g., 16 cores, a ray tracing unit, a thread director or scheduler).

In addition, and in at least one embodiment, two or more of GPUs 1110 are interconnected over high-speed links 1129(1)-1129(2), which may be implemented using similar or different protocols/links than those used for high-speed links 1140(1)-1140(N). Similarly, two or more of multi-core processors 1105 may be connected over a high-speed link 1128 which may be symmetric multi-processor (SMP) buses operating at 20 GB/s, 30 GB/s, 120 GB/s or higher. Alternatively, all communication between various system components shown in FIG. 11A may be accomplished using similar protocols/links (e.g., over a common interconnection fabric).

In at least one embodiment, each multi-core processor 1105 is communicatively coupled to a processor memory 1101(1)-1101(M), via memory interconnects 1126(1)-1126(M), respectively, and each GPU 1110(1)-1110(N) is communicatively coupled to GPU memory 1120(1)-1120(N) over GPU memory interconnects 1150(1)-1150(N), respectively. In at least one embodiment, memory interconnects 1126 and 1150 may utilize similar or different memory access technologies. By way of example, and not limitation, processor memories 1101(1)-1101(M) and GPU memories 1120 may be volatile memories such as dynamic random access memories (DRAMs) (including stacked DRAMs), Graphics DDR SDRAM (GDDR) (e.g., GDDR5, GDDR6), or High Bandwidth Memory (HBM) and/or may be non-volatile memories such as 3D XPoint or Nano-Ram. In at least one embodiment, some portion of processor memories 1101 may be volatile memory and another portion may be non-volatile memory (e.g., using a two-level memory (2LM) hierarchy).

As described herein, although various multi-core processors 1105 and GPUs 1110 may be physically coupled to a particular memory 1101, 1120, respectively, and/or a unified memory architecture may be implemented in which a virtual system address space (also referred to as “effective address” space) is distributed among various physical memories. For example, processor memories 1101(1)-1101(M) may each comprise 64 GB of system memory address space and GPU memories 1120(1)-1120(N) may each comprise 32 GB of system memory address space resulting in a total of 256 GB addressable memory when M=2 and N=4. Other values for N and M are possible.

FIG. 11B illustrates additional details for an interconnection between a multi-core processor 1107 and a graphics acceleration module 1146 in accordance with one exemplary embodiment. In at least one embodiment, graphics acceleration module 1146 may include one or more GPU chips integrated on a line card which is coupled to processor 1107 via high-speed link 1140 (e.g., a PCIe bus, NVLink, etc.). In at least one embodiment, graphics acceleration module 1146 may alternatively be integrated on a package or chip with processor 1107.

In at least one embodiment, processor 1107 includes a plurality of cores 1160A-1160D (which may be referred to as “execution units”), each with a translation lookaside buffer (“TLB”) 1161A-1161D and one or more caches 1162A-1162D. In at least one embodiment, cores 1160A-1160D may include various other components for executing instructions and processing data that are not illustrated. In at least one embodiment, caches 1162A-1162D may comprise Level 1 (L1) and Level 2 (L2) caches. In addition, one or more shared caches 1156 may be included in caches 1162A-1162D and shared by sets of cores 1160A-1160D. For example, one embodiment of processor 1107 includes 24 cores, each with its own L1 cache, twelve shared L2 caches, and twelve shared L3 caches. In this embodiment, one or more L2 and L3 caches are shared by two adjacent cores. In at least one embodiment, processor 1107 and graphics acceleration module 1146 connect with system memory 1114, which may include processor memories 1101(1)-1101(M) of FIG. 11A.

In at least one embodiment, coherency is maintained for data and instructions stored in various caches 1162A-1162D, 1156 and system memory 1114 via inter-core communication over a coherence bus 1164. In at least one embodiment, for example, each cache may have cache coherency logic/circuitry associated therewith to communicate to over coherence bus 1164 in response to detected reads or writes to particular cache lines. In at least one embodiment, a cache snooping protocol is implemented over coherence bus 1164 to snoop cache accesses.

In at least one embodiment, a proxy circuit 1125 communicatively couples graphics acceleration module 1146 to coherence bus 1164, allowing graphics acceleration module 1146 to participate in a cache coherence protocol as a peer of cores 1160A-1160D. In particular, in at least one embodiment, an interface 1135 provides connectivity to proxy circuit 1125 over high-speed link 1140 and an interface 1137 connects graphics acceleration module 1146 to high-speed link 1140.

In at least one embodiment, an accelerator integration circuit 1136 provides cache management, memory access, context management, and interrupt management services on behalf of a plurality of graphics processing engines 1131(1)-1131(N) of graphics acceleration module 1146. In at least one embodiment, graphics processing engines 1131(1)-1131(N) may each comprise a separate graphics processing unit (GPU). In at least one embodiment, plurality of graphics processing engines 1131(1)-1131(N) of graphics acceleration module 1146 include one or more graphics cores 1200 as discussed in connection with FIGS. 12A and 12B. In at least one embodiment, graphics processing engines 1131(1)-1131(N) alternatively may comprise different types of graphics processing engines within a GPU, such as graphics execution units, media processing engines (e.g., video encoders/decoders), samplers, and blit engines. In at least one embodiment, graphics acceleration module 1146 may be a GPU with a plurality of graphics processing engines 1131(1)-1131(N) or graphics processing engines 1131(1)-1131(N) may be individual GPUs integrated on a common package, line card, or chip.

In at least one embodiment, accelerator integration circuit 1136 includes a memory management unit (MMU) 1139 for performing various memory management functions such as virtual-to-physical memory translations (also referred to as effective-to-real memory translations) and memory access protocols for accessing system memory 1114. In at least one embodiment, MMU 1139 may also include a translation lookaside buffer (TLB) (not shown) for caching virtual/effective to physical/real address translations. In at least one embodiment, a cache 1138 can store commands and data for efficient access by graphics processing engines 1131(1)-1131(N). In at least one embodiment, data stored in cache 1138 and graphics memories 1133(1)-1133(M) is kept coherent with core caches 1162A-1162D, 1156 and system memory 1114, possibly using a fetch unit 1144. As mentioned, this may be accomplished via proxy circuit 1125 on behalf of cache 1138 and memories 1133(1)-1133(M) (e.g., sending updates to cache 1138 related to modifications/accesses of cache lines on processor caches 1162A-1162D, 1156 and receiving updates from cache 1138).

In at least one embodiment, a set of registers 1145 store context data for threads executed by graphics processing engines 1131(1)-1131(N) and a context management circuit 1148 manages thread contexts. For example, context management circuit 1148 may perform save and restore operations to save and restore contexts of various threads during contexts switches (e.g., where a first thread is saved and a second thread is stored so that a second thread can be execute by a graphics processing engine). For example, on a context switch, context management circuit 1148 may store current register values to a designated region in memory (e.g., identified by a context pointer). It may then restore register values when returning to a context. In at least one embodiment, an interrupt management circuit 1147 receives and processes interrupts received from system devices.

In at least one embodiment, virtual/effective addresses from a graphics processing engine 1131 are translated to real/physical addresses in system memory 1114 by MMU 1139. In at least one embodiment, accelerator integration circuit 1136 supports multiple (e.g., 4, 8, 16) graphics accelerator modules 1146 and/or other accelerator devices. In at least one embodiment, graphics accelerator module 1146 may be dedicated to a single application executed on processor 1107 or may be shared between multiple applications. In at least one embodiment, a virtualized graphics execution environment is presented in which resources of graphics processing engines 1131(1)-1131(N) are shared with multiple applications or virtual machines (VMs). In at least one embodiment, resources may be subdivided into “slices” which are allocated to different VMs and/or applications based on processing requirements and priorities associated with VMs and/or applications.

In at least one embodiment, accelerator integration circuit 1136 performs as a bridge to a system for graphics acceleration module 1146 and provides address translation and system memory cache services. In addition, in at least one embodiment, accelerator integration circuit 1136 may provide virtualization facilities for a host processor to manage virtualization of graphics processing engines 1131(1)-1131(N), interrupts, and memory management.

In at least one embodiment, because hardware resources of graphics processing engines 1131(1)-1131(N) are mapped explicitly to a real address space seen by host processor 1107, any host processor can address these resources directly using an effective address value. In at least one embodiment, one function of accelerator integration circuit 1136 is physical separation of graphics processing engines 1131(1)-1131(N) so that they appear to a system as independent units.

In at least one embodiment, one or more graphics memories 1133(1)-1133(M) are coupled to each of graphics processing engines 1131(1)-1131(N), respectively and N=M. In at least one embodiment, graphics memories 1133(1)-1133(M) store instructions and data being processed by each of graphics processing engines 1131(1)-1131(N). In at least one embodiment, graphics memories 1133(1)-1133(M) may be volatile memories such as DRAMs (including stacked DRAMs), GDDR memory (e.g., GDDR5, GDDR6), or HBM, and/or may be non-volatile memories such as 3D XPoint or Nano-Ram.

In at least one embodiment, to reduce data traffic over high-speed link 1140, biasing techniques can be used to ensure that data stored in graphics memories 1133(1)-1133(M) is data that will be used most frequently by graphics processing engines 1131(1)-1131(N) and preferably not used by cores 1160A-1160D (at least not frequently). Similarly, in at least one embodiment, a biasing mechanism attempts to keep data needed by cores (and preferably not graphics processing engines 1131(1)-1131(N)) within caches 1162A-1162D, 1156 and system memory 1114.

FIG. 11C illustrates another exemplary embodiment in which accelerator integration circuit 1136 is integrated within processor 1107. In this embodiment, graphics processing engines 1131(1)-1131(N) communicate directly over high-speed link 1140 to accelerator integration circuit 1136 via interface 1137 and interface 1135 (which, again, may be any form of bus or interface protocol). In at least one embodiment, accelerator integration circuit 1136 may perform similar operations as those described with respect to FIG. 11B, but potentially at a higher throughput given its close proximity to coherence bus 1164 and caches 1162A-1162D, 1156. In at least one embodiment, an accelerator integration circuit supports different programming models including a dedicated-process programming model (no graphics acceleration module virtualization) and shared programming models (with virtualization), which may include programming models which are controlled by accelerator integration circuit 1136 and programming models which are controlled by graphics acceleration module 1146.

In at least one embodiment, graphics processing engines 1131(1)-1131(N) are dedicated to a single application or process under a single operating system. In at least one embodiment, a single application can funnel other application requests to graphics processing engines 1131(1)-1131(N), providing virtualization within a VM/partition.

In at least one embodiment, graphics processing engines 1131(1)-1131(N), may be shared by multiple VM/application partitions. In at least one embodiment, shared models may use a system hypervisor to virtualize graphics processing engines 1131(1)-1131(N) to allow access by each operating system. In at least one embodiment, for single-partition systems without a hypervisor, graphics processing engines 1131(1)-1131(N) are owned by an operating system. In at least one embodiment, an operating system can virtualize graphics processing engines 1131(1)-1131(N) to provide access to each process or application.

In at least one embodiment, graphics acceleration module 1146 or an individual graphics processing engine 1131(1)-1131(N) selects a process element using a process handle. In at least one embodiment, process elements are stored in system memory 1114 and are addressable using an effective address to real address translation technique described herein. In at least one embodiment, a process handle may be an implementation-specific value provided to a host process when registering its context with graphics processing engine 1131(1)-1131(N) (that is, calling system software to add a process element to a process element linked list). In at least one embodiment, a lower 16-bits of a process handle may be an offset of a process element within a process element linked list.

FIG. 11D illustrates an exemplary accelerator integration slice 1190. In at least one embodiment, a “slice” comprises a specified portion of processing resources of accelerator integration circuit 1136. In at least one embodiment, an application is effective address space 1182 within system memory 1114 stores process elements 1183. In at least one embodiment, process elements 1183 are stored in response to GPU invocations 1181 from applications 1180 executed on processor 1107. In at least one embodiment, a process element 1183 contains process state for corresponding application 1180. In at least one embodiment, a work descriptor (WD) 1184 contained in process element 1183 can be a single job requested by an application or may contain a pointer to a queue of jobs. In at least one embodiment, WD 1184 is a pointer to a job request queue in an application's effective address space 1182.

In at least one embodiment, graphics acceleration module 1146 and/or individual graphics processing engines 1131(1)-1131(N) can be shared by all or a subset of processes in a system. In at least one embodiment, an infrastructure for setting up process states and sending a WD 1184 to a graphics acceleration module 1146 to start a job in a virtualized environment may be included.

In at least one embodiment, a dedicated-process programming model is implementation-specific. In at least one embodiment, in this model, a single process owns graphics acceleration module 1146 or an individual graphics processing engine 1131. In at least one embodiment, when graphics acceleration module 1146 is owned by a single process, a hypervisor initializes accelerator integration circuit 1136 for an owning partition and an operating system initializes accelerator integration circuit 1136 for an owning process when graphics acceleration module 1146 is assigned.

In at least one embodiment, in operation, a WD fetch unit 1191 in accelerator integration slice 1190 fetches next WD 1184, which includes an indication of work to be done by one or more graphics processing engines of graphics acceleration module 1146. In at least one embodiment, data from WD 1184 may be stored in registers 1145 and used by MMU 1139, interrupt management circuit 1147 and/or context management circuit 1148 as illustrated. For example, one embodiment of MMU 1139 includes segment/page walk circuitry for accessing segment/page tables 1186 within an OS virtual address space 1185. In at least one embodiment, interrupt management circuit 1147 may process interrupt events 1192 received from graphics acceleration module 1146. In at least one embodiment, when performing graphics operations, an effective address 1193 generated by a graphics processing engine 1131(1)-1131(N) is translated to a real address by MMU 1139.

In at least one embodiment, registers 1145 are duplicated for each graphics processing engine 1131(1)-1131(N) and/or graphics acceleration module 1146 and may be initialized by a hypervisor or an operating system. In at least one embodiment, each of these duplicated registers may be included in an accelerator integration slice 1190. Exemplary registers that may be initialized by a hypervisor are shown in Table 1.

TABLE 1
Hypervisor Initialized Registers

| Register | |
|---|---|
| # | Description |
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record |
| | Pointer |
| 9 | Storage Description Register |

Exemplary registers that may be initialized by an operating system are shown in Table 2.

TABLE 2
Operating System Initialized Registers

| Register # | Description |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In at least one embodiment, each WD 1184 is specific to a particular graphics acceleration module 1146 and/or graphics processing engines 1131(1)-1131(N). In at least one embodiment, it contains all information required by a graphics processing engine 1131(1)-1131(N) to do work, or it can be a pointer to a memory location where an application has set up a command queue of work to be completed.

FIG. 11E illustrates additional details for one exemplary embodiment of a shared model. This embodiment includes a hypervisor real address space 1198 in which a process element list 1199 is stored. In at least one embodiment, hypervisor real address space 1198 is accessible via a hypervisor 1196 which virtualizes graphics acceleration module engines for operating system 1195.

In at least one embodiment, shared programming models allow for all or a subset of processes from all or a subset of partitions in a system to use a graphics acceleration module 1146. In at least one embodiment, there are two programming models where graphics acceleration module 1146 is shared by multiple processes and partitions, namely time-sliced shared and graphics directed shared.

In at least one embodiment, in this model, system hypervisor 1196 owns graphics acceleration module 1146 and makes its function available to all operating systems 1195. In at least one embodiment, for a graphics acceleration module 1146 to support virtualization by system hypervisor 1196, graphics acceleration module 1146 may adhere to certain requirements, such as (1) an application's job request must be autonomous (that is, state does not need to be maintained between jobs), or graphics acceleration module 1146 must provide a context save and restore mechanism, (2) an application's job request is guaranteed by graphics acceleration module 1146 to complete in a specified amount of time, including any translation faults, or graphics acceleration module 1146 provides an ability to preempt processing of a job, and (3) graphics acceleration module 1146 must be guaranteed fairness between processes when operating in a directed shared programming model.

In at least one embodiment, application 1180 is required to make an operating system 1195 system call with a graphics acceleration module type, a work descriptor (WD), an authority mask register (AMR) value, and a context save/restore area pointer (CSRP). In at least one embodiment, graphics acceleration module type describes a targeted acceleration function for a system call. In at least one embodiment, graphics acceleration module type may be a system-specific value. In at least one embodiment, WD is formatted specifically for graphics acceleration module 1146 and can be in a form of a graphics acceleration module 1146 command, an effective address pointer to a user-defined structure, an effective address pointer to a queue of commands, or any other data structure to describe work to be done by graphics acceleration module 1146.

In at least one embodiment, an AMR value is an AMR state to use for a current process. In at least one embodiment, a value passed to an operating system is similar to an application setting an AMR. In at least one embodiment, if accelerator integration circuit 1136 (not shown) and graphics acceleration module 1146 implementations do not support a User Authority Mask Override Register (UAMOR), an operating system may apply a current UAMOR value to an AMR value before passing an AMR in a hypervisor call. In at least one embodiment, hypervisor 1196 may optionally apply a current Authority Mask Override Register (AMOR) value before placing an AMR into process element 1183. In at least one embodiment, CSRP is one of registers 1145 containing an effective address of an area in an application's effective address space 1182 for graphics acceleration module 1146 to save and restore context state. In at least one embodiment, this pointer is optional if no state is required to be saved between jobs or when a job is preempted. In at least one embodiment, context save/restore area may be pinned system memory.

Upon receiving a system call, operating system 1195 may verify that application 1180 has registered and been given authority to use graphics acceleration module 1146. In at least one embodiment, operating system 1195 then calls hypervisor 1196 with information shown in Table 3.

TABLE 3
OS to Hypervisor Call Parameters

| Parameter | |
|---|---|
| # | Description |
| 1 | A work descriptor (WD) |
| 2 | An Authority Mask Register (AMR) value (potentially |
| | masked) |
| 3 | An effective address (EA) Context Save/Restore Area Pointer |
| | (CSRP) |
| 4 | A process ID (PID) and optional thread ID (TID) |
| 5 | A virtual address (VA) accelerator utilization record pointer |
| | (AURP) |
| 6 | Virtual address of storage segment table pointer (SSTP) |
| 7 | A logical interrupt service number (LISN) |

In at least one embodiment, upon receiving a hypervisor call, hypervisor 1196 verifies that operating system 1195 has registered and been given authority to use graphics acceleration module 1146. In at least one embodiment, hypervisor 1196 then puts process element 1183 into a process element linked list for a corresponding graphics acceleration module 1146 type. In at least one embodiment, a process element may include information shown in Table 4.

TABLE 4
Process Element Information

| Element | |
|---|---|
| # | Description |
| 1 | A work descriptor (WD) |
| 2 | An Authority Mask Register (AMR) value (potentially masked). |
| 3 | An effective address (EA) Context Save/Restore Area Pointer |
| | (CSRP) |
| 4 | A process ID (PID) and optional thread ID (TID) |
| 5 | A virtual address (VA) accelerator utilization record pointer |
| | (AURP) |
| 6 | Virtual address of storage segment table pointer (SSTP) |
| 7 | A logical interrupt service number (LISN) |
| 8 | Interrupt vector table, derived from hypervisor call parameters |
| 9 | A state register (SR) value |
| 10 | A logical partition ID (LPID) |
| 11 | A real address (RA) hypervisor accelerator utilization record |
| | pointer |
| 12 | Storage Descriptor Register (SDR) |

In at least one embodiment, hypervisor initializes a plurality of accelerator integration slice 1190 registers 1145.

As illustrated in FIG. 11F, in at least one embodiment, a unified memory is used, addressable via a common virtual memory address space used to access physical processor memories 1101(1)-1101(N) and GPU memories 1120(1)-1120(N). In this implementation, operations executed on GPUs 1110(1)-1110(N) utilize a same virtual/effective memory address space to access processor memories 1101(1)-1101(M) and vice versa, thereby simplifying programmability. In at least one embodiment, a first portion of a virtual/effective address space is allocated to processor memory 1101(1), a second portion to second processor memory 1101(N), a third portion to GPU memory 1120(1), and so on. In at least one embodiment, an entire virtual/effective memory space (sometimes referred to as an effective address space) is thereby distributed across each of processor memories 1101 and GPU memories 1120, allowing any processor or GPU to access any physical memory with a virtual address mapped to that memory.

In at least one embodiment, bias/coherence management circuitry 1194A-1194E within one or more of MMUs 1139A-1139E ensures cache coherence between caches of one or more host processors (e.g., 1105) and GPUs 1110 and implements biasing techniques indicating physical memories in which certain types of data should be stored. In at least one embodiment, while multiple instances of bias/coherence management circuitry 1194A-1194E are illustrated in FIG. 11F, bias/coherence circuitry may be implemented within an MMU of one or more host processors 1105 and/or within accelerator integration circuit 1136.

One embodiment allows GPU memories 1120 to be mapped as part of system memory, and accessed using shared virtual memory (SVM) technology, but without suffering performance drawbacks associated with full system cache coherence. In at least one embodiment, an ability for GPU memories 1120 to be accessed as system memory without onerous cache coherence overhead provides a beneficial operating environment for GPU offload. In at least one embodiment, this arrangement allows software of host processor 1105 to setup operands and access computation results, without overhead of tradition I/O DMA data copies. In at least one embodiment, such traditional copies involve driver calls, interrupts and memory mapped I/O (MMIO) accesses that are all inefficient relative to simple memory accesses. In at least one embodiment, an ability to access GPU memories 1120 without cache coherence overheads can be critical to execution time of an offloaded computation. In at least one embodiment, in cases with substantial streaming write memory traffic, for example, cache coherence overhead can significantly reduce an effective write bandwidth seen by a GPU 1110. In at least one embodiment, efficiency of operand setup, efficiency of results access, and efficiency of GPU computation may play a role in determining effectiveness of a GPU offload.

In at least one embodiment, selection of GPU bias and host processor bias is driven by a bias tracker data structure. In at least one embodiment, a bias table may be used, for example, which may be a page-granular structure (e.g., controlled at a granularity of a memory page) that includes 1 or 2 bits per GPU-attached memory page. In at least one embodiment, a bias table may be implemented in a stolen memory range of one or more GPU memories 1120, with or without a bias cache in a GPU 1110 (e.g., to cache frequently/recently used entries of a bias table). Alternatively, in at least one embodiment, an entire bias table may be maintained within a GPU.

In at least one embodiment, a bias table entry associated with each access to a GPU attached memory 1120 is accessed prior to actual access to a GPU memory, causing following operations. In at least one embodiment, local requests from a GPU 1110 that find their page in GPU bias are forwarded directly to a corresponding GPU memory 1120. In at least one embodiment, local requests from a GPU that find their page in host bias are forwarded to processor 1105 (e.g., over a high-speed link as described herein). In at least one embodiment, requests from processor 1105 that find a requested page in host processor bias complete a request like a normal memory read. Alternatively, requests directed to a GPU-biased page may be forwarded to a GPU 1110. In at least one embodiment, a GPU may then transition a page to a host processor bias if it is not currently using a page. In at least one embodiment, a bias state of a page can be changed either by a software-based mechanism, a hardware-assisted software-based mechanism, or, for a limited set of cases, a purely hardware-based mechanism.

In at least one embodiment, one mechanism for changing bias state employs an API call (e.g., OpenCL), which, in turn, calls a GPU's device driver which, in turn, sends a message (or enqueues a command descriptor) to a GPU directing it to change a bias state and, for some transitions, perform a cache flushing operation in a host. In at least one embodiment, a cache flushing operation is used for a transition from host processor 1105 bias to GPU bias, but is not for an opposite transition.

In at least one embodiment, cache coherency is maintained by temporarily rendering GPU-biased pages uncacheable by host processor 1105. In at least one embodiment, to access these pages, processor 1105 may request access from GPU 1110, which may or may not grant access right away. In at least one embodiment, thus, to reduce communication between processor 1105 and GPU 1110 it is beneficial to ensure that GPU-biased pages are those which are required by a GPU but not host processor 1105 and vice versa.

Hardware structure(s) 615 are used to perform one or more embodiments. Details regarding a hardware structure(s) 615 may be provided herein in conjunction with FIGS. 6A and/or 6B.

FIGS. 12A-12B illustrate additional exemplary graphics processor logic according to embodiments described herein. In at least one embodiment, components illustrated in and described in connection with FIGS. 12A-12B are integrated into a single system, such as a graphics processing unit (GPU), SoC, or another type of processor. FIG. 12A illustrates a graphics core 1200 that may be included within a graphics processor, in at least one embodiment. FIG. 12B illustrates a highly-parallel general-purpose graphics processing unit (“GPGPU”, which can also be referred to as a “graphics processing unit”) 1230 suitable for deployment on a multi-chip module in at least one embodiment. In at least one embodiment, graphics processing unit 1230 is a GPGPU that comprises a graphics processor.

In at least one embodiment, graphics core 1200 includes a shared instruction cache 1202, a texture unit 1218, and a cache/shared memory 1220 (e.g., including L1, L2, L3, last level cache, or other caches) that are common to execution resources within graphics core 1200. In at least one embodiment, graphics core 1200 can include multiple slices 1201A-1201N or a partition for each core, and a graphics processor can include multiple instances of graphics core 1200. In at least one embodiment, each slice 1201A-1201N refers to graphics core 1200. In at least one embodiment, slices 1201A-1201N have sub-slices, which are part of a slice 1201A-1201N. In at least one embodiment, slices 1201A-1201N are independent of other slices or dependent on other slices. In at least one embodiment, slices 1201A-1201N can include support logic including a local instruction cache 1204A-1204N, a thread scheduler (sequencer) 1206A-1206N, a thread dispatcher 1208A-1208N, and a set of registers 1210A-1210N. In at least one embodiment, slices 1201A-1201N can include a set of additional function units (AFUs 1212A-1212N), floating-point units (FPUs 1214A-1214N), integer arithmetic logic units (ALUs 1216A-1216N), address computational units (ACUs 1213A-1213N), double-precision floating-point units (DPFPUs 1215A-1215N), and matrix processing units (MPUs 1217A-1217N). In at least one embodiment, MPUs 1217A-1217N are referred to as matrix engines.

In at least one embodiment, each slice 1201A-1201N includes one or more engines for floating point and integer vector operations and one or more engines to accelerate convolution and matrix operations in AI, machine learning, or large dataset workloads. In at least one embodiment, one or more slices 1201A-1201N include one or more vector engines to compute a vector (e.g., compute mathematical operations for vectors). In at least one embodiment, a vector engine can compute a vector operation in 16-bit floating point (also referred to as “FP16”), 32-bit floating point (also referred to as “FP32”), or 64-bit floating point (also referred to as “FP64”). In at least one embodiment, one or more slices 1201A-1201N includes 16 vector engines that are paired with 16 matrix math units to compute matrix/tensor operations, where vector engines and math units are exposed via matrix extensions. In at least one embodiment, a slice a specified portion of processing resources of a processing unit, e.g., 16 cores and a ray tracing unit or 8 cores, a thread scheduler, a thread dispatcher, and additional functional units for a processor. In at least one embodiment, graphics core 1200 includes one or more matrix engines to compute matrix operations, e.g., when computing tensor operations.

In at least one embodiment, one or more slices 1201A-1201N includes one or more ray tracing units to compute ray tracing operations (e.g., 16 ray tracing units per slice slices 1201A-1201N). In at least one embodiment, a ray tracing unit computes ray traversal, triangle intersection, bounding box intersect, or other ray tracing operations.

In at least one embodiment, one or more slices 1201A-1201N includes a media slice that encodes, decodes, and/or transcodes data; scales and/or format converts data; and/or performs video quality operations on video data.

In at least one embodiment, one or more slices 1201A-1201N are linked to L2 cache and memory fabric, link connectors, high-bandwidth memory (HBM) (e.g., HBM2e, HDM3) stacks, and a media engine. In at least one embodiment, one or more slices 1201A-1201N include multiple cores (e.g., 16 cores) and multiple ray tracing units (e.g., 16) paired to each core. In at least one embodiment, one or more slices 1201A-1201N has one or more Li caches. In at least one embodiment, one or more slices 1201A-1201N include one or more vector engines; one or more instruction caches to store instructions; one or more L1 caches to cache data; one or more shared local memories (SLMs) to store data, e.g., corresponding to instructions; one or more samplers to sample data; one or more ray tracing units to perform ray tracing operations; one or more geometries to perform operations in geometry pipelines and/or apply geometric transformations to vertices or polygons; one or more rasterizers to describe an image in vector graphics format (e.g., shape) and convert it into a raster image (e.g., a series of pixels, dots, or lines, which when displayed together, create an image that is represented by shapes); one or more a Hierarchical Depth Buffer (Hiz) to buffer data; and/or one or more pixel backends. In at least one embodiment, a slice 1201A-1201N includes a memory fabric, e.g., an L2 cache.

In at least one embodiment, FPUs 1214A-1214N can perform single-precision (32-bit) and half-precision (16-bit) floating point operations, while DPFPUs 1215A-1215N perform double precision (64-bit) floating point operations. In at least one embodiment, ALUs 1216A-1216N can perform variable precision integer operations at 8-bit, 16-bit, and 32-bit precision, and can be configured for mixed precision operations. In at least one embodiment, MPUs 1217A-1217N can also be configured for mixed precision matrix operations, including half-precision floating point and 8-bit integer operations. In at least one embodiment, MPUs 1217-1217N can perform a variety of matrix operations to accelerate machine learning application frameworks, including enabling support for accelerated general matrix to matrix multiplication (GEMM). In at least one embodiment, AFUs 1212A-1212N can perform additional logic operations not supported by floating-point or integer units, including trigonometric operations (e.g., sine, cosine, etc.).

Logic 615 are used to perform inferencing and/or training operations associated with one or more embodiments. Details regarding logic 615 are provided herein in conjunction with FIGS. 6A and/or 6B. In at least one embodiment, logic 615 may be used in graphics core 1200 for inferencing or predicting operations based, at least in part, on weight parameters calculated using neural network training operations, neural network functions and/or architectures, or neural network use cases described herein.

In at least one embodiment, graphics core 1200 includes an interconnect and a link fabric sublayer that is attached to a switch and a GPU-GPU bridge that enables multiple graphics processors 1200 (e.g., 8) to be interlinked without glue to each other with load/store units (LSUs), data transfer units, and sync semantics across multiple graphics processors 1200. In at least one embodiment, interconnects include standardized interconnects (e.g., PCIe) or some combination thereof.

In at least one embodiment, graphics core 1200 includes multiple tiles. In at least one embodiment, a tile is an individual die or one or more dies, where individual dies can be connected with an interconnect (e.g., embedded multi-die interconnect bridge (EMIB)). In at least one embodiment, graphics core 1200 includes a compute tile, a memory tile (e.g., where a memory tile can be exclusively accessed by different tiles or different chipsets such as a Rambo tile), substrate tile, a base tile, a HMB tile, a link tile, and EMIB tile, where all tiles are packaged together in graphics core 1200 as part of a GPU. In at least one embodiment, graphics core 1200 can include multiple tiles in a single package (also referred to as a “multi tile package”). In at least one embodiment, a compute tile can have 8 graphics cores 1200, an L1 cache; and a base tile can have a host interface with PCIe 5.0, HBM2e, MDFI, and EMIB, a link tile with 8 liks, 8 ports with an embedded switch. In at least one embodiment, tiles are connected with face-to-face (F2F) chip-on-chip bonding through fine-pitched, 36-micron, microbumps (e.g., copper pillars). In at least one embodiment, graphics core 1200 includes memory fabric, which includes memory, and is tile that is accessible by multiple tiles. In at least one embodiment, graphics core 1200 stores, accesses, or loads its own hardware contexts in memory, where a hardware context is a set of data loaded from registers before a process resumes, and where a hardware context can indicate a state of hardware (e.g., state of a GPU).

In at least one embodiment, graphics core 1200 includes serializer/deserializer (SERDES) circuitry that converts a serial data stream to a parallel data stream, or converts a parallel data stream to a serial data stream.

In at least one embodiment, graphics core 1200 includes a high speed coherent unified fabric (GPU to GPU), load/store units, bulk data transfer and sync semantics, and connected GPUs through an embedded switch, where a GPU-GPU bridge is controlled by a controller.

In at least one embodiment, graphics core 1200 performs an API, where said API abstracts hardware of graphics core 1200 and access libraries with instructions to perform math operations (e.g., math kernel library), deep neural network operations (e.g., deep neural network library), vector operations, collective communications, thread building blocks, video processing, data analytics library, and/or ray tracing operations.

FIG. 12B illustrates GPGPU 1230 that can be configured to enable highly-parallel compute operations to be performed by an array of graphics processing units, in at least one embodiment. In at least one embodiment, GPGPU 1230 can be linked directly to other instances of GPGPU 1230 to create a multi-GPU cluster to improve training speed for deep neural networks. In at least one embodiment, GPGPU 1230 includes a host interface 1232 to enable a connection with a host processor. In at least one embodiment, host interface 1232 is a PCI Express interface. In at least one embodiment, host interface 1232 can be a vendor-specific communications interface or communications fabric. In at least one embodiment, GPGPU 1230 receives commands from a host processor and uses a global scheduler 1234 (which may be referred to as a thread sequencer and/or asynchronous compute engine) to distribute execution threads associated with those commands to a set of compute clusters 1236A-1236H. In at least one embodiment, compute clusters 1236A-1236H share a cache memory 1238. In at least one embodiment, cache memory 1238 can serve as a higher-level cache for cache memories within compute clusters 1236A-1236H. In at least one embodiment, compute clusters 1236A-1236H comprise a slice or are referred to as “slices.”

In at least one embodiment, GPGPU 1230 includes memory 1244A-1244B coupled with compute clusters 1236A-1236H via a set of memory controllers 1242A-1242B (e.g., one or more controllers for HBM2e). In at least one embodiment, memory 1244A-1244B can include various types of memory devices including dynamic random access memory (DRAM) or graphics random access memory, such as synchronous graphics random access memory (SGRAM), including graphics double data rate (GDDR) memory.

In at least one embodiment, compute clusters 1236A-1236H each include a set of graphics cores, such as graphics core 1200 of FIG. 12A, which can include multiple types of integer and floating point logic units that can perform computational operations at a range of precisions including suited for machine learning computations. For example, in at least one embodiment, at least a subset of floating point units in each of compute clusters 1236A-1236H can be configured to perform 16-bit or 32-bit floating point operations, while a different subset of floating point units can be configured to perform 64-bit floating point operations.

In at least one embodiment, multiple instances of GPGPU 1230 can be configured to operate as a compute cluster. In at least one embodiment, communication used by compute clusters 1236A-1236H for synchronization and data exchange varies across embodiments. In at least one embodiment, multiple instances of GPGPU 1230 communicate over host interface 1232. In at least one embodiment, GPGPU 1230 includes an I/O hub 1239 that couples GPGPU 1230 with a GPU link 1240 that enables a direct connection to other instances of GPGPU 1230. In at least one embodiment, GPU link 1240 is coupled to a dedicated GPU-to-GPU bridge that enables communication and synchronization between multiple instances of GPGPU 1230. In at least one embodiment, GPU link 1240 couples with a high-speed interconnect to transmit and receive data to other GPGPUs or parallel processors. In at least one embodiment, multiple instances of GPGPU 1230 are located in separate data processing systems and communicate via a network device that is accessible via host interface 1232. In at least one embodiment GPU link 1240 can be configured to enable a connection to a host processor in addition to or as an alternative to host interface 1232.

In at least one embodiment, GPGPU 1230 can be configured to train neural networks. In at least one embodiment, GPGPU 1230 can be used within an inferencing platform. In at least one embodiment, in which GPGPU 1230 is used for inferencing, GPGPU 1230 may include fewer compute clusters 1236A-1236H relative to when GPGPU 1230 is used for training a neural network. In at least one embodiment, memory technology associated with memory 1244A-1244B may differ between inferencing and training configurations, with higher bandwidth memory technologies devoted to training configurations. In at least one embodiment, an inferencing configuration of GPGPU 1230 can support inferencing specific instructions. For example, in at least one embodiment, an inferencing configuration can provide support for one or more 8-bit integer dot product instructions, which may be used during inferencing operations for deployed neural networks.

Logic 615 are used to perform inferencing and/or training operations associated with one or more embodiments. Details regarding logic 615 are provided herein in conjunction with FIGS. 6A and/or 6B. In at least one embodiment, logic 615 may be used in GPGPU 1230 for inferencing or predicting operations based, at least in part, on weight parameters calculated using neural network training operations, neural network functions and/or architectures, or neural network use cases described herein.

### Processors

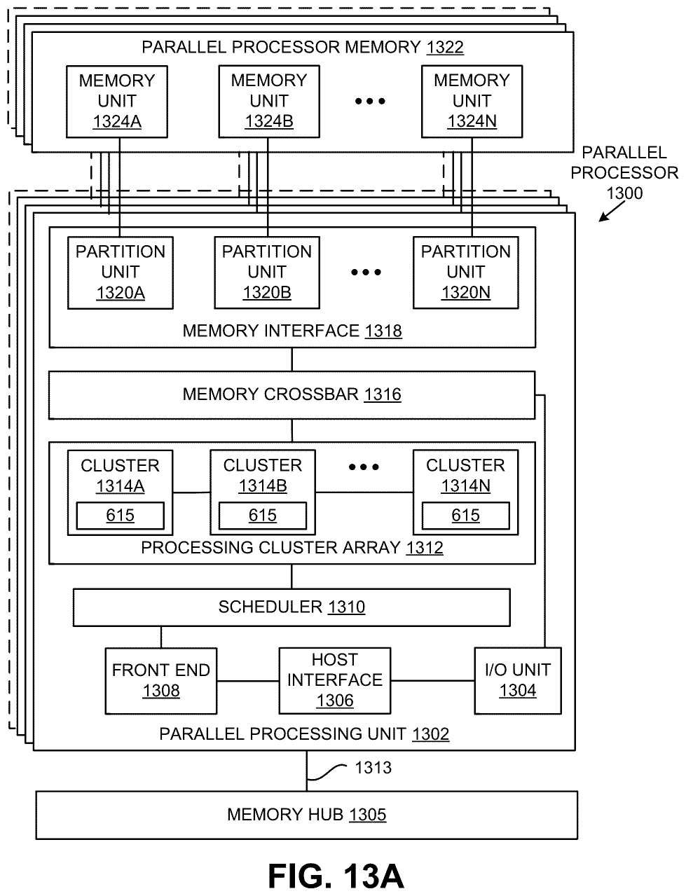

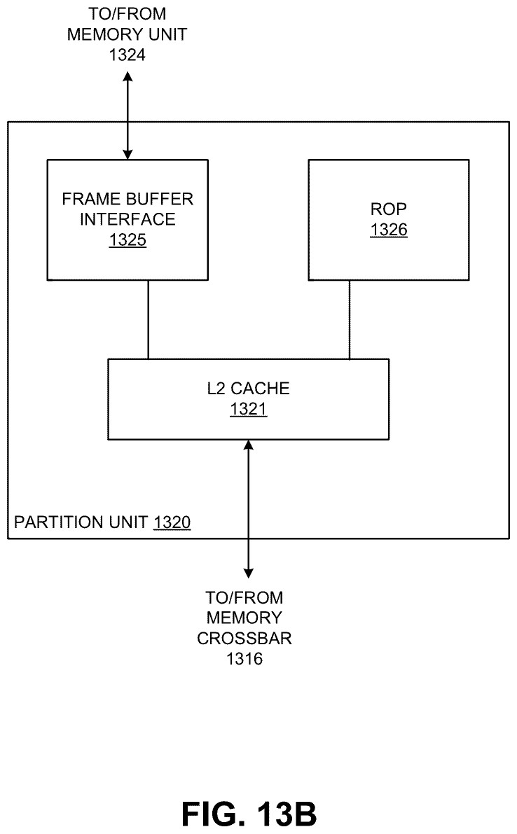

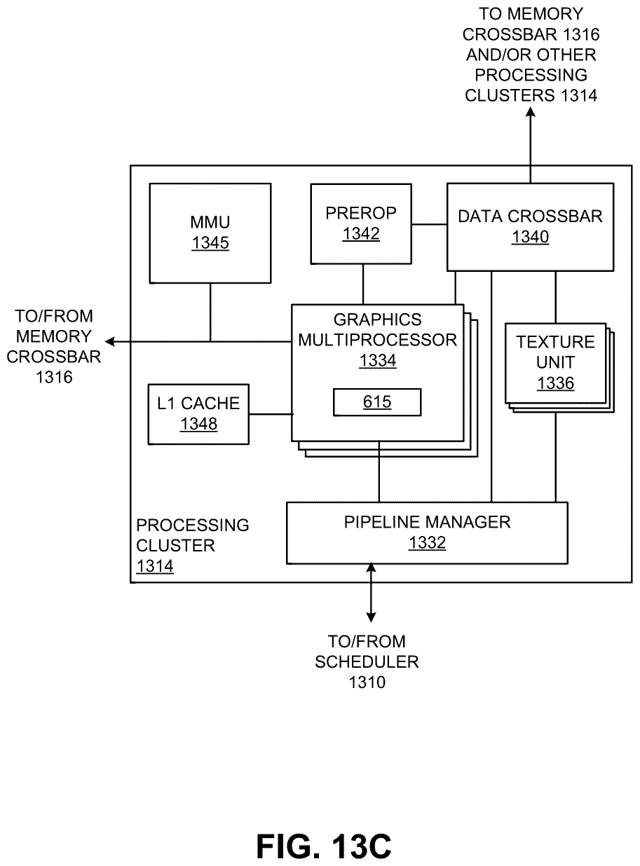

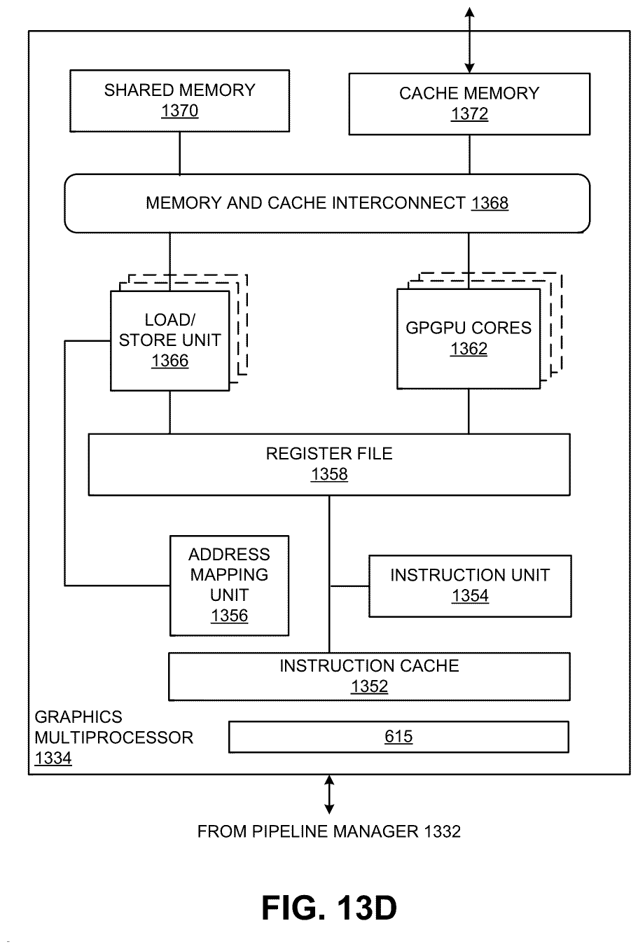

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1316, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as, but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2e, or HDM3. In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13A (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, routed for further processing by one or more processor(s), or routed for further processing by one of processing entities within parallel processor 1300 of FIG. 13A.

FIG. 13C is a block diagram of a processing cluster 1314 within a parallel processing unit according to at least one embodiment. In at least one embodiment, a processing cluster is an instance of one of processing clusters 1314A-1314N of FIG. 13A. In at least one embodiment, processing cluster 1314 can be configured to execute many threads in parallel, where “thread” refers to an instance of a particular program executing on a particular set of input data. In at least one embodiment, single-instruction, multiple-data (SIMD) instruction issue techniques are used to support parallel execution of a large number of threads without providing multiple independent instruction units. In at least one embodiment, single-instruction, multiple-thread (SIMT) techniques are used to support parallel execution of a large number of generally synchronized threads, using a common instruction unit configured to issue instructions to a set of processing engines within each one of processing clusters.

In at least one embodiment, operation of processing cluster 1314 can be controlled via a pipeline manager 1332 that distributes processing tasks to SIMT parallel processors. In at least one embodiment, pipeline manager 1332 receives instructions from scheduler 1310 of FIG. 13A and manages execution of those instructions via a graphics multiprocessor 1334 and/or a texture unit 1336. In at least one embodiment, graphics multiprocessor 1334 is an exemplary instance of a SIMT parallel processor. However, in at least one embodiment, various types of SIMT parallel processors of differing architectures may be included within processing cluster 1314. In at least one embodiment, one or more instances of graphics multiprocessor 1334 can be included within a processing cluster 1314. In at least one embodiment, graphics multiprocessor 1334 can process data and a data crossbar 1340 can be used to distribute processed data to one of multiple possible destinations, including other shader units. In at least one embodiment, pipeline manager 1332 can facilitate distribution of processed data by specifying destinations for processed data to be distributed via data crossbar 1340.

In at least one embodiment, each graphics multiprocessor 1334 within processing cluster 1314 can include an identical set of functional execution logic (e.g., arithmetic logic units, load-store units, etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 1314 constitute a thread. In at least one embodiment, a set of threads executing across a set of parallel processing engines is a thread group. In at least one embodiment, a thread group executes a common program on different input data. In at least one embodiment, each thread within a thread group can be assigned to a different processing engine within a graphics multiprocessor 1334. In at least one embodiment, a thread group may include fewer threads than a number of processing engines within graphics multiprocessor 1334. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 1334. In at least one embodiment, when a thread group includes more threads than number of processing engines within graphics multiprocessor 1334, processing can be performed over consecutive clock cycles. In at least one embodiment, multiple thread groups can be executed concurrently on a graphics multiprocessor 1334.

In at least one embodiment, graphics multiprocessor 1334 includes an internal cache memory to perform load and store operations. In at least one embodiment, graphics multiprocessor 1334 can forego an internal cache and use a cache memory (e.g., L1 cache 1348) within processing cluster 1314. In at least one embodiment, each graphics multiprocessor 1334 also has access to L2 caches within partition units (e.g., partition units 1320A-1320N of FIG. 13A) that are shared among all processing clusters 1314 and may be used to transfer data between threads. In at least one embodiment, graphics multiprocessor 1334 may also access off-chip global memory, which can include one or more of local parallel processor memory and/or system memory. In at least one embodiment, any memory external to parallel processing unit 1302 may be used as global memory. In at least one embodiment, processing cluster 1314 includes multiple instances of graphics multiprocessor 1334 and can share common instructions and data, which may be stored in L1 cache 1348.

In at least one embodiment, each processing cluster 1314 may include an MMU 1345 (memory management unit) that is configured to map virtual addresses into physical addresses. In at least one embodiment, one or more instances of MMU 1345 may reside within memory interface 1318 of FIG. 13A. In at least one embodiment, MMU 1345 includes a set of page table entries (PTEs) used to map a virtual address to a physical address of a tile and optionally a cache line index. In at least one embodiment, MMU 1345 may include address translation lookaside buffers (TLB) or caches that may reside within graphics multiprocessor 1334 or L1 1348 cache or processing cluster 1314. In at least one embodiment, a physical address is processed to distribute surface data access locally to allow for efficient request interleaving among partition units. In at least one embodiment, a cache line index may be used to determine whether a request for a cache line is a hit or miss.

In at least one embodiment, a processing cluster 1314 may be configured such that each graphics multiprocessor 1334 is coupled to a texture unit 1336 for performing texture mapping operations, e.g., determining texture sample positions, reading texture data, and filtering texture data. In at least one embodiment, texture data is read from an internal texture L1 cache (not shown) or from an L1 cache within graphics multiprocessor 1334 and is fetched from an L2 cache, local parallel processor memory, or system memory, as needed. In at least one embodiment, each graphics multiprocessor 1334 outputs processed tasks to data crossbar 1340 to provide processed task to another processing cluster 1314 for further processing or to store processed task in an L2 cache, local parallel processor memory, or system memory via memory crossbar 1316. In at least one embodiment, a preROP 1342 (pre-raster operations unit) is configured to receive data from graphics multiprocessor 1334, and direct data to ROP units, which may be located with partition units as described herein (e.g., partition units 1320A-1320N of FIG. 13A). In at least one embodiment, preROP 1342 unit can perform optimizations for color blending, organizing pixel color data, and performing address translations.

Logic 615 are used to perform inferencing and/or training operations associated with one or more embodiments. Details regarding logic 615 are provided herein in conjunction with FIGS. 6A and/or 6B. In at least one embodiment, logic 615 may be used in graphics processing cluster 1314 for inferencing or predicting operations based, at least in part, on weight parameters calculated using neural network training operations, neural network functions and/or architectures, or neural network use cases described herein.

FIG. 13D shows a graphics multiprocessor 1334 according to at least one embodiment. In at least one embodiment, graphics multiprocessor 1334 couples with pipeline manager 1332 of processing cluster 1314. In at least one embodiment, graphics multiprocessor 1334 has an execution pipeline including but not limited to an instruction cache 1352, an instruction unit 1354, an address mapping unit 1356, a register file 1358, one or more general purpose graphics processing unit (GPGPU) cores 1362, and one or more load/store units 1366, where one or more load/store units 1366 can perform load/store operations to load/store instructions corresponding to performing an operation. In at least one embodiment, GPGPU cores 1362 and load/store units 1366 are coupled with cache memory 1372 and shared memory 1370 via a memory and cache interconnect 1368.

In at least one embodiment, instruction cache 1352 receives a stream of instructions to execute from pipeline manager 1332. In at least one embodiment, instructions are cached in instruction cache 1352 and dispatched for execution by an instruction unit 1354. In at least one embodiment, instruction unit 1354 can dispatch instructions as thread groups (e.g., warps, wavefronts, waves), with each thread of thread group assigned to a different execution unit within GPGPU cores 1362. In at least one embodiment, an instruction can access any of a local, shared, or global address space by specifying an address within a unified address space. In at least one embodiment, address mapping unit 1356 can be used to translate addresses in a unified address space into a distinct memory address that can be accessed by load/store units 1366.

In at least one embodiment, register file 1358 provides a set of registers for functional units of graphics multiprocessor 1334. In at least one embodiment, register file 1358 provides temporary storage for operands connected to data paths of functional units (e.g., GPGPU cores 1362, load/store units 1366) of graphics multiprocessor 1334. In at least one embodiment, register file 1358 is divided between each of functional units such that each functional unit is allocated a dedicated portion of register file 1358. In at least one embodiment, register file 1358 is divided between different warps (which may be referred to as wavefronts and/or waves) being executed by graphics multiprocessor 1334.

In at least one embodiment, GPGPU cores 1362 can each include floating point units (FPUs) and/or integer arithmetic logic units (ALUs) that are used to execute instructions of graphics multiprocessor 1334. In at least one embodiment, GPGPU cores 1362 can be similar in architecture or can differ in architecture. In at least one embodiment, a first portion of GPGPU cores 1362 include a single precision FPU and an integer ALU while a second portion of GPGPU cores include a double precision FPU. In at least one embodiment, FPUs can implement IEEE 754-2008 standard floating point arithmetic or enable variable precision floating point arithmetic. In at least one embodiment, graphics multiprocessor 1334 can additionally include one or more fixed function or special function units to perform specific functions such as copy rectangle or pixel blending operations. In at least one embodiment, one or more of GPGPU cores 1362 can also include fixed or special function logic.

In at least one embodiment, GPGPU cores 1362 include SIMD logic capable of performing a single instruction on multiple sets of data. In at least one embodiment, GPGPU cores 1362 can physically execute SIMD4, SIMD8, and SIMD16 instructions and logically execute SIMD1, SIMD2, and SIMD32 instructions. In at least one embodiment, SIMD instructions for GPGPU cores can be generated at compile time by a shader compiler or automatically generated when executing programs written and compiled for single program multiple data (SPMD) or SIMT architectures. In at least one embodiment, multiple threads of a program configured for an SIMT execution model can executed via a single SIMD instruction. For example, in at least one embodiment, eight SIMT threads that perform same or similar operations can be executed in parallel via a single SIMD8 logic unit.

In at least one embodiment, memory and cache interconnect 1368 is an interconnect network that connects each functional unit of graphics multiprocessor 1334 to register file 1358 and to shared memory 1370. In at least one embodiment, memory and cache interconnect 1368 is a crossbar interconnect that allows load/store unit 1366 to implement load and store operations between shared memory 1370 and register file 1358. In at least one embodiment, register file 1358 can operate at a same frequency as GPGPU cores 1362, thus data transfer between GPGPU cores 1362 and register file 1358 can have very low latency. In at least one embodiment, shared memory 1370 can be used to enable communication between threads that execute on functional units within graphics multiprocessor 1334. In at least one embodiment, cache memory 1372 can be used as a data cache for example, to cache texture data communicated between functional units and texture unit 1336. In at least one embodiment, shared memory 1370 can also be used as a program managed cache. In at least one embodiment, threads executing on GPGPU cores 1362 can programmatically store data within shared memory in addition to automatically cached data that is stored within cache memory 1372.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink). In at least one embodiment, an SoC comprises a parallel processor or GPGPU as described herein, where said parallel processor or said GPGPU is performed on said SoC. In at least one embodiment, a GPU may be integrated on a package or chip as cores and communicatively coupled to cores over an internal processor bus/interconnect internal to a package or chip. In at least one embodiment, regardless a manner in which a GPU is connected, processor cores may allocate work to such GPU in a form of sequences of commands/instructions contained in a work descriptor. In at least one embodiment, that GPU then uses dedicated circuitry/logic for efficiently processing these commands/instructions.

Logic 615 are used to perform inferencing and/or training operations associated with one or more embodiments. Details regarding logic 615 are provided herein in conjunction with FIGS. 6A and/or 6B. In at least one embodiment, logic 615 may be used in graphics multiprocessor 1334 for inferencing or predicting operations based, at least in part, on weight parameters calculated using neural network training operations, neural network functions and/or architectures, or neural network use cases described herein.

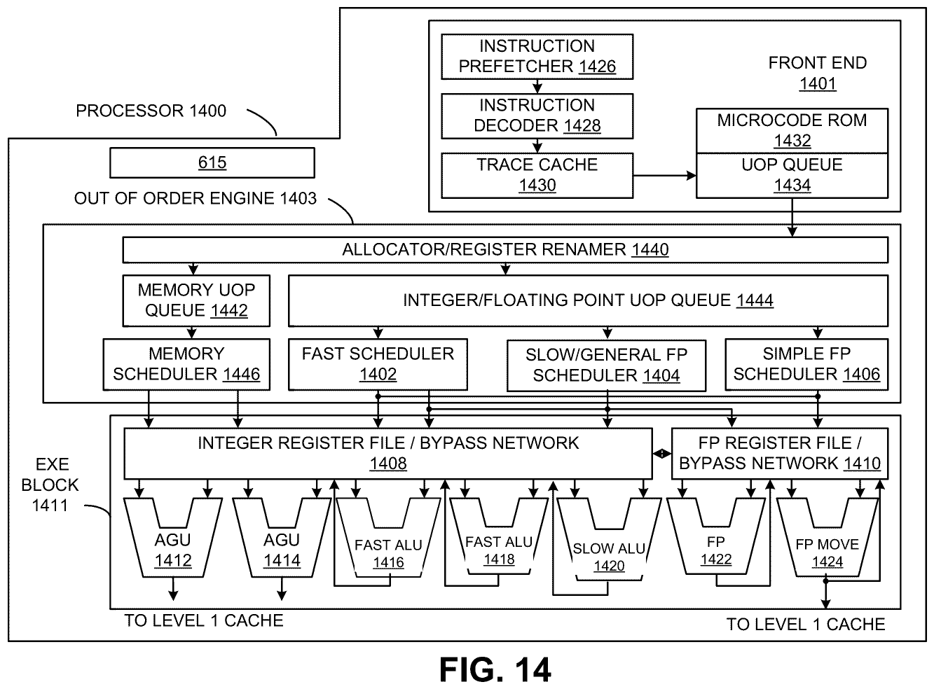

FIG. 14 is a block diagram illustrating micro-architecture for a processor 1400 that may include logic circuits to perform instructions, according to at least one embodiment. In at least one embodiment, processor 1400 may perform instructions, including x86 instructions, ARM instructions, specialized instructions for application-specific integrated circuits (ASICs), etc. In at least one embodiment, processor 1400 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany single instruction, multiple data (“SIMD”) and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processor 1400 may perform instructions to accelerate machine learning or deep learning algorithms, training, or inferencing.

In at least one embodiment, processor 1400 includes an in-order front end (“front end”) 1401 to fetch instructions to be executed and prepare instructions to be used later in a processor pipeline. In at least one embodiment, front end 1401 may include several units. In at least one embodiment, an instruction prefetcher 1426 fetches instructions from memory and feeds instructions to an instruction decoder 1428 which in turn decodes or interprets instructions. For example, in at least one embodiment, instruction decoder 1428 decodes a received instruction into one or more operations called “micro-instructions” or “micro-operations” (also called “micro ops” or “uops” or 37 μ-ops”) that a machine may execute. In at least one embodiment, instruction decoder 1428 parses an instruction into an opcode and corresponding data and control fields that may be used by micro-architecture to perform operations in accordance with at least one embodiment. In at least one embodiment, a trace cache 1430 may assemble decoded uops into program ordered sequences or traces in a uop queue 1434 for execution. In at least one embodiment, when trace cache 1430 encounters a complex instruction, a microcode ROM 1432 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 1428 may access microcode ROM 1432 to perform that instruction. In at least one embodiment, an instruction may be decoded into a small number of micro-ops for processing at instruction decoder 1428. In at least one embodiment, an instruction may be stored within microcode ROM 1432 should a number of micro-ops be needed to accomplish such operation. In at least one embodiment, trace cache 1430 refers to an entry point programmable logic array (“PLA”) to determine a correct micro-instruction pointer for reading microcode sequences to complete one or more instructions from microcode ROM 1432 in accordance with at least one embodiment. In at least one embodiment, after microcode ROM 1432 finishes sequencing micro-ops for an instruction, front end 1401 of a machine may resume fetching micro-ops from trace cache 1430.

In at least one embodiment, out-of-order execution engine (“out of order engine”) 1403 may prepare instructions for execution. In at least one embodiment, out-of-order execution logic has a number of buffers to smooth out and re-order flow of instructions to optimize performance as they go down a pipeline and get scheduled for execution. In at least one embodiment, out-of-order execution engine 1403 includes, without limitation, an allocator/register renamer 1440, a memory uop queue 1442, an integer/floating point uop queue 1444, a memory scheduler 1446, a fast scheduler 1402, a slow/general floating point scheduler (“slow/general FP scheduler”) 1404, and a simple floating point scheduler (“simple FP scheduler”) 1406. In at least one embodiment, fast schedule 1402, slow/general floating point scheduler 1404, and simple floating point scheduler 1406 are also collectively referred to herein as “uop schedulers 1402, 1404, 1406.” In at least one embodiment, allocator/register renamer 1440 allocates machine buffers and resources that each uop needs in order to execute. In at least one embodiment, allocator/register renamer 1440 renames logic registers onto entries in a register file. In at least one embodiment, allocator/register renamer 1440 also allocates an entry for each uop in one of two uop queues, memory uop queue 1442 for memory operations and integer/floating point uop queue 1444 for non-memory operations, in front of memory scheduler 1446 and uop schedulers 1402, 1404, 1406. In at least one embodiment, uop schedulers 1402, 1404, 1406, determine when a uop is ready to execute based on readiness of their dependent input register operand sources and availability of execution resources uops need to complete their operation. In at least one embodiment, fast scheduler 1402 may schedule on each half of a main clock cycle while slow/general floating point scheduler 1404 and simple floating point scheduler 1406 may schedule once per main processor clock cycle. In at least one embodiment, uop schedulers 1402, 1404, 1406 arbitrate for dispatch ports to schedule uops for execution.

In at least one embodiment, execution block 1411 includes, without limitation, an integer register file/bypass network 1408, a floating point register file/bypass network (“FP register file/bypass network”) 1410, address generation units (“AGUs”) 1412 and 1414, fast Arithmetic Logic Units (ALUs) (“fast ALUs”) 1416 and 1418, a slow Arithmetic Logic Unit (“slow ALU”) 1420, a floating point ALU (“FP”) 1422, and a floating point move unit (“FP move”) 1424. In at least one embodiment, integer register file/bypass network 1408 and floating point register file/bypass network 1410 are also referred to herein as “register files 1408, 1410.” In at least one embodiment, AGUSs 1412 and 1414, fast ALUs 1416 and 1418, slow ALU 1420, floating point ALU 1422, and floating point move unit 1424 are also referred to herein as “execution units 1412, 1414, 1416, 1418, 1420, 1422, and 1424.” In at least one embodiment, execution block 1411 may include, without limitation, any number (including zero) and type of register files, bypass networks, address generation units, and execution units, in any combination.

In at least one embodiment, register networks 1408, 1410 may be arranged between uop schedulers 1402, 1404, 1406, and execution units 1412, 1414, 1416, 1418, 1420, 1422, and 1424. In at least one embodiment, integer register file/bypass network 1408 performs integer operations. In at least one embodiment, floating point register file/bypass network 1410 performs floating point operations. In at least one embodiment, each of register networks 1408, 1410 may include, without limitation, a bypass network that may bypass or forward just completed results that have not yet been written into a register file to new dependent uops. In at least one embodiment, register networks 1408, 1410 may communicate data with each other. In at least one embodiment, integer register file/bypass network 1408 may include, without limitation, two separate register files, one register file for a low-order thirty-two bits of data and a second register file for a high order thirty-two bits of data. In at least one embodiment, floating point register file/bypass network 1410 may include, without limitation, 128-bit wide entries because floating point instructions typically have operands from 64 to 128 bits in width.

In at least one embodiment, execution units 1412, 1414, 1416, 1418, 1420, 1422, 1424 may execute instructions. In at least one embodiment, register networks 1408, 1410 store integer and floating point data operand values that micro-instructions need to execute. In at least one embodiment, processor 1400 may include, without limitation, any number and combination of execution units 1412, 1414, 1416, 1418, 1420, 1422, 1424. In at least one embodiment, floating point ALU 1422 and floating point move unit 1424, may execute floating point, MMX, SIMD, AVX and SSE, or other operations, including specialized machine learning instructions. In at least one embodiment, floating point ALU 1422 may include, without limitation, a 64-bit by 64-bit floating point divider to execute divide, square root, and remainder micro ops. In at least one embodiment, instructions involving a floating point value may be handled with floating point hardware. In at least one embodiment, ALU operations may be passed to fast ALUs 1416, 1418. In at least one embodiment, fast ALUS 1416, 1418 may execute fast operations with an effective latency of half a clock cycle. In at least one embodiment, most complex integer operations go to slow ALU 1420 as slow ALU 1420 may include, without limitation, integer execution hardware for long-latency type of operations, such as a multiplier, shifts, flag logic, and branch processing. In at least one embodiment, memory load/store operations may be executed by AGUs 1412, 1414. In at least one embodiment, fast ALU 1416, fast ALU 1418, and slow ALU 1420 may perform integer operations on 64-bit data operands. In at least one embodiment, fast ALU 1416, fast ALU 1418, and slow ALU 1420 may be implemented to support a variety of data bit sizes including sixteen, thirty-two, 128, 256, etc. In at least one embodiment, floating point ALU 1422 and floating point move unit 1424 may be implemented to support a range of operands having bits of various widths, such as 128-bit wide packed data operands in conjunction with SIMD and multimedia instructions.

In at least one embodiment, uop schedulers 1402, 1404, 1406 dispatch dependent operations before a parent load has finished executing. In at least one embodiment, as uops may be speculatively scheduled and executed in processor 1400, processor 1400 may also include logic to handle memory misses. In at least one embodiment, if a data load misses in a data cache, there may be dependent operations in flight in a pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and a replay mechanism of at least one embodiment of a processor may also be designed to catch instruction sequences for text string comparison operations.

In at least one embodiment, “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

In at least one embodiment, processor 1400 or each core of processor 1400 includes one or more prefetchers, one or more fetchers, one or more pre-decoders, one or more decoders to decode data (e.g., instructions), one or more instruction queues to process instructions (e.g., corresponding to operations or API calls), one or more micro-operation (POP) cache to store pOPs, one or more micro-operation (pOP) queues, an in-order execution engine, one or more load buffers, one or more store buffers, one or more reorder buffers, one or more fill buffers, an out-of-order execution engine, one or more ports, one or more shift and/or shifter units, one or more fused multiply accumulate (FMA) units, one or more load and store units (“LSUs”) to perform load of store operations corresponding to loading/storing data (e.g., instructions) to perform an operation (e.g., perform an API, an API call), one or more matrix multiply accumulate (MMA) units, and/or one or more shuffle units to perform any function further described herein with respect to said processor 1400. In at least one embodiment processor 1400 can access, use, perform, or execute instructions corresponding to calling an API.

In at least one embodiment, processor 1400 includes one or more ultra path interconnects (UPIs), e.g., that is a point-to-point processor interconnect; one or more PCIe's; one or more accelerators to accelerate computations or operations; and/or one or more memory controllers. In at least one embodiment, processor 1400 includes a shared last level cache (LLC) that is coupled to one or more memory controllers, which can enable shared memory access across processor cores.

In at least one embodiment, processor 1400 or a core of processor 1400 has a mesh architecture where processor cores, on-chip caches, memory controllers, and I/O controllers are organized in rows and columns, with wires and switches connecting them at each intersection to allow for turns. In at least one embodiment, processor 1400 has one or more higher memory bandwidths (HMBs, e.g., HMBe) to store data or cache data, e.g., in Double Data Rate 5 Synchronous Dynamic Random-Access Memory (DDR5 SDRAM). In at least one embodiment, one or more components of processor 1400 are interconnected using compute express link (CXL) interconnects. In at least one embodiment, a memory controller uses a “least recently used” (LRU) approach to determine what gets stored in a cache. In at least one embodiment, processor 1400 includes one or more PCIe's (e.g., PCIe 5.0).

Logic 615 are used to perform inferencing and/or training operations associated with one or more embodiments. Details regarding logic 615 are provided herein in conjunction with FIGS. 6A and/or 6B. In at least one embodiment portions or all of logic 615 may be incorporated into execution block 1411 and other memory or registers shown or not shown. For example, in at least one embodiment, training and/or inferencing techniques described herein may use one or more of ALUs illustrated in execution block 1411. Moreover, weight parameters may be stored in on-chip or off-chip memory and/or registers (shown or not shown) that configure ALUs of execution block 1411 to perform one or more machine learning algorithms, neural network architectures, use cases, or training techniques described herein.

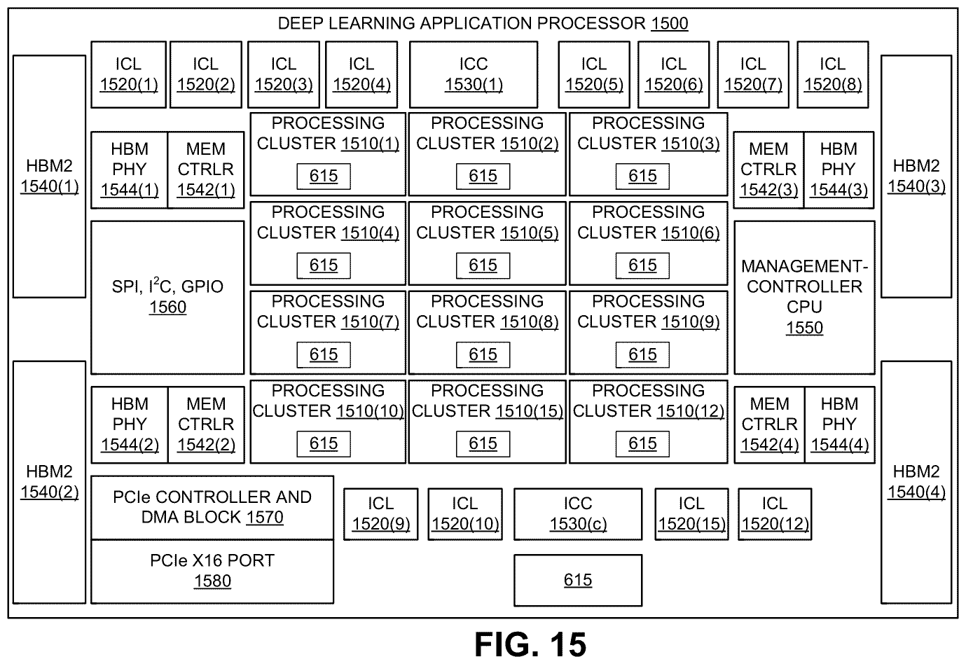

FIG. 15 illustrates a deep learning application processor 1500, according to at least one embodiment. In at least one embodiment, deep learning application processor 1500 uses instructions that, if executed by deep learning application processor 1500, cause deep learning application processor 1500 to perform some or all of processes and techniques described throughout this disclosure. In at least one embodiment, deep learning application processor 1500 is an application-specific integrated circuit (ASIC). In at least one embodiment, application processor 1500 performs matrix multiply operations either “hard-wired” into hardware as a result of performing one or more instructions or both. In at least one embodiment, deep learning application processor 1500 includes, without limitation, processing clusters 1510(1)-1510(12), Inter-Chip Links (“ICLs”) 1520(1)-1520(12), Inter-Chip Controllers (“ICCs”) 1530(1)-1530(2), high-bandwidth memory second generation (“HBM2”) 1540(1)-1540(4), memory controllers (“Mem Ctrlrs”) 1542(1)-1542(4), high bandwidth memory physical layer (“HBM PHY”) 1544(1)-1544(4), a management-controller central processing unit (“management-controller CPU”) 1550, a Serial Peripheral Interface, Inter-Integrated Circuit, and General Purpose Input/Output block (“SPI, I²C, GPIO”) 1560, a peripheral component interconnect express controller and direct memory access block (“PCIe Controller and DMA”) 1570, and a sixteen-lane peripheral component interconnect express port (“PCI Express x 16”) 1580.

In at least one embodiment, processing clusters 1510 may perform deep learning operations, including inference or prediction operations based on weight parameters calculated one or more training techniques, including those described herein. In at least one embodiment, each processing cluster 1510 may include, without limitation, any number and type of processors. In at least one embodiment, deep learning application processor 1500 may include any number and type of processing clusters 1500. In at least one embodiment, Inter-Chip Links 1520 are bi-directional. In at least one embodiment, Inter-Chip Links 1520 and Inter-Chip Controllers 1530 enable multiple deep learning application processors 1500 to exchange information, including activation information resulting from performing one or more machine learning algorithms embodied in one or more neural networks. In at least one embodiment, deep learning application processor 1500 may include any number (including zero) and type of ICLs 1520 and ICCs 1530.

In at least one embodiment, HBM2s 1540 provide a total of 32 Gigabytes (GB) of memory. In at least one embodiment, HBM2 1540(i) is associated with both memory controller 1542(i) and HBM PHY 1544(i) where “i” is an arbitrary integer. In at least one embodiment, any number of HBM2s 1540 may provide any type and total amount of high bandwidth memory and may be associated with any number (including zero) and type of memory controllers 1542 and HBM PHYs 1544. In at least one embodiment, SPI, I²C, GPIO 1560, PCIe Controller and DMA 1570, and/or PCIe 1580 may be replaced with any number and type of blocks that enable any number and type of communication standards in any technically feasible fashion.

Logic 615 are used to perform inferencing and/or training operations associated with one or more embodiments. Details regarding logic 615 are provided herein in conjunction with FIGS. 6A and/or 6B. In at least one embodiment, deep learning application processor is used to train a machine learning model, such as a neural network, to predict or infer information provided to deep learning application processor 1500. In at least one embodiment, deep learning application processor 1500 is used to infer or predict information based on a trained machine learning model (e.g., neural network) that has been trained by another processor or system or by deep learning application processor 1500. In at least one embodiment, processor 1500 may be used to perform one or more neural network use cases described herein.

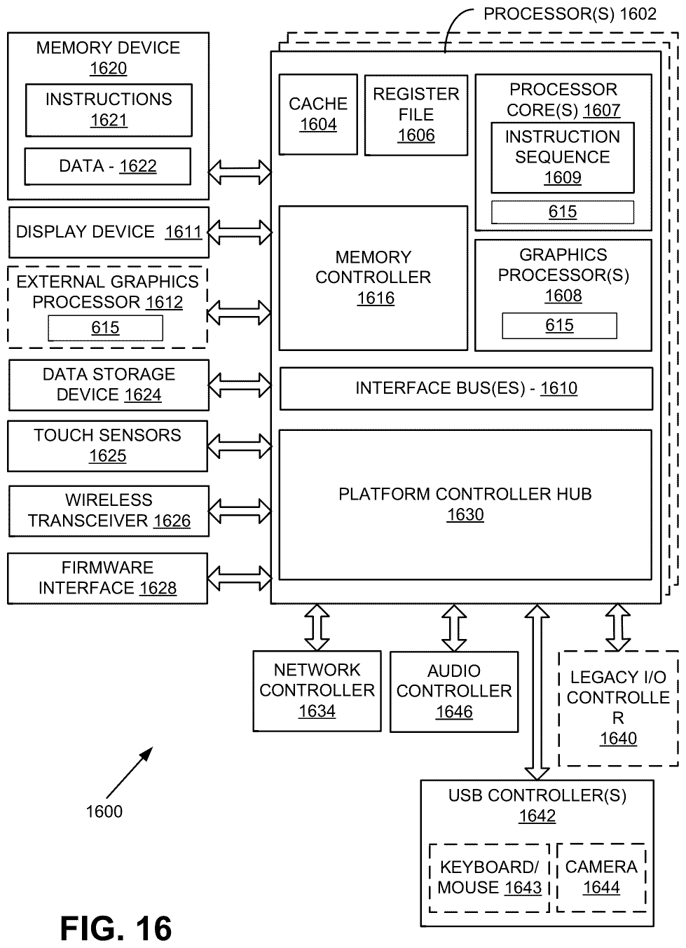

FIG. 16 is a block diagram of a processing system, according to at least one embodiment. In at least one embodiment, system 1600 includes one or more processors 1602 and one or more graphics processors 1608, and may be a single processor desktop system, a multiprocessor workstation system, or a server system having a large number of processors 1602 or processor cores 1607. In at least one embodiment, system 1600 is a processing platform incorporated within a system-on-a-chip (SoC) integrated circuit for use in mobile, handheld, or embedded devices. In at least one embodiment, one or more graphics processors 1608 include one or more graphics cores 1200.

In at least one embodiment, system 1600 can include, or be incorporated within a server-based gaming platform, a game console, including a game and media console, a mobile gaming console, a handheld game console, or an online game console. In at least one embodiment, system 1600 is a mobile phone, a smart phone, a tablet computing device or a mobile Internet device. In at least one embodiment, processing system 1600 can also include, couple with, or be integrated within a wearable device, such as a smart watch wearable device, a smart eyewear device, an augmented reality device, or a virtual reality device. In at least one embodiment, processing system 1600 is a television or set top box device having one or more processors 1602 and a graphical interface generated by one or more graphics processors 1608.

In at least one embodiment, one or more processors 1602 each include one or more processor cores 1607 to process instructions which, when executed, perform operations for system and user software. In at least one embodiment, each of one or more processor cores 1607 is configured to process a specific instruction sequence 1609. In at least one embodiment, instruction sequence 1609 may facilitate Complex Instruction Set Computing (CISC), Reduced Instruction Set Computing (RISC), or computing via a Very Long Instruction Word (VLIW). In at least one embodiment, processor cores 1607 may each process a different instruction sequence 1609, which may include instructions to facilitate emulation of other instruction sequences. In at least one embodiment, processor core 1607 may also include other processing devices, such a Digital Signal Processor (DSP).

In at least one embodiment, processor 1602 includes a cache memory 1604. In at least one embodiment, processor 1602 can have a single internal cache or multiple levels of internal cache. In at least one embodiment, cache memory is shared among various components of processor 1602. In at least one embodiment, processor 1602 also uses an external cache (e.g., a Level-3 (L3) cache or Last Level Cache (LLC)) (not shown), which may be shared among processor cores 1607 using known cache coherency techniques. In at least one embodiment, a register file 1606 is additionally included in processor 1602, which may include different types of registers for storing different types of data (e.g., integer registers, floating point registers, status registers, and an instruction pointer register). In at least one embodiment, register file 1606 may include general-purpose registers or other registers.

In at least one embodiment, one or more processor(s) 1602 are coupled with one or more interface bus(es) 1610 to transmit communication signals such as address, data, or control signals between processor 1602 and other components in system 1600. In at least one embodiment, interface bus 1610 can be a processor bus, such as a version of a Direct Media Interface (DMI) bus. In at least one embodiment, interface bus 1610 is not limited to a DMI bus, and may include one or more Peripheral Component Interconnect buses (e.g., PCI, PCI Express), memory busses, or other types of interface busses. In at least one embodiment processor(s) 1602 include an integrated memory controller 1616 and a platform controller hub 1630. In at least one embodiment, memory controller 1616 facilitates communication between a memory device and other components of system 1600, while platform controller hub (PCH) 1630 provides connections to I/O devices via a local I/O bus.

In at least one embodiment, a memory device 1620 can be a dynamic random access memory (DRAM) device, a static random access memory (SRAM) device, flash memory device, phase-change memory device, or some other memory device having suitable performance to serve as process memory. In at least one embodiment, memory device 1620 can operate as system memory for system 1600, to store data 1622 and instructions 1621 for use when one or more processors 1602 executes an application or process. In at least one embodiment, memory controller 1616 also couples with an optional external graphics processor 1612, which may communicate with one or more graphics processors 1608 in processors 1602 to perform graphics and media operations. In at least one embodiment, a display device 1611 can connect to processor(s) 1602. In at least one embodiment, display device 1611 can include one or more of an internal display device, as in a mobile electronic device or a laptop device, or an external display device attached via a display interface (e.g., DisplayPort, etc.). In at least one embodiment, display device 1611 can include a head mounted display (HMD) such as a stereoscopic display device for use in virtual reality (VR) applications or augmented reality (AR) applications.

In at least one embodiment, platform controller hub 1630 enables peripherals to connect to memory device 1620 and processor 1602 via a high-speed I/O bus. In at least one embodiment, I/O peripherals include, but are not limited to, an audio controller 1646, a network controller 1634, a firmware interface 1628, a wireless transceiver 1626, touch sensors 1625, a data storage device 1624 (e.g., hard disk drive, flash memory, etc.). In at least one embodiment, data storage device 1624 can connect via a storage interface (e.g., SATA) or via a peripheral bus, such as a Peripheral Component Interconnect bus (e.g., PCI, PCI Express). In at least one embodiment, touch sensors 1625 can include touch screen sensors, pressure sensors, or fingerprint sensors. In at least one embodiment, wireless transceiver 1626 can be a Wi-Fi transceiver, a Bluetooth transceiver, or a mobile network transceiver such as a 3G, 4G, or Long Term Evolution (LTE) transceiver. In at least one embodiment, firmware interface 1628 enables communication with system firmware, and can be, for example, a unified extensible firmware interface (UEFI). In at least one embodiment, network controller 1634 can enable a network connection to a wired network. In at least one embodiment, a high-performance network controller (not shown) couples with interface bus 1610. In at least one embodiment, audio controller 1646 is a multi-channel high definition audio controller. In at least one embodiment, system 1600 includes an optional legacy I/O controller 1640 for coupling legacy (e.g., Personal System 2 (PS/2)) devices to system 1600. In at least one embodiment, platform controller hub 1630 can also connect to one or more Universal Serial Bus (USB) controllers 1642 connect input devices, such as keyboard and mouse 1643 combinations, a camera 1644, or other USB input devices.

In at least one embodiment, an instance of memory controller 1616 and platform controller hub 1630 may be integrated into a discreet external graphics processor, such as external graphics processor 1612. In at least one embodiment, platform controller hub 1630 and/or memory controller 1616 may be external to one or more processor(s) 1602. For example, in at least one embodiment, system 1600 can include an external memory controller 1616 and platform controller hub 1630, which may be configured as a memory controller hub and peripheral controller hub within a system chipset that is in communication with processor(s) 1602.

Logic 615 are used to perform inferencing and/or training operations associated with one or more embodiments. Details regarding logic 615 are provided herein in conjunction with FIGS. 6A and/or 6B. In at least one embodiment portions or all of logic 615 may be incorporated into graphics processor 1608. For example, in at least one embodiment, training and/or inferencing techniques described herein may use one or more of ALUs embodied in a 3D pipeline. Moreover, in at least one embodiment, inferencing and/or training operations described herein may be done using logic other than logic illustrated in FIG. 6A or 6B. In at least one embodiment, weight parameters may be stored in on-chip or off-chip memory and/or registers (shown or not shown) that configure ALUs of graphics processor 1608 to perform one or more machine learning algorithms, neural network architectures, use cases, or training techniques described herein.

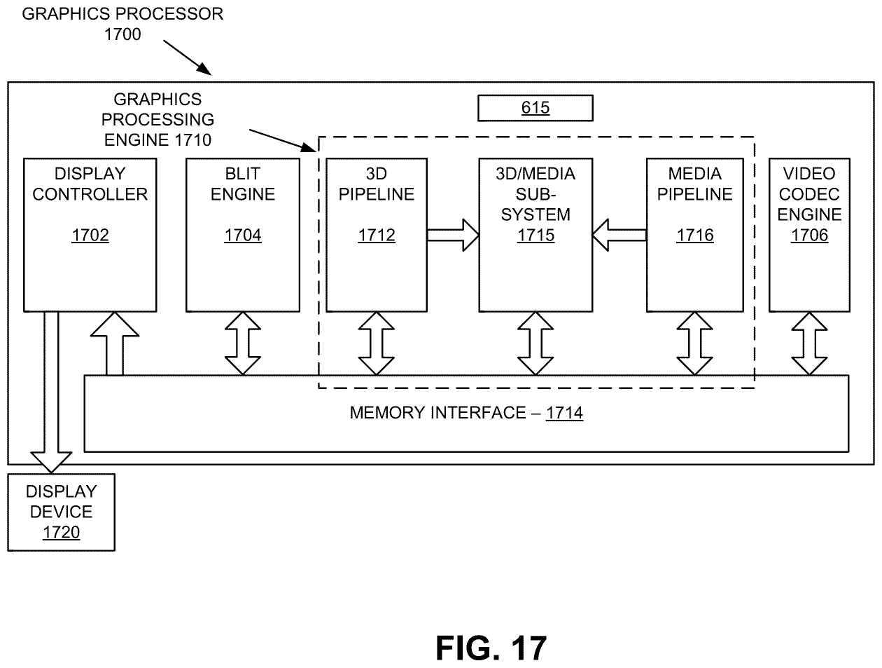

FIG. 17 is a block diagram of a graphics processor 1700, which may be a discrete graphics processing unit, or may be a graphics processor integrated with a plurality of processing cores. In at least one embodiment, graphics processor 1700 communicates via a memory mapped I/O interface to registers on graphics processor 1700 and with commands placed into memory. In at least one embodiment, graphics processor 1700 includes a memory interface 1714 to access memory. In at least one embodiment, memory interface 1714 is an interface to local memory, one or more internal caches, one or more shared external caches, and/or to system memory. In at least one embodiment, graphics processor 1700 includes graphics core 1200.

In at least one embodiment, graphics processor 1700 also includes a display controller 1702 to drive display output data to a display device 1720. In at least one embodiment, display controller 1702 includes hardware for one or more overlay planes for display device 1720 and composition of multiple layers of video or user interface elements. In at least one embodiment, display device 1720 can be an internal or external display device. In at least one embodiment, display device 1720 is a head mounted display device, such as a virtual reality (VR) display device or an augmented reality (AR) display device. In at least one embodiment, graphics processor 1700 includes a video codec engine 1706 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In at least one embodiment, graphics processor 1700 includes a block image transfer (BLIT) engine 1704 to perform two-dimensional (2D) rasterizer operations including, for example, bit-boundary block transfers. However, in at least one embodiment, 2D graphics operations are performed using one or more components of a graphics processing engine (GPE) 1710. In at least one embodiment, GPE 1710 is a compute engine for performing graphics operations, including three-dimensional (3D) graphics operations and media operations.

In at least one embodiment, GPE 1710 includes a 3D pipeline 1712 for performing 3D operations, such as rendering three-dimensional images and scenes using processing functions that act upon 3D primitive shapes (e.g., rectangle, triangle, etc.). In at least one embodiment, 3D pipeline 1712 includes programmable and fixed function elements that perform various tasks and/or spawn execution threads to a 3D/Media sub-system 1715. While 3D pipeline 1712 can be used to perform media operations, in at least one embodiment, GPE 1710 also includes a media pipeline 1716 that is used to perform media operations, such as video post-processing and image enhancement.

In at least one embodiment, media pipeline 1716 includes fixed function or programmable logic units to perform one or more specialized media operations, such as video decode acceleration, video de-interlacing, and video encode acceleration in place of, or on behalf of, video codec engine 1706. In at least one embodiment, media pipeline 1716 additionally includes a thread spawning unit to spawn threads for execution on 3D/Media sub-system 1715. In at least one embodiment, spawned threads perform computations for media operations on one or more graphics execution units included in 3D/Media sub-system 1715.

In at least one embodiment, 3D/Media subsystem 1715 includes logic for executing threads spawned by 3D pipeline 1712 and media pipeline 1716. In at least one embodiment, 3D pipeline 1712 and media pipeline 1716 send thread execution requests to 3D/Media subsystem 1715, which includes thread dispatch logic for arbitrating and dispatching various requests to available thread execution resources. In at least one embodiment, execution resources include an array of graphics execution units to process 3D and media threads. In at least one embodiment, 3D/Media subsystem 1715 includes one or more internal caches for thread instructions and data. In at least one embodiment, subsystem 1715 also includes shared memory, including registers and addressable memory, to share data between threads and to store output data.

Logic 615 are used to perform inferencing and/or training operations associated with one or more embodiments. Details regarding logic 615 are provided herein in conjunction with FIGS. 6A and/or 6B. In at least one embodiment portions or all of logic 615 may be incorporated into graphics processor 1700. For example, in at least one embodiment, training and/or inferencing techniques described herein may use one or more of ALUs embodied in 3D pipeline 1712. Moreover, in at least one embodiment, inferencing and/or training operations described herein may be done using logic other than logic illustrated in FIG. 6A or 6B. In at least one embodiment, weight parameters may be stored in on-chip or off-chip memory and/or registers (shown or not shown) that configure ALUs of graphics processor 1700 to perform one or more machine learning algorithms, neural network architectures, use cases, or training techniques described herein.

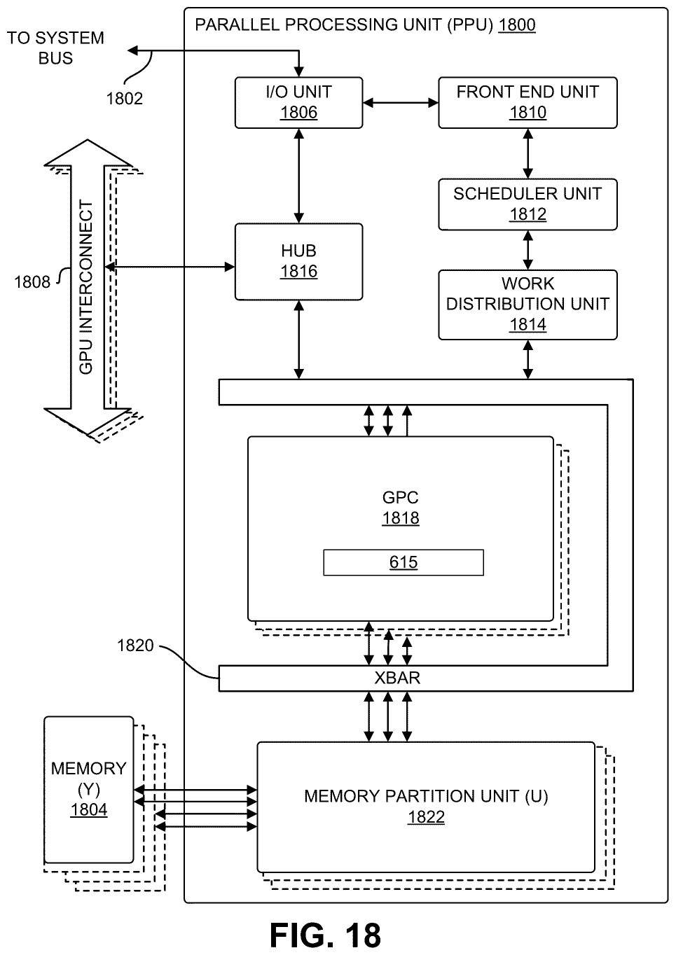

FIG. 18 illustrates a parallel processing unit (“PPU”) 1800, according to at least one embodiment. In at least one embodiment, PPU 1800 is configured with machine-readable code that, if executed by PPU 1800, causes PPU 1800 to perform some or all of processes and techniques described throughout this disclosure. In at least one embodiment, PPU 1800 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, PPU 1800 includes one or more graphics cores 1200. In at least one embodiment, a thread refers to a thread of execution and is an instantiation of a set of instructions configured to be executed by PPU 1800. In at least one embodiment, PPU 1800 is a graphics processing unit (“GPU”) configured to implement a graphics rendering pipeline for processing three-dimensional (“3D”) graphics data in order to generate two-dimensional (“2D”) image data for display on a display device such as a liquid crystal display (“LCD”) device. In at least one embodiment, PPU 1800 is utilized to perform computations such as linear algebra operations and machine-learning operations. FIG. 18 illustrates an example parallel processor for illustrative purposes only and should be construed as a non-limiting example of processor architectures contemplated within scope of this disclosure and that any suitable processor may be employed to supplement and/or substitute for same.

In at least one embodiment, one or more PPUs 1800 are configured to accelerate High Performance Computing (“HPC”), data center, and machine learning applications. In at least one embodiment, PPU 1800 is configured to accelerate deep learning systems and applications including following non-limiting examples: autonomous vehicle platforms, deep learning, high-accuracy speech, image, text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and more.

In at least one embodiment, PPU 1800 includes, without limitation, an Input/Output (“I/O”) unit 1806, a front-end unit 1810, a scheduler (sequencer) unit 1812, a work distribution unit 1814, a hub 1816, a crossbar (“XBar”) 1820, one or more general processing clusters (“GPCs”) 1818, and one or more partition units (“memory partition units”) 1822. In at least one embodiment, PPU 1800 is connected to a host processor or other PPUs 1800 via one or more high-speed GPU interconnects (“GPU interconnects”) 1808. In at least one embodiment, PPU 1800 is connected to a host processor or other peripheral devices via a system bus 1802. In at least one embodiment, PPU 1800 is connected to a local memory comprising one or more memory devices (“memory”) 1804. In at least one embodiment, memory devices 1804 include, without limitation, one or more dynamic random access memory (“DRAM”) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 1808 may refer to a wire-based multi-lane communications link that is used by systems to scale and include one or more PPUs 1800 combined with one or more central processing units (“CPUs”), supports cache coherence between PPUs 1800 and CPUs, and CPU mastering. In at least one embodiment, data and/or commands are transmitted by high-speed GPU interconnect 1808 through hub 1816 to/from other units of PPU 1800 such as one or more copy engines, video encoders, video decoders, power management units, and other components which may not be explicitly illustrated in FIG. 18.

In at least one embodiment, I/O unit 1806 is configured to transmit and receive communications (e.g., commands, data) from a host processor (not illustrated in FIG. 18) over system bus 1802. In at least one embodiment, I/O unit 1806 communicates with host processor directly via system bus 1802 or through one or more intermediate devices such as a memory bridge. In at least one embodiment, I/O unit 1806 may communicate with one or more other processors, such as one or more of PPUs 1800 via system bus 1802. In at least one embodiment, I/O unit 1806 implements a Peripheral Component Interconnect Express (“PCIe”) interface for communications over a PCIe bus. In at least one embodiment, I/O unit 1806 implements interfaces for communicating with external devices.

In at least one embodiment, I/O unit 1806 decodes packets received via system bus 1802. In at least one embodiment, at least some packets represent commands configured to cause PPU 1800 to perform various operations. In at least one embodiment, I/O unit 1806 transmits decoded commands to various other units of PPU 1800 as specified by commands. In at least one embodiment, commands are transmitted to front-end unit 1810 and/or transmitted to hub 1816 or other units of PPU 1800 such as one or more copy engines, a video encoder, a video decoder, a power management unit, etc. (not explicitly illustrated in FIG. 18). In at least one embodiment, I/O unit 1806 is configured to route communications between and among various logical units of PPU 1800.

In at least one embodiment, a program executed by host processor encodes a command stream in a buffer that provides workloads to PPU 1800 for processing. In at least one embodiment, a workload comprises instructions and data to be processed by those instructions. In at least one embodiment, a buffer is a region in a memory that is accessible (e.g., read/write) by both a host processor and PPU 1800 a host interface unit may be configured to access that buffer in a system memory connected to system bus 1802 via memory requests transmitted over system bus 1802 by I/O unit 1806. In at least one embodiment, a host processor writes a command stream to a buffer and then transmits a pointer to a start of a command stream to PPU 1800 such that front-end unit 1810 receives pointers to one or more command streams and manages one or more command streams, reading commands from command streams and forwarding commands to various units of PPU 1800.

In at least one embodiment, front-end unit 1810 is coupled to scheduler unit 1812 (which may be referred to as a sequencer unit, a thread sequencer, and/or an asynchronous compute engine) that configures various GPCs 1818 to process tasks defined by one or more command streams. In at least one embodiment, scheduler unit 1812 is configured to track state information related to various tasks managed by scheduler unit 1812 where state information may indicate which of GPCs 1818 a task is assigned to, whether task is active or inactive, a priority level associated with task, and so forth. In at least one embodiment, scheduler unit 1812 manages execution of a plurality of tasks on one or more of GPCs 1818.

In at least one embodiment, scheduler unit 1812 is coupled to work distribution unit 1814 that is configured to dispatch tasks for execution on GPCs 1818. In at least one embodiment, work distribution unit 1814 tracks a number of scheduled tasks received from scheduler unit 1812 and work distribution unit 1814 manages a pending task pool and an active task pool for each of GPCs 1818. In at least one embodiment, pending task pool comprises a number of slots (e.g., 32 slots) that contain tasks assigned to be processed by a particular GPC 1818; an active task pool may comprise a number of slots (e.g., 4 slots) for tasks that are actively being processed by GPCs 1818 such that as one of GPCs 1818 completes execution of a task, that task is evicted from that active task pool for GPC 1818 and another task from a pending task pool is selected and scheduled for execution on GPC 1818. In at least one embodiment, if an active task is idle on GPC 1818, such as while waiting for a data dependency to be resolved, then that active task is evicted from GPC 1818 and returned to that pending task pool while another task in that pending task pool is selected and scheduled for execution on GPC 1818.

In at least one embodiment, work distribution unit 1814 communicates with one or more GPCs 1818 via XBar 1820. In at least one embodiment, XBar 1820 is an interconnect network that couples many of units of PPU 1800 to other units of PPU 1800 and can be configured to couple work distribution unit 1814 to a particular GPC 1818. In at least one embodiment, one or more other units of PPU 1800 may also be connected to XBar 1820 via hub 1816.

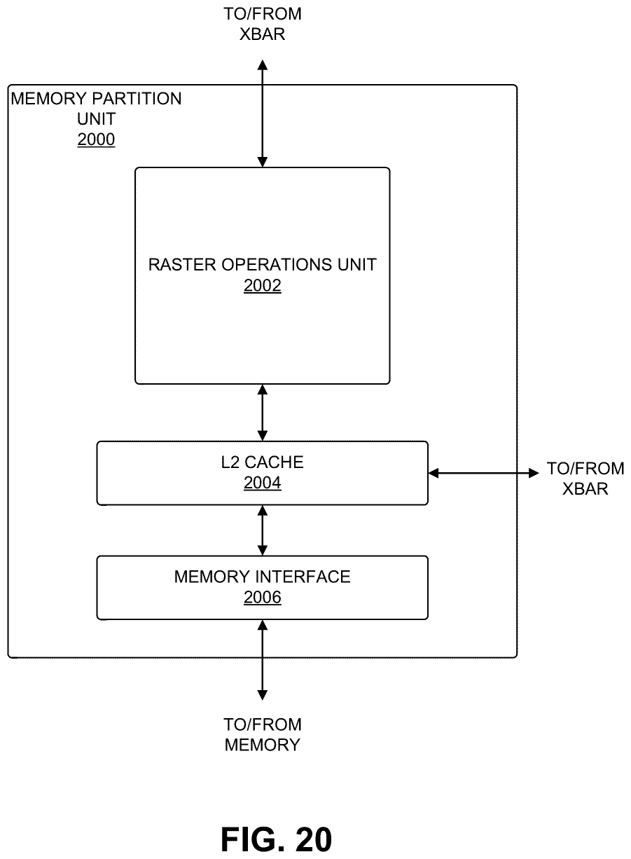

In at least one embodiment, tasks are managed by scheduler unit 1812 and dispatched to one of GPCs 1818 by work distribution unit 1814. In at least one embodiment, GPC 1818 is configured to process task and generate results. In at least one embodiment, results may be consumed by other tasks within GPC 1818, routed to a different GPC 1818 via XBar 1820, or stored in memory 1804. In at least one embodiment, results can be written to memory 1804 via partition units 1822, which implement a memory interface for reading and writing data to/from memory 1804. In at least one embodiment, results can be transmitted to another PPU or CPU via high-speed GPU interconnect 1808. In at least one embodiment, PPU 1800 includes, without limitation, a number U of partition units 1822 that is equal to a number of separate and distinct memory devices 1804 coupled to PPU 1800, as described in more detail herein in conjunction with FIG. 20.

In at least one embodiment, a host processor executes a driver kernel that implements an application programming interface (“API”) that enables one or more applications executing on a host processor to schedule operations for execution on PPU 1800. In at least one embodiment, multiple compute applications are simultaneously executed by PPU 1800 and PPU 1800 provides isolation, quality of service (“QoS”), and independent address spaces for multiple compute applications. In at least one embodiment, an application generates instructions (e.g., in form of API calls) that cause a driver kernel to generate one or more tasks for execution by PPU 1800 and that driver kernel outputs tasks to one or more streams being processed by PPU 1800. In at least one embodiment, each task comprises one or more groups of related threads, which may be referred to as a warp, wavefront, and/or wave. In at least one embodiment, a warp, wavefront, and/or wave comprises a plurality of related threads (e.g., 32 threads) that can be executed in parallel. In at least one embodiment, cooperating threads can refer to a plurality of threads including instructions to perform task and that exchange data through shared memory. In at least one embodiment, threads and cooperating threads are described in more detail in conjunction with FIG. 20.

Logic 615 are used to perform inferencing and/or training operations associated with one or more embodiments. Details regarding logic 615 are provided herein in conjunction with FIGS. 6A and/or 6B. In at least one embodiment, deep learning application processor is used to train a machine learning model, such as a neural network, to predict or infer information provided to PPU 1800. In at least one embodiment, deep learning application processor is used to infer or predict information based on a trained machine learning model (e.g., neural network) that has been trained by another processor or system or by PPU 1800. In at least one embodiment, PPU 1800 may be used to perform one or more neural network use cases described herein.

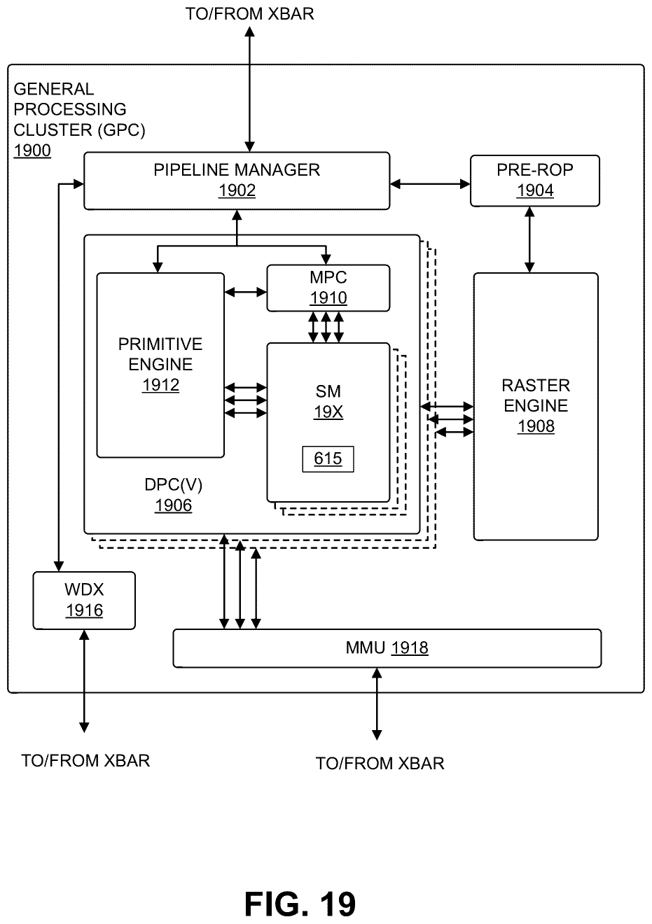

FIG. 19 illustrates a general processing cluster (“GPC”) 1900, according to at least one embodiment. In at least one embodiment, GPC 1900 is GPC 1818 of FIG. 18. In at least one embodiment, each GPC 1900 includes, without limitation, a number of hardware units for processing tasks and each GPC 1900 includes, without limitation, a pipeline manager 1902, a pre-raster operations unit (“preROP”) 1904, a raster engine 1908, a work distribution crossbar (“WDX”) 1916, a memory management unit (“MMU”) 1918, one or more Data Processing Clusters (“DPCs”) 1906, and any suitable combination of parts.

In at least one embodiment, operation of GPC 1900 is controlled by pipeline manager 1902. In at least one embodiment, pipeline manager 1902 manages configuration of one or more DPCs 1906 for processing tasks allocated to GPC 1900. In at least one embodiment, pipeline manager 1902 configures at least one of one or more DPCs 1906 to implement at least a portion of a graphics rendering pipeline. In at least one embodiment, DPC 1906 is configured to execute a vertex shader program on a programmable streaming multi-processor (“SM”) 1914. In at least one embodiment, pipeline manager 1902 is configured to route packets received from a work distribution unit to appropriate logical units within GPC 1900, in at least one embodiment, and some packets may be routed to fixed function hardware units in preROP 1904 and/or raster engine 1908 while other packets may be routed to DPCs 1906 for processing by a primitive engine 1912 or SM 1914. In at least one embodiment, pipeline manager 1902 configures at least one of DPCs 1906 to implement a neural network model and/or a computing pipeline.

In at least one embodiment, preROP unit 1904 is configured, in at least one embodiment, to route data generated by raster engine 1908 and DPCs 1906 to a Raster Operations (“ROP”) unit in partition unit 1822, described in more detail above in conjunction with FIG. 18. In at least one embodiment, preROP unit 1904 is configured to perform optimizations for color blending, organize pixel data, perform address translations, and more. In at least one embodiment, raster engine 1908 includes, without limitation, a number of fixed function hardware units configured to perform various raster operations, in at least one embodiment, and raster engine 1908 includes, without limitation, a setup engine, a coarse raster engine, a culling engine, a clipping engine, a fine raster engine, a tile coalescing engine, and any suitable combination thereof. In at least one embodiment, setup engine receives transformed vertices and generates plane equations associated with geometric primitive defined by vertices; plane equations are transmitted to a coarse raster engine to generate coverage information (e.g., an x, y coverage mask for a tile) for primitive; output of a coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, an output of raster engine 1908 comprises fragments to be processed by any suitable entity, such as by a fragment shader implemented within DPC 1906.

In at least one embodiment, each DPC 1906 included in GPC 1900 comprises, without limitation, an M-Pipe Controller (“MPC”) 1910; primitive engine 1912; one or more SMs 1914; and any suitable combination thereof. In at least one embodiment, MPC 1910 controls operation of DPC 1906, routing packets received from pipeline manager 1902 to appropriate units in DPC 1906. In at least one embodiment, packets associated with a vertex are routed to primitive engine 1912, which is configured to fetch vertex attributes associated with a vertex from memory; in contrast, packets associated with a shader program may be transmitted to SM 1914.

In at least one embodiment, SM 1914 comprises, without limitation, a programmable streaming processor that is configured to process tasks represented by a number of threads. In at least one embodiment, SM 1914 is multi-threaded and configured to execute a plurality of threads (e.g., 32 threads) from a particular group of threads concurrently and implements a Single-Instruction, Multiple-Data (“SIMD”) architecture where each thread in a group of threads (e.g., a warp, wavefront, wave) is configured to process a different set of data based on same set of instructions. In at least one embodiment, all threads in group of threads execute a common set of instructions. In at least one embodiment, SM 1914 implements a Single-Instruction, Multiple Thread (“SIMT”) architecture wherein each thread in a group of threads is configured to process a different set of data based on that common set of instructions, but where individual threads in a group of threads are allowed to diverge during execution. In at least one embodiment, a program counter, call stack, and execution state is maintained for each warp (which may be referred to as wavefronts and/or waves), enabling concurrency between warps and serial execution within warps when threads within a warp diverge. In another embodiment, a program counter, call stack, and execution state is maintained for each individual thread, enabling equal concurrency between all threads, within and between warps. In at least one embodiment, execution state is maintained for each individual thread and threads executing common instructions may be converged and executed in parallel for better efficiency. At least one embodiment of SM 1914 is described in more detail herein.

In at least one embodiment, MMU 1918 provides an interface between GPC 1900 and a memory partition unit (e.g., partition unit 1822 of FIG. 18) and MMU 1918 provides translation of virtual addresses into physical addresses, memory protection, and arbitration of memory requests. In at least one embodiment, MMU 1918 provides one or more translation lookaside buffers (“TLBs”) for performing translation of virtual addresses into physical addresses in memory.

Logic 615 are used to perform inferencing and/or training operations associated with one or more embodiments. Details regarding logic 615 are provided herein in conjunction with FIGS. 6A and/or 6B. In at least one embodiment, deep learning application processor is used to train a machine learning model, such as a neural network, to predict or infer information provided to GPC 1900. In at least one embodiment, GPC 1900 is used to infer or predict information based on a trained machine learning model (e.g., neural network) that has been trained by another processor or system or by GPC 1900. In at least one embodiment, GPC 1900 may be used to perform one or more neural network use cases described herein.

FIG. 20 illustrates a memory partition unit 2000 of a parallel processing unit (“PPU”), in accordance with at least one embodiment. In at least one embodiment, memory partition unit 2000 includes, without limitation, a Raster Operations (“ROP”) unit 2002, a level two (“L2”) cache 2004, a memory interface 2006, and any suitable combination thereof. In at least one embodiment, memory interface 2006 is coupled to memory. In at least one embodiment, memory interface 2006 may implement 32, 64, 128, 1024-bit data buses, or like, for high-speed data transfer. In at least one embodiment, PPU incorporates U memory interfaces 2006 where U is a positive integer, with one memory interface 2006 per pair of partition units 2000, where each pair of partition units 2000 is connected to a corresponding memory device. For example, in at least one embodiment, PPU may be connected to up to Y memory devices, such as high bandwidth memory stacks or graphics double-data-rate, version 5, synchronous dynamic random access memory (“GDDR5 SDRAM”).

In at least one embodiment, memory interface 2006 implements a high bandwidth memory second generation (“HBM2”) memory interface and Y equals half of U. In at least one embodiment, HBM2 memory stacks are located on a physical package with a PPU, providing substantial power and area savings compared with conventional GDDR5 SDRAM systems. In at least one embodiment, each HBM2 stack includes, without limitation, four memory dies with Y=4, with each HBM2 stack including two 128-bit channels per die for a total of 8 channels and a data bus width of 1024 bits. In at least one embodiment, that memory supports Single-Error Correcting Double-Error Detecting (“SECDED”) Error Correction Code (“ECC”) to protect data. In at least one embodiment, ECC can provide higher reliability for compute applications that are sensitive to data corruption.

In at least one embodiment, PPU implements a multi-level memory hierarchy. In at least one embodiment, memory partition unit 2000 supports a unified memory to provide a single unified virtual address space for central processing unit (“CPU”) and PPU memory, enabling data sharing between virtual memory systems. In at least one embodiment frequency of accesses by a PPU to a memory located on other processors is traced to ensure that memory pages are moved to physical memory of PPU that is accessing pages more frequently. In at least one embodiment, high-speed GPU interconnect 1808 supports address translation services allowing PPU to directly access a CPU's page tables and providing full access to CPU memory by a PPU.

In at least one embodiment, copy engines transfer data between multiple PPUs or between PPUs and CPUs. In at least one embodiment, copy engines can generate page faults for addresses that are not mapped into page tables and memory partition unit 2000 then services page faults, mapping addresses into page table, after which copy engine performs a transfer. In at least one embodiment, memory is pinned (i.e., non-pageable) for multiple copy engine operations between multiple processors, substantially reducing available memory. In at least one embodiment, with hardware page faulting, addresses can be passed to copy engines without regard as to whether memory pages are resident, and a copy process is transparent.

Data from memory 1804 of FIG. 18 or other system memory is fetched by memory partition unit 2000 and stored in L2 cache 2004, which is located on-chip and is shared between various GPCs, in accordance with at least one embodiment. Each memory partition unit 2000, in at least one embodiment, includes, without limitation, at least a portion of L2 cache associated with a corresponding memory device. In at least one embodiment, lower level caches are implemented in various units within GPCs. In at least one embodiment, each of SMs 1914 in FIG. 19 may implement a Level 1 (“L1”) cache wherein that L1 cache is private memory that is dedicated to a particular SM 1914 and data from L2 cache 2004 is fetched and stored in each L1 cache for processing in functional units of SMs 1914. In at least one embodiment, L2 cache 2004 is coupled to memory interface 2006 and XBar 1820 shown in FIG. 18.

ROP unit 2002 performs graphics raster operations related to pixel color, such as color compression, pixel blending, and more, in at least one embodiment. ROP unit 2002, in at least one embodiment, implements depth testing in conjunction with raster engine 1908, receiving a depth for a sample location associated with a pixel fragment from a culling engine of raster engine 1908. In at least one embodiment, depth is tested against a corresponding depth in a depth buffer for a sample location associated with a fragment. In at least one embodiment, if that fragment passes that depth test for that sample location, then ROP unit 2002 updates depth buffer and transmits a result of that depth test to raster engine 1908. It will be appreciated that a number of partition units 2000 may be different than a number of GPCs and, therefore, each ROP unit 2002 can, in at least one embodiment, be coupled to each GPC. In at least one embodiment, ROP unit 2002 tracks packets received from different GPCs and determines whether a result generated by ROP unit 2002 is to be routed to through XBar 1820.

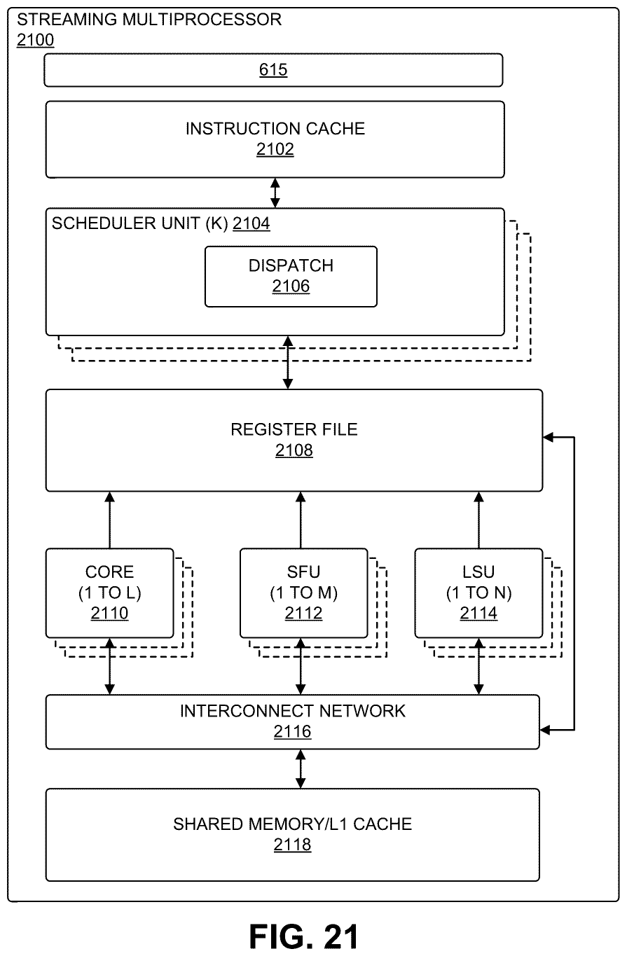

FIG. 21 illustrates a streaming multi-processor (“SM”) 2100, according to at least one embodiment. In at least one embodiment, SM 2100 is SM of FIG. 19. In at least one embodiment, SM 2100 includes, without limitation, an instruction cache 2102, one or more scheduler units 2104 (which may be referred to as sequencer units), a register file 2108, one or more processing cores (“cores”) 2110, one or more special function units (“SFUs”) 2112, one or more load/store units (“LSUs”) 2114, an interconnect network 2116, a shared memory/level one (“L1”) cache 2118, and/or any suitable combination thereof. In at least one embodiment, LSUs 2114 perform load of store operations corresponding to loading/storing data (e.g., instructions) to perform an operation (e.g., perform an API, an API call).

In at least one embodiment, a work distribution unit dispatches tasks for execution on general processing clusters (“GPCs”) of parallel processing units (“PPUs”) and each task is allocated to a particular Data Processing Cluster (“DPC”) within a GPC and, if a task is associated with a shader program, that task is allocated to one of SMs 2100 (which may be referred to as CUs and/or slices). In at least one embodiment, scheduler unit 2104 (which may be referred to as a sequencer and/or asynchronous compute engine) receives tasks from a work distribution unit and manages instruction scheduling for one or more thread blocks assigned to SM 2100. In at least one embodiment, scheduler unit 2104 schedules thread blocks for execution as warps (which may be referred to as wavefronts and/or waves) of parallel threads, wherein each thread block is allocated at least one warp. In at least one embodiment, each warp executes threads. In at least one embodiment, scheduler unit 2104 manages a plurality of different thread blocks, allocating warps to different thread blocks and then dispatching instructions from plurality of different cooperative groups to various functional units (e.g., processing cores 2110, SFUs 2112, and LSUs 2114) during each clock cycle.

In at least one embodiment, Cooperative Groups (which may also be referred to as wavefronts and/or waves) may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, applications of conventional programming models provide a single, simple construct for synchronizing cooperating threads: a barrier across all threads of a thread block (e.g., syncthreads( ) function). However, in at least one embodiment, programmers may define groups of threads at smaller than thread block granularities and synchronize within defined groups to enable greater performance, design flexibility, and software reuse in form of collective group-wide function interfaces. In at least one embodiment, Cooperative Groups enables programmers to define groups of threads explicitly at sub-block (i.e., as small as a single thread) and multi-block granularities, and to perform collective operations such as synchronization on threads in a cooperative group. In at least one embodiment, that programming model supports clean composition across software boundaries, so that libraries and utility functions can synchronize safely within their local context without having to make assumptions about convergence. In at least one embodiment, Cooperative Groups primitives enable new patterns of cooperative parallelism, including, without limitation, producer-consumer parallelism, opportunistic parallelism, and global synchronization across an entire grid of thread blocks.

In at least one embodiment, a dispatch unit 2106 is configured to transmit instructions to one or more functional units and scheduler unit 2104 and includes, without limitation, two dispatch units 2106 that enable two different instructions from a common warp to be dispatched during each clock cycle. In at least one embodiment, each scheduler unit 2104 includes a single dispatch unit 2106 or additional dispatch units 2106.

In at least one embodiment, each SM 2100 (which may be referred to as a CU and/or slice), in at least one embodiment, includes, without limitation, register file 2108 that provides a set of registers for functional units of SM 2100. In at least one embodiment, register file 2108 is divided between each functional unit such that each functional unit is allocated a dedicated portion of register file 2108. In at least one embodiment, register file 2108 is divided between different warps being executed by SM 2100 and register file 2108 provides temporary storage for operands connected to data paths of functional units. In at least one embodiment, each SM 2100 comprises, without limitation, a plurality of L processing cores 2110, where L is a positive integer. In at least one embodiment, SM 2100 includes, without limitation, a large number (e.g., 128 or more) of distinct processing cores 2110. In at least one embodiment, each processing core 2110 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 2110 include, without limitation, 64 single-precision (32-bit) floating point cores, 64 integer cores, 32 double-precision (64-bit) floating point cores, and 8 tensor cores.

Tensor cores are configured to perform matrix operations in accordance with at least one embodiment. In at least one embodiment, one or more tensor cores are included in processing cores 2110. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation, D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA 9 C++ API, exposes specialized matrix load, matrix multiply and accumulate, and matrix store operations to efficiently use tensor cores from a CUDA-C++ program. In at least one embodiment, at a CUDA level, a warp-level interface assumes 16×16 size matrices spanning all 32 threads of warp (which may be referred to as a wavefront and/or wave).

In at least one embodiment, each SM 2100 comprises, without limitation, M SFUs 2112 that perform special functions (e.g., attribute evaluation, reciprocal square root, and like). In at least one embodiment, SFUs 2112 include, without limitation, a tree traversal unit configured to traverse a hierarchical tree data structure. In at least one embodiment, SFUs 2112 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 2100. In at least one embodiment, texture maps are stored in shared memory/L1 cache 2118. In at least one embodiment, texture units implement texture operations such as filtering operations using mip-maps (e.g., texture maps of varying levels of detail), in accordance with at least one embodiment. In at least one embodiment, each SM 2100 includes, without limitation, two texture units.

Each SM 2100 comprises, without limitation, N LSUs 2114 that implement load and store operations between shared memory/L1 cache 2118 and register file 2108, in at least one embodiment. Interconnect network 2116 connects each functional unit to register file 2108 and LSU 2114 to register file 2108 and shared memory/L1 cache 2118 in at least one embodiment. In at least one embodiment, interconnect network 2116 is a crossbar that can be configured to connect any functional units to any registers in register file 2108 and connect LSUs 2114 to register file 2108 and memory locations in shared memory/L1 cache 2118.

In at least one embodiment, shared memory/L1 cache 2118 is an array of on-chip memory that allows for data storage and communication between SM 2100 and primitive engine and between threads in SM 2100, in at least one embodiment. In at least one embodiment, shared memory/L1 cache 2118 comprises, without limitation, 128 KB of storage capacity and is in a path from SM 2100 to a partition unit. In at least one embodiment, shared memory/L1 cache 2118, in at least one embodiment, is used to cache reads and writes. In at least one embodiment, one or more of shared memory/L1 cache 2118, L2 cache, and memory are backing stores.

Combining data cache and shared memory functionality into a single memory block provides improved performance for both types of memory accesses, in at least one embodiment. In at least one embodiment, capacity is used or is usable as a cache by programs that do not use shared memory, such as if shared memory is configured to use half of a capacity, and texture and load/store operations can use remaining capacity. Integration within shared memory/L1 cache 2118 enables shared memory/L1 cache 2118 to function as a high-throughput conduit for streaming data while simultaneously providing high-bandwidth and low-latency access to frequently reused data, in accordance with at least one embodiment. In at least one embodiment, when configured for general purpose parallel computation, a simpler configuration can be used compared with graphics processing. In at least one embodiment, fixed function graphics processing units are bypassed, creating a much simpler programming model. In a general purpose parallel computation configuration, a work distribution unit assigns and distributes blocks of threads directly to DPCs, in at least one embodiment. In at least one embodiment, threads in a block execute a common program, using a unique thread ID in calculation to ensure each thread generates unique results, using SM 2100 to execute program and perform calculations, shared memory/L1 cache 2118 to communicate between threads, and LSU 2114 to read and write global memory through shared memory/L1 cache 2118 and memory partition unit. In at least one embodiment, when configured for general purpose parallel computation, SM 2100 writes commands that scheduler unit 2104 can use to launch new work on DPCs.

In at least one embodiment, a PPU is included in or coupled to a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, and more. In at least one embodiment, a PPU is embodied on a single semiconductor substrate. In at least one embodiment, a PPU is included in a system-on-a-chip (“SoC”) along with one or more other devices such as additional PPUs, memory, a reduced instruction set computer (“RISC”) CPU, a memory management unit (“MMU”), a digital-to-analog converter (“DAC”), and like.

In at least one embodiment, a PPU may be included on a graphics card that includes one or more memory devices. In at least one embodiment, that graphics card may be configured to interface with a PCIe slot on a motherboard of a desktop computer. In at least one embodiment, that PPU may be an integrated graphics processing unit (“iGPU”) included in chipset of a motherboard.

Logic 615 are used to perform inferencing and/or training operations associated with one or more embodiments. Details regarding logic 615 are provided herein in conjunction with FIGS. 6A and/or 6B. In at least one embodiment, deep learning application processor is used to train a machine learning model, such as a neural network, to predict or infer information provided to SM 2100. In at least one embodiment, SM 2100 is used to infer or predict information based on a trained machine learning model (e.g., neural network) that has been trained by another processor or system or by SM 2100. In at least one embodiment, SM 2100 may be used to perform one or more neural network use cases described herein.

At least one embodiment of the disclosure can be described in view of the following clauses:

According to at least one embodiment, a processor is provided comprising one or more arithmetic logic units (ALUs) to compute final averaged parameters for a trained neural network, at least in part, by: performing a training phase, comprising storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and performing a post-training phase, comprising determining, for a desired averaging function, a combination of selected snapshots of averaged parameters selected from the basis set, and determining the parameters for the trained neural network by combining the plurality of network parameters of each of the selected snapshots according to the determined combination.

According to at least one embodiment of the processor, the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

According to at least one embodiment of the processor, the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

According to at least one embodiment of the processor, the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

According to at least one embodiment of the processor, the determined combination of selected snapshots is a weighted average that includes, for each respective selected snapshot, a respective weight.

According to at least one embodiment of the processor, the respective weights are determined by solving a least squares optimization problem to minimize a distance between the desired averaging function and a weighted average of a set of averaging functions corresponding to the selected snapshots.

According to at least one embodiment of the processor, at least one respective snapshot of averaged parameters stored after each of the plurality of training intervals includes a plurality of network parameters averaged by an exponential moving average and an exponential moving average half-life.

According to at least one embodiment of the processor, at least one respective snapshot of averaged parameters stored after each of the plurality of training intervals includes a plurality of respective network parameters averaged by an averaging function that is a power function.

According to at least one embodiment of the processor, the power function is provided as

$${p}_{{t}_{c}} ( t ) = \frac{f ( t )}{g ( {t}_{c} )} , where f ( t ) = {t}^{γ} and g ( {t}_{c} ) = \frac{{t}_{c}^{γ + 1}}{γ + 1} ,$$

and wherein the one or more averaging parameters is a selection of a value for γ.

According to at least one embodiment of the processor, the desired averaging function is a different averaging function than the averaging function by which the plurality of network parameters of any respective snapshot are averaged.

According to at least one embodiment, a system is provided comprising one or more processors to compute final averaged parameters for a trained neural network, at least in part, by performing: a training phase, comprising storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and a post-training phase, comprising determining, for a desired averaging function, a combination of selected snapshots of averaged parameters selected from the basis set, and determining the parameters for the trained neural network by combining the plurality of network parameters of each of the selected snapshots according to the determined combination. The system further comprises one or more memories to store the trained neural network.

According to at least one embodiment of the system, the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

According to at least one embodiment of the system, the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

According to at least one embodiment of the system, the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

According to at least one embodiment of the system, the determined combination of selected snapshots is a weighted average that includes, for each respective selected snapshot, a respective weight.

According to at least one embodiment of the system, at least one respective snapshot of averaged parameters stored after each of the plurality of training intervals includes a plurality of network parameters averaged by an exponential moving average and an exponential moving average half-life.

According to at least one embodiment of the system, at least one respective snapshot of averaged parameters stored after each of the plurality of training intervals includes a plurality of respective network parameters averaged by an averaging function that is a power function.

According to at least one embodiment of the system, the power function is provided as

$${p}_{{t}_{c}} ( t ) = \frac{f ( t )}{g ( {t}_{c} )} , where f ( t ) = {t}^{γ} and g ( {t}_{c} ) = \frac{{t}_{c}^{γ + 1}}{γ + 1} ,$$

and wherein the one or more averaging parameters is a selection of a value for γ.

According to at least one embodiment, a machine-readable medium is provided having stored thereon a set of instructions, which if performed by one or more processors, cause the one or more processors to at least compute final averaged parameters for a trained neural network, at least in part, by performing a training phase, comprising storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and a post-training phase, comprising determining, for a desired averaging function, a combination of selected snapshots of averaged parameters selected from the basis set, and determining the parameters for the trained neural network by combining the plurality of network parameters of each of the selected snapshots according to the determined combination.

According to at least one embodiment of the machine-readable medium, the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

According to at least one embodiment of the machine-readable medium, the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

According to at least one embodiment of the machine-readable medium, the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

According to at least one embodiment of the machine-readable medium, the determined combination of selected snapshots is a weighted average that includes, for each respective selected snapshot, a respective weight.

According to at least one embodiment, a method is provided for computing final averaged parameters for a trained neural network, the method comprising: performing a training phase, comprising storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and performing a post-training phase, comprising determining, for a desired averaging function, a combination of selected snapshots of averaged parameters selected from the basis set, and determining the parameters for the trained neural network by combining the plurality of network parameters of each of the selected snapshots according to the determined combination.

According to at least one embodiment of the method, the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

According to at least one embodiment of the method, the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

According to at least one embodiment of the method, the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

According to at least one embodiment, a system is provided comprising one or more processors to perform inference using the trained neural network for which the final averaged parameters are computed by the method according to at least one embodiment; and one or more memories to store the one or more neural networks.

According to at least one embodiment, a machine-readable medium having stored thereon a set of instructions, which if performed by one or more processors, cause the one or more processors to at least perform inference using the trained neural network for which the final averaged parameters are computed by the method according to at least one embodiment.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, referring back to FIG. 10, computer programs in form of machine-readable executable code or computer control logic algorithms are stored in main memory 1004 and/or secondary storage. Computer programs, if executed by one or more processors, enable system 1000 to perform various functions in accordance with at least one embodiment. In at least one embodiment, memory 1004, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1002, parallel processing system 1012, an integrated circuit capable of at least a portion of capabilities of both CPU 1002, parallel processing system 1012, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1000 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1012 includes, without limitation, a plurality of parallel processing units (“PPUs”) 1014 and associated memories 1016. In at least one embodiment, PPUs 1014 are connected to a host processor or other peripheral devices via an interconnect 1018 and a switch 1020 or multiplexer. In at least one embodiment, parallel processing system 1012 distributes computational tasks across PPUs 1014 which can be parallelizable for example, as part of distribution of computational tasks across multiple graphics processing unit (“GPU”) thread blocks. In at least one embodiment, memory is shared and accessible (e.g., for read and/or write access) across some or all of PPUs 1014, although such shared memory may incur performance penalties relative to use of local memory and registers resident to a PPU 1014. In at least one embodiment, operation of PPUs 1014 is synchronized through use of a command such as _syncthreads( ), wherein all threads in a block (e.g., executed across multiple PPUs 1014) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors 1700, graphics cores 1200, parallel processor 1300, processor 1400, processor core 1400, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more arithmetic logic units (ALUs) to compute final averaged parameters for a trained neural network, at least in part, by performing:
a training phase, comprising:
storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and
a post-training phase, comprising:
determining, for a desired averaging function, a combination of selected snapshots of averaged parameters selected from the basis set, and
determining the parameters for the trained neural network by combining the plurality of network parameters of each of the selected snapshots according to the determined combination.

2. The processor according to claim 1, wherein the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

3. The processor according to claim 2, wherein the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

4. The processor according to claim 2, wherein the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

5. The processor according to claim 1, wherein the determined combination of selected snapshots is a weighted average that includes, for each respective selected snapshot, a respective weight.

6. The processor according to claim 5, wherein the respective weights are determined by solving a least squares optimization problem to minimize a distance between the desired averaging function and a weighted average of a set of averaging functions corresponding to the selected snapshots.

7. The processor according to claim 1, wherein at least one respective snapshot of averaged parameters stored after each of the plurality of training intervals includes a plurality of network parameters averaged by an exponential moving average and an exponential moving average half-life.

8. The processor according to claim 1, wherein at least one respective snapshot of averaged parameters stored after each of the plurality of training intervals includes a plurality of respective network parameters averaged by an averaging function that is a power function.

9. The processor according to claim 8, wherein the power function is provided as
$${p}_{{t}_{c}} ( t ) = \frac{f ( t )}{g ( {t}_{c} )} , where f ( t ) = {t}^{γ} and g ( {t}_{c} ) = \frac{{t}_{c}^{γ + 1}}{γ + 1} ,$$
and wherein the one or more averaging parameters is a selection of a value or γ.

10. The processor according to claim 1, wherein the desired averaging function is a different averaging function than the averaging function by which the plurality of network parameters of any respective snapshot are averaged.

11. A system comprising:
one or more processors to compute final averaged parameters for a trained neural network, at least in part, by performing:
a training phase, comprising:
storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and
a post-training phase, comprising:
determining, for a desired averaging function, a combination of selected snapshots of averaged parameters selected from the basis set, and
determining the parameters for the trained neural network by combining the plurality of network parameters of each of the selected snapshots according to the determined combination; and
one or more memories to store the trained neural network.

12. The system according to claim 11, wherein the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

13. The system according to claim 12, wherein the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

14. The system according to claim 12, wherein the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

15. The system according to claim 11, wherein the determined combination of selected snapshots is a weighted average that includes, for each respective selected snapshot, a respective weight.

16. The system according to claim 11, wherein at least one respective snapshot of averaged parameters stored after each of the plurality of training intervals includes a plurality of network parameters averaged by an exponential moving average and an exponential moving average half-life.

17. The system according to claim 11, wherein at least one respective snapshot of averaged parameters stored after each of the plurality of training intervals includes a plurality of respective network parameters averaged by an averaging function that is a power function.

18. The system according to claim 17, wherein the power function is provided as
$${p}_{{t}_{c}} ( t ) = \frac{f ( t )}{g ( {t}_{c} )} , where f ( t ) = {t}^{γ} and g ( {t}_{c} ) = \frac{{t}_{c}^{γ + 1}}{γ + 1} ,$$
and wherein the one or more averaging parameters is a selection of a value for γ.

19. A machine-readable medium having stored thereon a set of instructions, which if performed by one or more processors, cause the one or more processors to at least:
compute final averaged parameters for a trained neural network, at least in part, by performing:
a training phase, comprising:
storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and
a post-training phase, comprising:
determining, for a desired averaging function, a combination of selected snapshots of averaged parameters selected from the basis set, and
determining the parameters for the trained neural network by combining the plurality of network parameters of each of the selected snapshots according to the determined combination.

20. The machine-readable medium according to claim 19, wherein the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

21. The machine-readable medium according to claim 20, wherein the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

22. The machine-readable medium according to claim 20, wherein the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

23. The machine-readable medium according to claim 19, wherein the determined combination of selected snapshots is a weighted average that includes, for each respective selected snapshot, a respective weight.

24. The machine-readable medium according to claim 19, wherein the determined combination of selected snapshots is a weighted average that includes, for each respective selected snapshot, a respective weight.

25. A method for computing final averaged parameters for a trained neural network, the method comprising:
performing a training phase, comprising:
storing, after each of a plurality of training intervals during a neural network training process, one or more snapshots of averaged parameters to provide a basis set of averaged parameter snapshots, each respective snapshot of averaged parameters including a plurality of network parameters averaged by a respective combination of an averaging function and one or more averaging parameters; and
performing a post-training phase, comprising:
determining, for a desired averaging function, a combination of selected snapshots of averaged parameters selected from the basis set, and
determining the parameters for the trained neural network by combining the plurality of network parameters of each of the selected snapshots according to the determined combination.

26. The method according to claim 25, wherein the storing, after each of a plurality of training intervals during a neural network training process, one or more snapshots of averaged parameters to provide a basis set of averaged parameter snapshots comprises storing, after each of the plurality of training intervals, at least two snapshots of averaged parameters, each of the at least two snapshots including a plurality of network parameters averaged by a different combination of an averaging function and/or one or more averaging parameters.

27. The method according to claim 26, wherein the at least two snapshots of averaged parameters comprise a first snapshot including a plurality of network parameters averaged by a first averaging function and one or more first averaging parameters and a second snapshot including a plurality of network parameters averaged by the first averaging function and one or more second averaging parameters different from the one or more first averaging parameters.

28. The method according to claim 26, wherein the at least two snapshots of averaged parameters comprise a first snapshot including a plurality of network parameters averaged by a first averaging function and one or more averaging parameters and a second snapshot including a plurality of network parameters averaged by a second averaging function different from the first averaging function and one or more averaging parameters.

29. A system comprising:
one or more processors to perform inference using the trained neural network for which the final averaged parameters are computed by the method according to claim 25; and
one or more memories to store the one or more neural networks.

30. A machine-readable medium having stored thereon a set of instructions, which if performed by one or more processors, cause the one or more processors to at least:
perform inference using the trained neural network for which the final averaged parameters are computed by the method according to claim 25.
